(19) United States
(12) Patent Application Publication
(10) Pub. No.: US 2025/0034493 A1
(43) Pub. Date: Jan. 30, 2025

(54) RUM REPLICAS

(71) Applicant: Ava Food Labs, Inc., Detroit, MI (US)

(72) Inventors: Daniel Assad Saad, Dallas, TX (US); Solomon Eli Isaacson, Oakland, CA (US); Samantha Shen Magrath, Washington, DC (US); Mardonn Carl Chua, Ann Arbor, MI (US); Lindsay Loretta Smith, San Francisco, CA (US)

(21) Appl. No.: 18/708,858

(22) PCT Filed: Nov. 9, 2022
(86) PCT No.: PCT/US2022/049435

§ 371 Date: May 9, 2024

Related U.S. Application Data
(60) Provisional application No. 63/277,220, filed on Nov. 9, 2021.

(51) Int. Cl. C12G 3/06; C12G 3/07

(52) U.S. Cl. CPC C12G 3/06; C12G 3/07

(57) ABSTRACT

Materials and methods for producing rum-like alcoholic beverages containing individual volatile components are provided herein.

### CROSS-REFERENCE TO RELATED APPLICATIONS

This application claims priority from U.S. Provisional Application Ser. No. 63/277,220, filed Nov. 9, 2021. The disclosure of the prior application is considered part of (and is incorporated by reference in) the disclosure of this application.

### TECHNICAL FIELD

This document relates to materials and methods for producing rum-like alcoholic beverages that contain individually added volatile components.

### BACKGROUND

The term “rum” generally refers to a distilled liquor made by fermenting and distilling sugarcane molasses or sugarcane juice, and then aging the distillate, typically in oak barrels. Many rums are produced in countries of the Caribbean, as well as in North American and South America countries, but rum also is made in other sugar-producing countries around the world.

Rums are produced in various grades, including light rums (also referred to as “silver” or “white” rums), golden or “amber” rums, dark rums, overproof rums. “Aged” rums are dark rums that have been barrel aged to confer warm, toasty colors and flavors. Some rums are infused with flavors of fruits, including banana, mango, orange, pineapple, coconut, and lime. In some cases, rums are flavored by the addition of spices such as cinnamon, rosemary, absinthe, aniseed, pepper, cloves, and cardamom.

Rum typically is 40 to 95 percent alcohol by volume (ABV), with the alcohol content varying depending on the type of rum. the Rum production is based on traditional styles that vary between locations and distillers. Traditional methods for producing rum can be lengthy and costly, involving harvesting sugarcane, extracting water and sugar juice from the harvested cane, in some cases, producing molasses from the sugarcane, fermenting the molasses or the sugar juice, distilling the fermentate in pot stills or column stills, aging the rum (e.g., in bourbon casks or other wooden casks or steel tanks), and optionally blending the rum to provide a desired flavor. Each component of the traditional processes for making rum can have an inherent variability and risk, including climate, crop disease, and contamination, which can render such methods and their resulting products inconsistent from batch to batch and year to year.

### SUMMARY

This document is based, at least in part, on the identification of compounds that contribute to the flavor and aroma of different types of rum, and on the development of methods for combining those compounds to yield rum replicas that have the taste, aroma, and other characteristics of traditionally generated rums. Because each ingredient is added individually, the methods disclosed herein reduce many of the risks and variability associated with traditional rum production. The methods also can provide nearly infinite reproducibility of a recipe, which is not possible with traditional production methods. Further, the methods described herein allow for unique flexibility in optimization of the flavors, aromas, and textures of rums of various types (e.g., white rum, aged rum, and spiced rum), and can greatly reduce or even eliminate the possibility that the resulting beverage will contain detrimental or undesired components. Moreover, the methods disclosed herein differ from currently existing methods in that they are rapid, reproducible, and cost-effective.

In a first aspect, this document features a rum replica containing water; a grain neutral spirit; optionally, a traditional rum, wherein the rum replica contains no more than about 10 wt % of the traditional rum; glycerin; optionally, an oak extract; optionally, a salt; optionally, a sugar or other sweetener; optionally, a tannin; optionally, one or more plant oils, fruit oils, plant flavors, or fruit flavors; and at least ten added volatile organic compounds, wherein the added VOCs include at least one acid, at least one additional alcohol, at least one aldehyde, at least one ester, at least one terpene, at least one furan, and optionally at least one ketone, wherein the added VOCs comprise about 0.0001 wt % to about 1 wt % of the rum replica. The at least one acid can include acetic acid. The at least one additional alcohol can include one or more of 1-octen-3-ol, 1-propanol, 2-methyl-1-butanol, isoamyl alcohol, and isobutanol. The at least one additional alcohol can include 1-propanol and 2-methyl-1-butanol. The at least one additional alcohol can include isobutanol, isoamyl alcohol, 1-propanol, 2-methyl-1-butanol, and 1-octen-3-ol. The at least one additional alcohol can include isobutanol, 1-propanol, and 2-methyl-1-butanol. The at least one aldehyde can include one or more of 5-methyl-furfural, benzaldehyde, benzeneacetaldehyde, citral, furfural, hexanal, nonanal, and valeraldehyde. The at least one aldehyde can include furfural, benzeneacetaldehyde, nonanal, valeraldehyde, benzaldehyde, and 5-methyl-furfural. The at least one aldehyde can include furfural, valeraldehyde, benzaldehyde, and 5-methyl-furfural. The at least one aldehyde can include furfural, hexanal, citral, benzaldehyde, and 5-methyl-furfural. The at least one ester can include one or more of allyl hexanoate, benzyl butyrate, butyl acetate, diethyl butanedioate, ethyl acetate, ethyl octanoate, ethyl butyrate, ethyl heptanoate, ethyl hexanoate, ethyl pentanoate, ethyl propionate, heptanyl acetate, isoamyl acetate, isobutyl acetate, n-propyl acetate, p-anisyl acetate, and tetrahydrofurfuryl acetate. The at least one ester can include isoamyl acetate, tetrahydrofurfuryl acetate, p-anisyl acetate, ethyl propionate, ethyl acetate, and diethyl butanedioate. The at least one ester can include ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, and ethyl acetate. The at least one ester can include isobutyl acetate, tetrahydrofurfuryl acetate, p-anisyl acetate, ethyl propionate, and ethyl acetate. The at least one ester can include ethyl hexanoate, ethyl octanoate, isobutyl acetate, ethyl propionate, and ethyl acetate. The at least one terpene can include one or more of beta-caryophyllene, beta-pinene, d-limonene, linalool, myrcene, and p-cymene. The at least one terpene can include p-cymene. The at least one terpene can include d-limonene and p-cymene. The at least one terpene can include d-limonene, beta-pinene, myrcene, beta-caryophyllene, linalool, and p-cymene. The at least one furan can include 2-acetylfuran. The rum replica can include at least one ketone, and wherein the at least one ketone includes one or more of 2,3-hexanedione, 2,3-pentanedione, and maltol. The at least one ketone can include 2,3-hexanedione and maltol. The at least one ketone can include 2,3-hexanedione, 2,3-pentanedione, and maltol. The added VOCs can further include one or more of dimethyl disulfide, rum ether, and whiskey lactone. The added VOCs can include rum ether and whiskey lactone. The added VOCs can include dimethyl disulfide, rum ether, and whiskey lactone. The rum replica can include an oak extract. The rum replica can include a salt, and wherein the salt is sodium chloride. The rum replica can include a sugar or other sweetener selected from the group consisting of sucrose, fructose, glucose, sugar alcohols, and sugar substitutes. The rum replica can include a tannin.

The added VOCs can include ten or more compounds selected from the group consisting of 1-decanol, 1-octen-3-ol, 1-propanol, 2,3-hexanedione, 2,3-pentanedione, 2-acetylfuran, 2-methyl-1-butanol, 2-pentylfuran, 5-methyl-furfural, acetic acid, allyl hexanoate, benzaldehyde, benzeneacetaldehyde, benzyl butyrate, beta-bisabolene, beta-caryophyllene, beta-pinene, butyl acetate, citral, decanal, diethyl butanedioate, dimethyl disulfide, D-limonene, dodecanoic acid, ethyl acetate, ethyl octanoate, ethyl benzoate, ethyl butyrate, ethyl dodecanoate, ethyl heptanoate, ethyl hexanoate, ethyl pentanoate, ethyl propionate, furfural, heptanyl acetate, isoamyl acetate, isoamyl acetate, isobutyl acetate, isopentyl hexanoate, isobutanol, linalool, maltol, menthol, myrcene, decanoic acid, hexanal, nonanal, n-propyl acetate, octanoic acid, octyl acetate, p-anisyl acetate, p-cymene, phenethyl acetate, phenylethyl alcohol, rum ether, tetrahydrofurfuryl acetate, valeraldehyde, and whiskey lactone. The rum added VOCs can include 10 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone. The added VOCs can include 20 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

The added VOCs can include 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone. The added VOCs can include 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone. The added VOCs can include 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone. The added VOCs can include 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

The rum replica can include from about 5 wt % to about 70 wt % water; from about 25 wt % to about 95 wt % grain neutral spirits; from about 1 wt % to about 10 wt % rum; from about 0.1 wt % to about 10 wt % glycerin; optionally, up to about 0.1 wt % salt; optionally, up to about 5 wt % sugar or sweetener; optionally, up to about 0.1 wt % tannins; and from about 0.001 wt % to about 1 wt % added VOCs, wherein the added VOCs include ten or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone. The added VOCs can include 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone. The added VOCs can include 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone. The added VOCs can include 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone. The added VOCs can include 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

The added VOCs can include isobutanol, wherein the isobutanol is present in the rum replica at a concentration greater than about 315 mg/L. The added VOCs can include ethyl heptanoate, wherein the ethyl heptanoate is present in the rum replica at a concentration greater than about 1.84 mg/L. The added VOCs can include acetic acid, wherein the acetic acid is present in the rum replica at a concentration less than about 7.5 mg/L. The added VOCs can include n-propyl acetate, wherein the n-propyl acetate is present in the rum replica at a concentration less than about 0.12 mg/L. The added VOCs can include isoamyl acetate, wherein the isoamyl acetate is present in the rum replica at a concentration greater than about 21.4 mg/L. The added VOCs can include 2-methyl-1-butanol, wherein the 2-methyl-1-butanol is present in the rum replica at a concentration less than about 3.1 mg/L. The added VOCs can include benzeneacetaldehyde, wherein the benzeneacetaldehyde is present in the rum replica at a concentration less than about 0.0012 mg/L. The added VOCs can include nonanal, wherein the nonanal is present in the rum replica at a concentration greater than about 0.1 mg/L. The added VOCs can include valeraldehyde, wherein the valeraldehyde is present in the rum replica at a concentration less than about 0.0024 mg/L. The added VOCs can include allyl hexanoate, wherein the allyl hexanoate is present in the rum replica at a concentration greater than about 0.034 mg/L. The added VOCs can include benzyl butyrate, wherein the benzyl butyrate is present in the rum replica at a concentration in an amount greater than about 0.37 mg/L. The added VOCs can include ethyl acetate, wherein the ethyl acetate is present in the rum replica at a concentration less than about 4.6 mg/L. The added VOCs can include acetic acid, wherein less than about 0.001 wt % of the added VOCs is acetic acid. The added VOCs can include isoamyl acetate, wherein at least about 0.013 wt % of the added VOCs is isoamyl acetate. The added VOCs can include 2-methyl-1-butanol, wherein less than about 0.0003 wt % of the added VOCs is 2-methyl-1-butanol. The added VOCs can include nonanal, wherein at least about 0.00007 wt % of the added VOCs is nonanal. The added VOCs can include allyl hexanoate, wherein at least about 0.00002 wt % of the added VOCs is allyl hexanoate. The added VOCs can include benzyl butyrate, wherein at least about 0.0002 wt % of the added VOCs is benzyl butyrate. The added VOCs can include ethyl acetate, wherein less than about 0.0005 wt % of the added VOCs is ethyl acetate. The rum replica can further include from about 10 wt % to about 30 wt % oak extract. The rum replica can further include from about 0.0005 to about 0.002 wt % orange oil. The total concentration of the one or more esters in the rum replica can be less than about 7.5 mg/L. The total concentration of the one or more acids in the rum replica can be less than about 10 mg/L.

In another aspect, this document features a method for making a rum replica. The method can include, or consist essentially of, combining: water; a grain neutral spirit; optionally, a traditional rum, wherein the rum replica contains no more than about 10 wt % of the rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein the added VOCs include at least one acid, at least one additional alcohol, at least one aldehyde, at least one ester, and at least one terpene, at least one furan, and optionally at least one ketone, wherein the added VOCs comprise about 0.0001 wt % to about 1 wt % of the rum replica. The at least one acid can include acetic acid. The at least one additional alcohol can include one or more of 1-octen-3-ol, 1-propanol, 2-methyl-1-butanol, isoamyl alcohol, and isobutanol. The at least one additional alcohol can include 1-propanol and 2-methyl-1-butanol. The at least one additional alcohol can include isobutanol, isoamyl alcohol, 1-propanol, 2-methyl-1-butanol, and 1-octen-3-ol. The at least one additional alcohol can include isobutanol, 1-propanol, and 2-methyl-1-butanol. The at least one aldehyde can include one or more of 5-methyl-furfural, benzaldehyde, benzeneacetaldehyde, citral, furfural, hexanal, nonanal, and valeraldehyde. The at least one aldehyde can include furfural, benzeneacetaldehyde, nonanal, valeraldehyde, benzaldehyde, and 5-methyl-furfural. The at least one aldehyde can include furfural, valeraldehyde, benzaldehyde, and 5-methyl-furfural. The at least one aldehyde can include furfural, hexanal, citral, benzaldehyde, and 5-methyl-furfural. The at least one ester can include one or more of allyl hexanoate, benzyl butyrate, butyl acetate, diethyl butanedioate, ethyl acetate, ethyl octanoate, ethyl butyrate, ethyl heptanoate, ethyl hexanoate, ethyl pentanoate, ethyl propionate, heptanyl acetate, isoamyl acetate, isobutyl acetate, n-propyl acetate, p-anisyl acetate, and tetrahydrofurfuryl acetate. The at least one ester can include isoamyl acetate, tetrahydrofurfuryl acetate, p-anisyl acetate, ethyl propionate, ethyl acetate, and diethyl butanedioate. The at least one ester can include ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, and ethyl acetate. The at least one ester can include isobutyl acetate, tetrahydrofurfuryl acetate, p-anisyl acetate, ethyl propionate, and ethyl acetate. The at least one ester can include ethyl hexanoate, ethyl octanoate, isobutyl acetate, ethyl propionate, and ethyl acetate. The at least one terpene can include one or more of beta-caryophyllene, beta-pinene, d-limonene, linalool, myrcene, and p-cymene. The at least one terpene can include p-cymene. The at least one terpene can include d-limonene and p-cymene. The at least one terpene can include d-limonene, beta-pinene, myrcene, beta-caryophyllene, linalool, and p-cymene. The at least one furan can include 2-acetylfuran. The rum replica can include at least one ketone, and wherein the at least one ketone includes one or more of 2,3-hexanedione, 2,3-pentanedione, and maltol. The at least one ketone can include 2,3-hexanedione and maltol. The at least one ketone can include 2,3-hexanedione, 2,3-pentanedione, and maltol. The added VOCs can further include one or more of dimethyl disulfide, rum ether, and whiskey lactone. The added VOCs can include rum ether and whiskey lactone. The added VOCs can include dimethyl disulfide, rum ether, and whiskey lactone. The rum replica can include an oak extract. The rum replica can include a salt, and wherein the salt is sodium chloride. The rum replica can include a sugar or other sweetener selected from the group consisting of sucrose, fructose, glucose, sugar alcohols, and sugar substitutes. The rum replica can include a tannin.

The added VOCs can include ten or more compounds selected from the group consisting of 1-decanol, 1-octen-3-ol, 1-propanol, 2,3-hexanedione, 2,3-pentanedione, 2-acetylfuran, 2-methyl-1-butanol, 2-pentylfuran, 5-methyl-furfural, acetic acid, allyl hexanoate, benzaldehyde, benzeneacetaldehyde, benzyl butyrate, beta-bisabolene, beta-caryophyllene, beta-pinene, butyl acetate, citral, decanal, diethyl butanedioate, dimethyl disulfide, D-limonene, dodecanoic acid, ethyl acetate, ethyl octanoate, ethyl benzoate, ethyl butyrate, ethyl dodecanoate, ethyl heptanoate, ethyl hexanoate, ethyl pentanoate, ethyl propionate, furfural, heptanyl acetate, isoamyl acetate, isoamyl acetate, isobutyl acetate, isopentyl hexanoate, isobutanol, linalool, maltol, menthol, myrcene, decanoic acid, hexanal, nonanal, n-propyl acetate, octanoic acid, octyl acetate, p-anisyl acetate, p-cymene, phenethyl acetate, phenylethyl alcohol, rum ether, tetrahydrofurfuryl acetate, valeraldehyde, and whiskey lactone. The added VOCs can include 10 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone. The added VOCs can include 20 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

The added VOCs can include 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone. The added VOCs can include 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone. The added VOCs can include 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone. The added VOCs can include 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

The method can include combining from about 5 wt % to about 70 wt % water; from about 25 wt % to about 95 wt % grain neutral spirits; from about 1 wt % to about 10 wt % traditional rum; from about 0.1 wt % to about 10 wt % glycerin; optionally, up to about 0.1 wt % salt; optionally, up to about 5 wt % sugar or sweetener; optionally, up to about 0.1 wt % tannins; and from about 0.001 wt % to about 1 wt % added VOCs, wherein the added VOCs include ten or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone. The added VOCs can include 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone. The added VOCs can include 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone. The added VOCs can include 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone. The added VOCs can include 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

The added VOCs can include isobutanol, wherein the isobutanol is present in the rum replica at a concentration greater than about 315 mg/L. The added VOCs can include ethyl heptanoate, wherein the ethyl heptanoate is present in the rum replica at a concentration greater than about 1.84 mg/L. The added VOCs can include acetic acid, wherein the acetic acid is present in the rum replica at a concentration less than about 7.5 mg/L. The added VOCs can include n-propyl acetate, wherein the n-propyl acetate is present in the rum replica at a concentration less than about 0.12 mg/L. The added VOCs can include isoamyl acetate, wherein the isoamyl acetate is present in the rum replica at a concentration greater than about 21.4 mg/L. The added VOCs can include 2-methyl-1-butanol, wherein the 2-methyl-1-butanol is present in the rum replica at a concentration less than about 3.1 mg/L. The added VOCs can include benzeneacetaldehyde, wherein the benzeneacetaldehyde is present in the rum replica at a concentration less than about 0.0012 mg/L. The added VOCs can include nonanal, wherein the nonanal is present in the rum replica at a concentration greater than about 0.1 mg/L. The added VOCs can include valeraldehyde, wherein the valeraldehyde is present in the rum replica at a concentration less than about 0.0024 mg/L. The added VOCs can include allyl hexanoate, wherein the allyl hexanoate is present in the rum replica at a concentration greater than about 0.034 mg/L. The added VOCs can include benzyl butyrate, wherein the benzyl butyrate is present in the rum replica at a concentration in an amount greater than about 0.37 mg/L. The added VOCs can include ethyl acetate, wherein the ethyl acetate is present in the rum replica at a concentration less than about 4.6 mg/L. The added VOCs can include acetic acid, wherein less than about 0.001 wt % of the added VOCs is acetic acid. The added VOCs can include isoamyl acetate, wherein at least about 0.013 wt % of the added VOCs is isoamyl acetate. The added VOCs can include 2-methyl-1-butanol, wherein less than about 0.0003 wt % of the added VOCs is 2-methyl-1-butanol. The added VOCs can include nonanal, wherein at least about 0.00007 wt % of the added VOCs is nonanal. The added VOCs can include allyl hexanoate, wherein at least about 0.00002 wt % of the added VOCs is allyl hexanoate. The added VOCs can include benzyl butyrate, wherein at least about 0.0002 wt % of the added VOCs is benzyl butyrate. The added VOCs can include ethyl acetate, wherein less than about 0.0005 wt % of the added VOCs is ethyl acetate. The method can further include adding from about 10 wt % to about 30 wt % oak extract to the rum replica. The method can further include adding from about 0.0005 to about 0.002 wt % orange oil to the rum replica. The total concentration of the one or more esters in the rum replica can be less than about 7.5 mg/L. The total concentration of the one or more acids in the rum replica can be less than about 10 mg/L.

In another aspect, this document features a rum replica produced by a method disclosed herein.

In another aspect, this documents features a rum-like alcoholic beverage concentrate containing: optionally, a traditional rum, wherein the alcoholic beverage, after dilution to produce a final product, contains no more than about 10 wt % of the rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein the added VOCs include at least one acid, at least one additional alcohol, at least one aldehyde, at least one ester, at least one terpene, at least one furan, and optionally at least one ketone, wherein at least one of the added VOCs is present in a concentration of at least about 2-fold the concentration of the same VOC in a corresponding traditional rum or a corresponding non-concentrate rum-like alcoholic beverage. At least one of the added VOCs can be present in the concentrate in a concentration of at least about 5-fold the concentration of the same VOCs in a corresponding traditional rum or a corresponding non-concentrate rum-like alcoholic beverage. At least one of the added VOCs can be present in the concentrate in a concentration of at least about 10-fold the concentration of the same VOCs in a corresponding traditional rum or a corresponding non-concentrate rum-like alcoholic beverage. At least one of the added VOCs can be present in the concentrate in a concentration of at least about 15-fold the concentration of the same VOCs in a corresponding traditional rum or a corresponding non-concentrate rum-like alcoholic beverage. Upon dilution of the rum-like beverage concentrate to a rum-like alcoholic beverage, the rum-like alcoholic beverage can be a rum replica described herein.

In still another aspect, this document features a method of making a rum-like alcoholic beverage concentrate. The method can include, or consist essentially of combining: optionally, a rum, wherein the alcoholic beverage, after dilution to produce a final product, contains no more than about 10 wt % of the rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein the added VOCs include at least one acid, at least one additional alcohol, at least one aldehyde, at least one ester, at least one terpene, at least one furan, and optionally at least one ketone, wherein at least one of the added VOCs is present in a concentration of at least about 2-fold the concentration of the same VOC in a corresponding traditional rum or a corresponding non-concentrate rum-like alcoholic beverage. At least one of the added VOCs can be present in the concentrate in a concentration of at least about 5-fold the concentration of the same VOCs in a corresponding traditional rum or a corresponding non-concentrate rum-like alcoholic beverage. At least one of the added VOCs can be present in the concentrate in a concentration of at least about 10-fold the concentration of the same VOCs in a corresponding traditional rum or a corresponding non-concentrate rum-like alcoholic beverage. At least one of the added VOCs can be present in the concentrate in a concentration of at least about 15-fold the concentration of the same VOCs in a corresponding traditional rum or a corresponding non-concentrate rum-like alcoholic beverage. Upon dilution of the rum-like beverage concentrate to a rum-like alcoholic beverage, the rum-like alcoholic beverage can be a rum replica described herein.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the description below. Other features, objects, and advantages of the invention will be apparent from the description and from the claims.

### DETAILED DESCRIPTION

This document provides rum-like alcoholic beverages (also referred to as “rum replicas,” “rum products,” and “flavored rums”), as well as methods for making rum-like alcoholic beverages by combining water and ethanol with individual VOCs. Going forward in this document, the term “rum” refers to both “rum” and “rum” spirits.

The rum-like alcoholic beverages described herein have characteristics—including taste, aroma, mouthfeel, and appearance—of traditionally produced rums, and are meant to be consumed and enjoyed in the same manner as traditional rums. For example, the rum replicas can have colors consistent with those of traditional rums, ranging from colorless (white) to golden (or “amber”) to dark, with similar viscosity to traditional rums. In some cases, a rum replica provided herein can be essentially colorless, reminiscent of traditionally-made white rum. In some cases, a rum replica provided herein can be darker in color and more full-bodied, reminiscent of traditionally-made aged rum. In some cases, a rum replica provided herein can have aromas and tastes much like those of traditionally-made spiced or flavored rums.

As used herein, the terms “traditional” and “reference” rum refer to rum produced through standard processing, fermenting, distilling, and aging processes.

The following standards of identity for traditionally produced distilled neutral spirits are set forth in 27 C.F.R. § 5.22(a):

Class 1; neutral spirits or alcohol. “Neutral spirits” or “alcohol” are distilled spirits produced from any material at or above 1900 proof, and, if bottled, bottled at not less than 800 proof.

The following standards of identity for traditionally produced rum are further set forth in 27 C.F.R. § 5.22(f):

(f) Class 6; rum. “Rum” is an alcoholic distillate from the fermented juice of sugar cane, sugar cane syrup, sugar cane molasses, or other sugar cane by-products, produced at less than 190° proof in such manner that the distillate possesses the taste, aroma, and characteristics generally attributed to rum, and bottled at not less than 80° proof, and also includes mixtures solely of such distillates.

The alcoholic beverages provided herein can include a traditional rum, such that the beverages can be considered “spirits” as defined above. In such embodiments, any appropriate percentage of the ethanol in a rum replica, on a proof gallon basis, can be from a traditional rum. Any type of traditional rum can be included in the rum replicas provided herein. For example, traditional white rum, traditional dark rum, traditional aged rum, or traditional spiced rum can be included in the rum replicas provided herein.

A “proof gallon” is one liquid gallon of spirits that is 50% alcohol at 60° F. Thus, for example, a distilled spirit bottled at 80 proof (40% alcohol) would be 0.8 proof gallons per gallon of liquid. An 80 proof spirit rum replica containing 1% ethanol from a traditional rum on a proof gallon basis therefore would contain 0.8×0.01=0.008 proof gallon from the traditional rum.

The rum replicas described herein can contain particular volatile and, optionally, non-volatile organic compounds. The terms “contain,” “include,” “comprise” are used herein to indicate that a compound is present in a rum replica in an amount that is detectable (e.g., using a mass spectrometry method, such as gas chromatography mass spectrometry). The terms “lacks,” “does not contain,” “does not include,” and “does not comprise” are used herein to indicate that a compound is not detectable in a rum replica (e.g., using a mass spectrometry method, such as liquid chromatography mass spectrometry). The rum replicas provided herein can be distinguished from traditional rums based at least in part on the combination of VOCs and, in some cases, non-volatile organic compounds contained or not contained therein, and/or based on the amounts of particular VOCs or, in some cases, non-volatile organic compounds contained therein.

In some embodiments, a rum replica can consist of the ingredients included in a particular list, or can have a VOC content (or non-volatile compound content) that consists of the VOCs (or non-volatile compounds) included in a particular list. Further, a rum replica can consist essentially of the ingredients included in a particular list, or can have a VOC content (or non-volatile compound content) that consists essentially of the VOCs (or non-volatile compounds) that are included in a particular list. By “consisting essentially of” is meant that a rum replica contains specified ingredients/VOCs/non-volatile compounds, and can contain additional ingredients/VOCs/non-volatile compounds that do not materially affect the basic and novel characteristics of the rum.

Various formulations for rum replicas are described herein. In general, the rum replicas include the following components, or classes of components:
(a) a source of water, either pure or with mineral content present to improve flavor;
(b) a source of ethanol (e.g., a distilled or fermented ethanol, such as a grain neutral spirit);
(c) optionally, a traditional rum, where the traditional rum makes up no more than about 10 wt % of the rum replica;
(d) glycerin;
(e) optionally, an oak extract;
(f) optionally, one or more salts;
(g) optionally, one or more sugars or other sweeteners;
(h) optionally, tannins;
(i) optionally, one or more plant oils, fruit oils, plant flavors, or fruit flavors;
(j) one or more additional VOCs (in addition to the ethanol, and in addition to VOCs that may be present in the traditional rum, plant oil(s), fruit oil(s), plant flavor(s), and fruit flavor(s), if included); and
(k) optionally, one or more additional non-volatile compounds (that is, one or more non-volatile compounds in addition to any non-volatile compounds that may be present in the traditional rum, plant oil, fruit oil, plant flavor, and fruit flavor, if included), such as one or more coloring agents).

Water is the main component of the rum replicas, acting as a solvent for the other ingredients. The ethanol component and the rum component (if any) provide the alcoholic content. The one or more added VOCs and the optional oak extract, optional salt, optional sugar, and optional tannins can provide both aroma and flavor, including fruity, floral, earthy, herbaceous, oak, yeast, spice, and/or mineral aromas and flavors. In some cases, non-volatile components can provide acidity, flavor, aftertaste, and mouthfeel perception of the rum replicas.

In general, the rum replicas provided herein can have a water content of about 5 to about 70 wt %. For example, a rum replica can have a water content of about 5 to 10 wt %, about 10 to 20 wt %, about 20 to 30 wt %, about 30 to 40 wt %, about 40 to 45 wt %, about 45 to 50 wt %, about 50 to 55 wt %, about 55 to 60 wt %, about 60 to 65 wt %, or about 65 to 70 wt %.

In general, the rum replicas provided herein can have a total alcohol content (e.g., an ethanol content from grain neutral spirits and traditional rum) content that ranges from about 25 wt % to about 95 wt %. For example, a rum replica can have an alcohol content of about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 25 to 30 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt %.

In some cases, the rum replicas provided herein can contain about 25 wt % to about 95 wt % grain neutral spirits (e.g., about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 25 to 30 wt %, about 30 to 35 wt %, about 35 to 40 wt %, about 40 to 45 wt %, about 45 to 50 wt %, about 50 to 55 wt %, about 55 to 60 wt %, about 60 to 65 wt %, about 65 to 70 wt %, about 70 to 75 wt %, about 75 to 80 wt %, about 80 to 85 wt %, about 85 to 90 wt %, or about 90 to 95 wt % grain neutral spirits) and about 0.1 wt % to about 10 wt % traditional rum (e.g., about 0.1 wt %, about 0.25 wt %, about 0.5 wt %, about 0.75 wt %, about 1 wt %, about 1.25 wt %, about 1.5 wt %, about 2 wt %, about 3 wt %, about 5 wt %, about 10 wt %, about 0.1 to 0.25 wt %, about 0.25 to 0.5 wt %, about 0.5 to 0.75 wt %, about 0.75 to 1 wt %, about 1 to 1.25 wt %, about 1.25 to 1.5 wt %, about 1.5 to 2 wt %, about 2 to 3 wt %, about 3 to 5 wt %, about 5 to 10 wt %, no more than about 1 wt %, no more than about 2 wt %, no more than about 3 wt %, no more than about 5 wt %, or no more than about 10 wt % traditional rum).

The rum replicas provided herein can contain about 0.1 wt % to about 10 wt % glycerin, which can contribute to the mouthfeel and body/viscosity of the rum replicas, and can provide some sweetness. For example, a rum replica can contain glycerin in an amount of about 0.1 wt %, about 0.5 wt %, about 1 wt %, about 1.5 wt %, about 2 wt %, about 2.5 wt %, about 3 wt %, about 4 wt %, about 5 wt %, about 6 wt %, about 7 wt %, about 8 wt %, about 9 wt %, about 10 wt %, about 0.1 to 0.5 wt %, about 0.5 to 1 wt %, about 0.5 to about 1.5 wt %, about 1 to 1.5 wt %, about 1.5 to 2 wt %, about 2 to 3 wt %, about 3 to 4 wt %, about 4 to 5 wt %, about 5 to 6 wt %, about 6 to 7 wt %, about 7 to 8 wt %, about 8 to 9 wt %, or about 9 to 10 wt %.

In some cases, the rum replicas provided herein can contain an oak extract. The oak extract can be included in an amount from about 0.1 wt % to about 30 wt %. For example, a rum replica can contain about 0.1 wt %, about 0.5 wt %, about 1 wt %, about 1.5 wt %, about 2 wt %, about 2.5 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 20 wt %, about 25 wt %, about 30 wt %, about 0.1 to 0.5 wt %, about 0.5 to 1 wt %, about 1 to 1.5 wt %, about 1.5 to 2 wt %, about 2 to 3 wt %, about 3 to 4 wt %, about 4 to 5 wt %, about 5 to 6 wt %, about 6 to 7 wt %, about 7 to 8 wt %, about 8 to 9 wt %, about 9 to 10 wt %, about 10 to 12 wt %, about 11 to 13 wt %, about 12 to 14 wt %, about 13 to 15 wt %, about 15 to 20 wt %, about 20 to 25 wt %, or about 25 to 30 wt % oak extract. In some cases, a rum replica provided herein contains no oak extract.

In some cases, the rum replicas provided herein can contain a salt (e.g., sodium chloride). One or more salts can be included in a total amount of about 0.0001 wt % to about 0.1 wt % (e.g., about 0.0001 wt %, about 0.0005 wt %, about 0.001 wt %, about 0.005 wt %, about 0.008 wt %, about 0.01 wt %, about 0.05 wt %, about 0.1 wt %, about 0.0001 to about 0.0005 wt %, about 0.0005 to about 0.001 wt %, about 0.001 to about 0.005 wt %, about 0.005 to about 0.01 wt %, about 0.01 to 0.05 wt %, or about 0.05 to 0.1 wt %). In some cases, a rum replica provided herein contains no salt.

In some cases, the rum replicas provided herein can contain a sugar or another sweetener (e.g., sucrose, fructose, glucose, sugar alcohols, sugar substitutes, or any combination thereof). One or more sugars or other sweeteners can be included in a total amount of about 0.0001 wt % to about 5 wt % (e.g., about 0.0001 wt %, about 0.0005 wt %, about 0.001 wt %, about 0.005 wt %, about 0.01 wt %, about 0.05 wt %, about 0.1 wt %, about 0.5 wt %, about 1 wt %, about 2 wt %, about 2.5 wt %, about 3 wt %, about 4 wt %, about 5 wt %, about 0.0001 to about 0.0005 wt %, about 0.0005 to about 0.001 wt %, about 0.001 to about 0.005 wt %, about 0.005 to about 0.01 wt %, about 0.01 to about 0.05 wt %, about 0.05 to about 0.1 wt %, about 0.1 to about 0.5 wt %, about 0.5 to about 1 wt %, about 1 to about 2 wt %, about 2 to about 3 wt %, about 3 to about 4 wt %, or about 4 to about 5 wt %). In some cases, a rum replica provided herein contains no individually added sugar or other added sweetener.

In some cases, the rum replicas provided herein can contain one or more tannins. The one or more tannins can be included in a total amount of about 0.0001 wt % to about 0.1 wt % (e.g., about 0.0001 wt %, about 0.0005 wt %, about 0.001 wt %, about 0.005 wt %, about 0.008 wt %, about 0.01 wt %, about 0.05 wt %, about 0.1 wt %, about 0.0001 to about 0.0005 wt %, about 0.0005 to about 0.001 wt %, about 0.001 to about 0.005 wt %, about 0.005 to about 0.01 wt %, about 0.01 to 0.05 wt %, or about 0.05 to 0.1 wt %). In some cases, a rum replica provided herein contains no tannins.

In some cases, the rum replicas provided herein can contain one or more plant or fruit oils (e.g., orange oil), and/or one or more plant- or fruit-derived flavors. The one or more plant oils can be included in a total amount of about 0.0005 wt % to about 0.002 wt % (e.g., about 0.0005 to about 0.001 wt %, about 0.001 to about 0.0015 wt %, or about 0.0015 to about 0.002 wt %). In some cases, a rum replica provided herein contains no plant oil, fruit oil, plant-derived flavor, or fruit-derived flavor.

The rum replicas provided herein also contain one or more additional VOCs, where the additional VOCs were added to the rum replica on an individual basis (e.g., in pure or substantially pure form). In some embodiments, a rum replica can include water, ethanol, a traditional rum, glycerin, optionally a sugar, optionally an added plant oil, fruit oil, plant flavor, or fruit flavor, and (a) one or more additional VOCs (i.e., VOCs in addition to ethanol and any VOCs included in the traditional rum, plant oil, fruit oil, plant flavor, and fruit flavor, if included), where the one or more additional VOCs are not present in a corresponding reference rum (also sometimes herein called a corresponding traditional rum); (b) one or more additional VOCs (i.e., VOCs in addition to ethanol and any VOCs included in the traditional rum, plant oil, fruit oil, plant flavor, and fruit flavor, if included), where the one or more additional VOCs do not include one or more VOCs that are present in a corresponding reference rum; (c) one or more additional non-volatile compounds (i.e., one or more non-volatile compounds in addition to any non-volatile compounds present in the traditional rum, plant oil, fruit oil, plant flavor, and fruit flavor, if included), where the one or more additional non-volatile compounds are not present in a corresponding reference rum; (d) one or more additional non-volatile compounds (i.e., one or more non-volatile compounds in addition to any non-volatile compounds present in the traditional rum, plant oil, fruit oil, plant flavor, and fruit flavor, if included), where the one or more additional non-volatile compounds do not include one or more non-volatile compounds that are present in a corresponding reference rum; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

As used herein, a “corresponding reference rum” can be a single type, a single brand, or a single bottle of traditionally-produced rum that a rum replica as described herein is intended to replicate. In some cases, a single type, single brand, or single bottle of traditionally-produced rum can be a blend of two or more (e.g., two, three, four, or more than four) rums. For example, if a rum replica is meant to be the same as a spiced rum, then a spiced rum would be a corresponding reference rum, while if a rum replica is meant to be the same as a white rum, then a white rum would be a corresponding reference rum.

The one or more added VOCs that are present in a rum replica can include one or more compounds that fall into any of several categories, including acids, alcohols, aldehydes, esters, ketones, terpenes, and/or other types of VOCs (e.g., sulfides, furans, lactones, and/or ethers). In some cases, for example, a rum replica (e.g., an aged rum replica) can contain added VOCs that include an acid, an alcohol in addition to the ethanol, an aldehyde, an ester, a ketone, a terpene, a furan, and a VOC that does not fall into any of the foregoing categories. In some cases, a rum replica (e.g., a white rum replica) can contain added VOCs that include an acid, alcohol in addition to the ethanol, an aldehyde, an ester, a ketone, a terpene, a furan, and a VOC that does not fall into any of the foregoing categories. In some cases, a rum replica (e.g., a spiced rum replica) can contain added VOCs that include an acid, an alcohol in addition to the ethanol, an aldehyde, an ester, a ketone, a terpene, a furan, and a VOC that does not fall into any of the foregoing categories. The additional VOCs can be present at any suitable amount within a rum replica. For example, additional VOCs can make up about 0.0001 wt % to about 1 wt % (e.g., about 0.0001 wt %, about 0.0005 wt %, about 0.001 wt %, about 0.005 wt %, about 0.01 wt %, about 0.05 wt %, about 0.1 wt %, about 0.5 wt %, about 1 wt %, about 0.0001 to about 0.0005 wt %, about 0.0005 to about 0.001 wt %, about 0.001 to about 0.005 wt %, about 0.005 to about 0.01 wt %, about 0.01 to about 0.05 wt %, about 0.05 to about 0.1 wt %, about 0.1 to about 0.5 wt %, or about 0.5 to about 1 wt %) of a rum replica.

Acids can contribute to the signature flavors of alcoholic beverages. Non-limiting examples of acids that can be included in the rum replicas provided herein include 2-methylbutyric acid, acetic acid, butyric acid, decanoic acid, isovaleric acid, dodecanoic acid, octanoic acid, and any combination thereof. A rum replica provided herein can contain one or more, two or more, three or more, four or more, five, six, or more than six acids selected from the group consisting of 2-methylbutyric acid, acetic acid, butyric acid, decanoic acid, isovaleric acid, dodecanoic acid, and octanoic acid. In some cases, for example, a rum replica can contain acetic acid. The acid(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more acids. The one or more acids can be present at any suitable amount within a rum replica. For example, added acid(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs can include no acids.

Alcohols in addition to the ethanol provided by the grain neutral spirit and the traditional rum can provide various flavor components to alcoholic beverages, including fruit, spice, grassiness, and oxidized characteristics. In some cases, higher alcohols also can add roundness to the general aroma of an alcoholic beverage, as well as some weight on the palate. Non-limiting examples of alcohols that can be present in the rum replicas provided herein include (±)2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 1-decanol, 1-propanol, isobutanol, (±)-menthol, phenylethyl alcohol, and any combination thereof. A rum replica provided herein can contain one or more, two or more, three or more, four or more, five or more, six or more, seven or more, eight or more, nine or more, ten or more, 11 or more, 12 or more, 13 or more, 14 or more, 15 or more, or 16 or more of the alcohols selected from the group consisting of (±)-2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 1-decanol, 1-propanol, isobutanol, (1)-menthol, and phenylethyl alcohol. For example, a rum replica can contain one or more alcohols selected from 1-octen-3-ol, 1-propanol, 2-methyl-1-butanol, isoamyl alcohol, and isobutanol. In some cases, a rum replica can contain 1-propanol and 2-methyl-1-butanol. In some cases, a rum replica can contain isobutanol, 1-propanol, and 2-methyl-1-butanol. In some cases, a rum replica can contain isobutanol, isoamyl alcohol, 1-propanol, 2-methyl-1-butanol, and 1-octen-3-ol. The alcohol(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more alcohols. The one or more alcohols can be present at any suitable amount within a rum replica. In some cases, for example, added alcohol(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs can include no additional alcohols.

Aldehydes also can provide flavors that add to the general character of an alcoholic beverage. In some cases, aldehydes that can be used in the rum replicas provided herein can include, without limitation, 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, 5-methyl-furfural, benzaldehyde, benzeneacetaldehyde, decanal, nonanal and any combination thereof. A rum replica provided herein can contain one or more, two or more, three or more, four or more, five or more, six or more, seven or more, eight or more, nine or more, ten or more, 11 or more, 12 or more, or 13 or more aldehydes selected from the group consisting of 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, 5-methyl-furfural, benzaldehyde, benzeneacetaldehyde, decanal, and nonanal. For example, a rum replica can contain one or more aldehydes selected from 5-methyl-furfural, benzaldehyde, benzeneacetaldehyde, citral, furfural, hexanal, nonanal, and valeraldehyde. In some cases, a rum replica can contain furfural, benzeneacetaldehyde, nonanal, valeraldehyde, benzaldehyde, and 5-methyl-furfural. In some cases, a rum replica can contain furfural, valeraldehyde, benzaldehyde, and 5-methyl-furfural. In some cases, a rum replica can contain furfural, hexanal, citral, benzaldehyde, and 5-methyl-furfural. The aldehyde(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more aldehydes. The one or more aldehyde(s) can be present at any suitable amount within a rum replica. In some cases, for example, added aldehyde(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs can include no aldehydes.

Esters, including ethyl, methyl, and acetate esters, can contribute fruity and floral characteristics to an alcoholic beverage. In some cases, esters that can be used in a rum replica include, without limitation, allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, butyl acetate, diethyl butanedioate, ethyl benzoate, ethyl butyrate, ethyl dodecanoate, ethyl pentanoate, ethyl propionate, heptanyl acetate, isobutyl acetate, isopentyl hexanoate, n-propyl acetate, octyl acetate, phenethyl acetate, and any combination thereof. A rum replica provided herein can contain one or more, two or more, three or more, four or more, five or more, six or more, seven or more, eight or more, nine or more, ten or more, 11 or more, 12 or more, 13 or more, 14 or more, 15 or more, 16 or more, 17 or more, or 18 or more esters selected from the group consisting of allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, butyl acetate, diethyl butanedioate, ethyl benzoate, ethyl butyrate, ethyl dodecanoate, ethyl pentanoate, ethyl propionate, heptanyl acetate, isobutyl acetate, isopentyl hexanoate, n-propyl acetate, octyl acetate, and phenethyl acetate. For example, a rum replica can contain one or more esters selected from allyl hexanoate, benzyl butyrate, butyl acetate, diethyl butanedioate, ethyl acetate, ethyl octanoate, ethyl butyrate, ethyl heptanoate, ethyl hexanoate, ethyl pentanoate, ethyl propionate, heptanyl acetate, isoamyl acetate, isobutyl acetate, n-propyl acetate, p-anisyl acetate, and tetrahydrofurfuryl acetate. In some cases, a rum replica can contain isoamyl acetate, tetrahydrofurfuryl acetate, p-anisyl acetate, ethyl propionate, ethyl acetate, and diethyl butanedioate. In some cases, a rum replica can contain ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, and ethyl acetate. In some cases, a rum replica can contain isobutyl acetate, tetrahydrofurfuryl acetate, p-anisyl acetate, ethyl propionate, and ethyl acetate. In some cases, a rum replica can contain ethyl hexanoate, ethyl octanoate, isobutyl acetate, ethyl propionate, and ethyl acetate. The ester(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more esters. The one or more esters can be present at any suitable amount within a rum replica. In some cases, for example, added ester(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs can include no esters.

Ketones can also contribute to the signature flavors of alcoholic beverages. Non-limiting examples of ketones that can be included in the rum replicas provided herein include 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, piperine, and any combination thereof. A rum replica provided herein can contain one or more, two or more, three or more, four or more, five or more, six or more, seven or more, eight or more, nine or more, ten or more, 11 or more, 12 or more, 13, or all 14 ketones selected from the group consisting of 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, and piperine. For example, a rum replica can include one or more ketones selected from 2,3-hexanedione, 2,3-pentanedione, and maltol. In some cases, a rum replica can include 2,3-hexanedione and maltol. The ketone(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more ketones. The one or more ketones can be present at any suitable amount within a rum replica. In some cases, for example, added ketone(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs can include no ketones.

Terpenes can contribute various floral and green characteristics to an alcoholic beverage. Non-limiting examples of terpenes that can be included in the rum replicas provided herein include beta-caryophyllene, beta-pinene, d-limonene, linalool, myrcene, beta-bisabolene, and p-cymene, and any combination thereof. A rum replica provided herein can contain one or more, two or more, three or more, four or more, or five or more terpenes selected from the group consisting of beta-caryophyllene, beta-pinene, d-limonene, linalool, myrcene, beta-bisabolene, and p-cymene. For example, a rum replica can contain one or more terpenes selected from beta-caryophyllene, beta-pinene, D-limonene, linalool, myrcene, and p-cymene. In some cases, a rum replica can contain p-cymene. In some cases, a rum replica can contain D-limonene and p-cymene. In some cases, a rum replica can contain D-limonene, beta-pinene, myrcene, beta-caryophyllene, linalool, and p-cymene. The terpene(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more terpenes. The one or more terpenes can be present at any suitable amount within a rum replica. In some cases, for example, added terpene(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs can include no terpenes.

Furans also can contribute to the flavors of an alcoholic beverage. Non-limiting examples of terpenes that can be included in the rum replicas provided herein include 2-acetyl furan, 2-pentyl furan, and any combination thereof. A rum replica provided herein can contain one or both of 2-acetyl furan and 2-pentyl furan. The furan(s) can make up any suitable proportion of the additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise one or more furans. The one or more furans can be present at any suitable amount within a rum replica. In some cases, for example, added furan(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs can include no furans.

In some cases, a rum replica provided herein can include one or more VOCs that do not fall into the above categories. Non-limiting examples of such VOCs that can be included in the rum replicas provided herein include diacetyl, dimethyl disulfide, methyl sulfide, rum ether, whiskey lactone, and any combination thereof. A rum replica provided herein can contain one or more, two or more, three or more, four or more, or five or more VOCs selected from the group consisting of diacetyl, dimethyl disulfide, methyl sulfide, rum ether, and whiskey lactone. For example, a rum replica can contain one or more VOCs selected from dimethyl disulfide, rum ether, and whiskey lactone. In some cases, a rum replica can contain rum ether and whiskey lactone. In some cases, a rum replica can contain dimethyl disulfide, rum ether, and whiskey lactone. These VOC(s) can make up any suitable proportion of the overall additional VOC content. For example, about 0.1% to about 99% (e.g., about 0.1% to about 1%, about 1% to about 10%, about 10% to about 20%, about 20% to about 25%, about 25% to about 30%, about 30% to about 40%, about 40% to about 50%, about 50% to about 60%, about 60% to about 70%, about 70% to about 80%, about 80% to about 90%, or about 90% to about 95%) by mass of the additional VOCs can comprise diacetyl, dimethyl disulfide, methyl sulfide, rum ether, or any combination thereof. The one or more VOCs that do not fall into the above categories can be present at any suitable amount within a rum replica. In some cases, for example, the added VOC(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, the additional VOCs do not include any compounds that are not within one of the above-described categories.

A rum replica can include any appropriate number of additional VOCs. For example, a rum replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) additional VOCs.

In some cases, for example, a rum replica can include five or more (e.g., ten or more, 15 or more, 20 or more, 25 or more, 30 or more, 35 or more, 40 or more, 45 or more, 50 or more, 55 or more, 60 or more, 70 or more, 80 or more, 90 or more, or 100 or more) additional VOCs selected from the group consisting of 2-methylbutyric acid, acetic acid, butyric acid, decanoic acid, isovaleric acid, (±)-2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, piperine, diacetyl, dimethyl disulfide, methyl sulfide, rum ether, beta-caryophyllene, beta-pinene, d-limonene, linalool, myrcene, 1-decanol, 1-propanol, 2-acetyl furan, 2-pentyl furan, 5-methyl-furfural, benzaldehyde, benzeneacetaldehyde, beta-bisabolene, butyl acetate, decanal, diethyl butanedioate, dodecanoic acid, ethyl benzoate, ethyl butyrate, ethyl dodecanoate, ethyl pentanoate, ethyl propionate, heptanyl acetate, isobutyl acetate, isopentyl hexanoate, isobutanol, menthol, nonanal, n-propyl acetate, octanoic acid, octyl acetate, p-cymene, phenethyl acetate, phenylethyl alcohol, and, whiskey lactone.

In some cases, a rum-like alcoholic beverage can include at least 10 (e.g., at least 15, at least 20, at least 25, at least 30, at least 35, at least 40, at least 45, or at least 50) added VOCs, where the added VOCs are selected from the group consisting of acetic acid, dodecanoic acid, decanoic acid, octanoic acid, 1-decanol, 1-octen-3-ol, 1-propanol, 2-methyl-1-butanol, isobutanol, menthol, phenylethyl alcohol, 5-methyl-furfural, benzaldehyde, benzeneacetaldehyde, citral, decanal, furfural, hexanal, nonanal, valeraldehyde, allyl hexanoate, benzyl butyrate, butyl acetate, diethyl butanedioate, ethyl acetate, ethyl octanoate, ethyl benzoate, ethyl butyrate, ethyl dodecanoate, ethyl heptanoate, ethyl hexanoate, ethyl pentanoate, ethyl propionate, heptanyl acetate, isoamyl acetate, isoamyl acetate, isobutyl acetate, isopentyl hexanoate, n-propyl acetate, octyl acetate, p-anisyl acetate, phenethyl acetate, tetrahydrofurfuryl acetate, 2,3-hexanedione, 2,3-pentanedione, maltol, beta-bisabolene, beta-caryophyllene, beta-pinene, D-limonene, linalool, myrcene, p-cymene, 2-acetylfuran, 2-pentylfuran, dimethyl disulfide, rum ether, and whiskey lactone.

In some cases, a rum-like alcoholic beverage can include at least 10 (e.g., at least 15, at least 20, at least 25, at least 30, at least 35, at least 40, 10 to 20, 10 to 30, 10 to 40, 15 to 20, 15 to 25, 15 to 30, 15 to 40, 20 to 30, 20 to 40, 25 to 30, 25 to 40, or 30 to 40) added VOCs, where the added VOCs are selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone. In some cases, a rum-like alcoholic beverage can contain 20 to 30 added VOCs selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone. In some cases, a rum-like alcoholic beverage can contain 25 to 35 added VOCs selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

In some cases, a rum replica provided herein can be an aged rum replica containing added VOCs that include an acid (e.g., acetic acid), an additional alcohol (e.g., hexanol), an aldehyde (e.g., 2,3-diolacetal, 1-propanol, 2-methyl-1-butanol, or any combination thereof), one or more aldehydes (e.g., furfural, benzeneacetaldehyde, nonanal, valeraldehyde, benzaldehyde, 5-methyl-furfural, or any combination thereof), one or more esters (e.g., diethyl succinate, tetrahydrofurfuryl acetate, isoamyl acetate, p-anisyl acetate, ethyl acetate, ethyl propionate, diethyl butanedioate, or any combination thereof), one or more ketones (e.g., 3,4-dimethyl-1,2-cyclopentadione, 6-methyl-5-hepten-2-one, 2,3-hexanedione, 2,3-pentanedione, 2-acetoxy-3-butanone, methylcyclopentenolone, 3-ethyl-2-hydroxy-2-cyclopenten-1-one, maltol, or any combination thereof), one or more terpenes (e.g., p-cymene), one or more furans (e.g., 2-aceylfuran, and one or more compounds of other categories (e.g., rum ether, whiskey lactone, or any combination thereof). For example, in some cases, a rum replica provided herein can be an aged rum replica that contains hexanol, vanillin erythro and threo-butan-2,3-diol acetal, diethyl succinate, tetrahydrofurfuryl acetate, isoamyl acetate, p-anisyl acetate, ethyl acetate, 3,4-dimethyl-1,2-cyclopentadione, 6-methyl-5-hepten-2-one, 2,3-hexanedione, 2,3-pentanedione, 2-acetoxy-3-butanone, methylcyclopentenolone, 3-ethyl-2-hydroxy-2-cyclopenten-1-one, and rum ether. In some cases, a rum replica provided herein can be an aged rum replica that contains 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

In some cases, a rum replica provided herein can be a white rum replica containing added VOCs that include one or more acids (e.g., 2-methylbutyric acid, acetic acid, butyric acid, decanoic acid, isovaleric acid, or any combination thereof), one or more additional alcohols (e.g., (±)-2-methyl-1-butanol, 1-octen-3-ol, 2-methoxy-4-propylphenol, 4-allyl-2,6-dimethoxyphenol, 4-ethylguaiacol, guaiacol, isoamyl alcohol, isobutyl alcohol, p-ethylphenol, phenethyl alcohol, 1-propanol, or any combination thereof), one or more aldehydes (e.g., 2-methylbutyraldehyde, 3-methylbutyraldehyde, acetal, furfural, hexanal, piperonal, valeraldehyde, vanillin, benzaldehyde, 5-methyl-furfural, or any combination thereof), one or more esters (e.g., allyl hexanoate, benzyl butyrate, ethyl 2-methylbutyrate, ethyl acrylate, ethyl heptanoate, ethyl hexanoate, ethyl isovalerate, ethyl octanoate, ethyl valerate, isoamyl acetate, phenethyl isovalerate, isobutyl acetate, ethyl propionate, ethyl acetate, or any combination thereof), one or more ketones (e.g., 4,5-dimethyl-3-hydroxy-2,5-dihydrofuran-2-one, 5-butyl-4-methyldihydro-2(3h)-furanone, beta damascenone, gamma-decalactone, or any combination thereof), one or more terpenes (e.g., p-cymene), one or more furans (e.g., 2-acetylfuran) and one or more VOCs that do not fall into any of the foregoing groups (e.g., diacetyl, dimethyl disulfide, methyl sulfide, rum ether, whiskey lactone, or any combination thereof). For example, in some cases, a rum replica provided herein can be a white rum replica that contains 2-methylbutyric acid, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, guaiacol, isoamyl alcohol, isobutyl alcohol, p-ethylphenol, phenethyl alcohol, 2-methylbutyraldehyde, 3-methylbutyraldehyde, acetal, furfural, hexanal, piperonal, valeraldehyde, vanillin, allyl hexanoate, benzyl butyrate, ethyl 2-methylbutyrate, ethyl acrylate, ethyl heptanoate, ethyl hexanoate, ethyl isovalerate, ethyl octanoate, ethyl valerate, isoamyl acetate, phenethyl isovalerate, 4,5-dimethyl-3-hydroxy-2,5-dihydrofuran-2-one, 5-butyl-4-methyldihydro-2(3h)-furanone, beta damascenone, gamma-decalactone, diacetyl, dimethyl disulfide, methyl sulfide, and rum ether. In some cases, a rum replica provided herein can be a white rum replica that contains 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

In some cases, a rum replica provided herein can be a spiced rum replica containing a plant oil, fruit oil, plant flavor, or fruit flavor (e.g., orange oil), and added VOCs that include one or more acids (e.g., acetic acid), one or more additional alcohols (e.g., eucalyptol, eugenol, geraniol, guaiacol, isoeugenol, isobutanol, 1-propanol, 2-methyl-1-butanol, or any combination thereof), one or more aldehydes (e.g., cinnamaldehyde, citral, piperonal, p-methoxybenzaldehyde, vanillin, vanillin erythro and threo-butan-2,3-diol acetal, furfural, hexanal, benzaldehyde, 5-methyl-furfural, or any combination thereof), one or more esters (e.g., tetrahydrofurfuryl acetate, isobutyl acetate, p-anisyl acetate, ethyl propionate, ethyl acetate, or any combination thereof), one or more ketones (e.g., 2,3-hexanedione, 2,3-pentanedione, 2-acetoxy-3-butanone, 3,4-dimethyl-1,2-cyclopentadione, 3-ethyl-2-hydroxy-2-cyclopenten-1-one, acetoin, maltol, methylcyclopentenolone, piperine, or any combination thereof), one or more terpenes (e.g., beta-caryophyllene, beta-pinene, d-limonene, linalool, myrcene, p-cymene, or any combination thereof), one or more furans (e.g., 2-acetylfuran), and one or more VOCs that do not fall into any of the foregoing groups (e.g., rum ether, whiskey lactone, or a combination thereof). For example, in some cases, a rum replica provided herein can be a spiced rum replica that contains eucalyptol, eugenol, geraniol, guaiacol, isoeugenol, cinnamaldehyde, citral, piperonal, p-methoxybenzaldehyde, vanillin, vanillin erythro and threo-butan-2,3-diol acetal, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, acetoin, maltol, methylcyclopentenolone, piperine, beta-caryophyllene, beta-pinene, d-limonene, linalool, and myrcene. In some cases, a rum replica provided herein can be a white rum replica that contains 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

In some cases, a rum replica provided herein can be an artisanal rum replica containing added VOCs that include one or more acids (e.g., acetic acid), one or more additional alcohols (e.g., isobutanol, isoamyl alcohol, 1-propanol, 2-methyl-1-butanol, 1-octen-3-ol, or any combination thereof), one or more aldehydes (e.g., furfural, valeraldehyde, benzaldehyde, 5-methyl-furfural, or any combination thereof), one or more esters (e.g., ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, ethyl acetate, or any combination thereof), one or more terpenes (e.g., d-limonene, p-cymene, or a combination thereof), one or more furans (e.g., 2-acetylfuran), and one or more VOCs that do not fall into any of the foregoing groups (e.g., dimethyl disulfide, rum ether, whiskey lactone, or any combination thereof). For example, in some cases, a rum replica provided herein can be an artisanal rum replica that contains 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

In some embodiments, the rum replicas provided herein can include one or more (e.g., one, two, three, four, five, six, seven eight, nine, ten, or more than ten) VOCs that are not present in a corresponding traditional rum. Non-limiting examples of such compounds include beta-pinene, myrcene, beta-caryophyllene, heptanyl acetate, tetrahydrofurfuryl acetate, p-anisyl acetate, citral, and 2,3-hexanedione. In some embodiments, a rum replica can include at least one (e.g., at least 2, at least 3, at least 4, at least 5, at least 6, at least 7, or all 8) compound selected from the group consisting of beta-pinene, myrcene, beta-caryophyllene, heptanyl acetate, tetrahydrofurfuryl acetate, p-anisyl acetate, citral, and 2,3-hexanedione. It is surprising that the rum replicas described herein include one or more compounds not found in any tested traditional rum, as it would be expected that to create a rum replica, one would only think to use compounds found in one or more traditional rums. By way of example only, 2,3-hexanedione, on its own, can gives off a fatty or phenolic character. However, in low concentrations in a rum replica (e.g., any of the rum replicas provided herein), it can provide an attractive character.

In some embodiments, the additional VOCs can exclude one or more VOCs that are present in a corresponding traditional rum. Non-limiting examples of such compounds include phenylethyl alcohol, ethyl dodecanoate, 1-decanol, ethyl nonanoate, ethyl-9-decenoate, 2-methylbutyl octanoate, ethyl laurate, isoamyl decanoate, and ethyl myristate. In some embodiments, a rum replica can exclude one or both of phenylethyl alcohol and ethyl dodecanoate. It is surprising that the rum replicas described herein lack one or more compounds found in every tested traditional rum, as it would be expected that to create a rum replica, one would believe that compounds present in every tested traditional rum to be important to rum flavor.

In some cases, the number of additional VOCs in a rum replica can be fewer than the number of additional VOCs in a single corresponding reference rum. Further, in some embodiments, the rum replicas provided herein can lack one or more (e.g., one, two, three, four, five, ten, 15, 20, or more than 20) VOCs that are present in a corresponding traditional rum. In some cases, the overall population of additional (non-ethanol) VOCs in a rum replica can have less than 95% identity to the VOCs in a corresponding reference rum (e.g., in a single type of traditionally made rum corresponding to the replica). For example, the additional VOCs in a rum replica can have less than 90%, less than 80%, less than 70%, less than 60%, less than 50%, less than 40%, less than 30%, less than 25%, less than 20%, or less than 15% identity to the population of VOCs in a corresponding reference rum made by traditional methods. In some cases, a percent identity can be calculated by dividing the number of shared additional VOCs by the number of additional VOCs in the corresponding reference rum. Some rum replicas may contain at least 3 (e.g., at least 5, at least 10 at least 15, at least 20, at least 25, at least 30, at least 35, at least 40, at least 45, or at least 50) VOCs that are not found in a single reference rum. Moreover, some rum replicas may contain no more than 50 (e.g., no more than 45, 40, 35, 30, 25, 20, 15, or 10) VOCs that are present in a single reference rum. For example, in some embodiments, a rum replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference rum; in some embodiments, n can be equal to 5, 6, 7, 8, 9, 10, 11, 12, 13, 14, 15, 16, 17, 18, 19, 20, 25, 30, 35, 40, 45, 50, 55, 60, 65, 70, 75, 80, or 85.

A rum can include VOCs in any appropriate amount. For example, in some embodiments, the additional VOCs can be present in a total amount of about 100 mg/L to about 5000 mg/L (e.g., about 100 to about 300 mg/L, about 300 to about 500 mg/L, about 500 to about 700 mg/L, about 700 to about 1000 mg/L, about 1000 to about 2000 mg/L, about 2000 to about 3000 mg/L, about 3000 to about 4000 mg/L, or about 4000 to about 5000 mg/L).

The presence, absence, and/or amount of VOCs and non-volatile compounds in traditional rums and in rum replicas can be assessed using gas chromatography/mass spectrometry (GC-MS) and liquid chromatography/mass spectrometry (LC-MS) methods as described herein. A volatile or non-volatile compound that is “not present” in a reference rum is one that is not detected in the reference rum using the methods set forth in Example 3. Limits of detection for various VOCs are disclosed in TABLES 2A and 2B herein.

As noted above, the amounts of VOCs in reference rums are measured using the GC-MS methods described herein. In some embodiments, the amount of a particular VOC in a rum replica can be an amount, based on concentration or percent composition, that is within a range 30% higher and lower than a measured amount for that VOC in a corresponding reference rum. For example, a VOC can be present in a rum replica in an amount that is 70 to 90%, 80 to 100%, 90 to 110%, 100 to 120%, 110 to 130%, 70 to 100%, 80 to 110%, 90 to 120%, or 100 to 130% of an amount measured for that VOC in a corresponding reference rum.

In some embodiments, a percent composition of VOCs can be calculated by dividing the measured amount of a VOC of interest (e.g., in mg/L) by the total measured amount of VOCs (e.g., in mg/L). In some embodiments, the total measured amount of VOCs is based on the VOCs in TABLES 1B-1H. In some embodiments, the total measured amount of VOCs is based on the total measured amount of VOCs in the group that includes 1-decanol, 1-octen-3-ol, 1-propanol, 2,3-hexanedione, 2,3-pentanedione, 2-acetoxy-3-butanone, 2-acetylfuran, 2-methoxy-4-propylphenol, 2-methyl-1-butanol, 2-methylbutyraldehyde, 2-methylbutyric acid, 2-pentylfuran, 2-trans,4-trans-decadienal, 3,4-dimethyl-1,2-cyclopentadione, 3-ethyl-2-hydroxy-2-cyclopenten-1-one, 3-methylbutyraldehyde, 4,5-dimethyl-3-hydroxy-2,5-dihydrofuran-2-one, 4-allyl-2,6-dimethoxyphenol, 4-ethylguaiacol, 5-butyl-4-methyldihydro-2(3h)-furanone, 5-methyl-furfural, 6-methyl-5-hepten-2-one, acetal, acetic acid, acetoin, allyl hexanoate, benzaldehyde, benzeneacetaldehyde, benzyl butyrate, beta damascenone, beta-bisabolene, beta-caryophyllene, beta-pinene, butyl acetate, butyric acid, cinnamaldehyde, citral, decanal, decanoic acid, diacetyl, diethyl butanedioate, diethyl succinate, dimethyl disulfide, d-limonene, dodecanoic acid, ethyl 2-methylbutyrate, ethyl 3-phenylpropionate, ethyl acetate, ethyl acrylate, ethyl octanoate, ethyl benzoate, ethyl butyrate, ethyl dodecanoate, ethyl heptanoate, ethyl hexanoate, ethyl isovalerate, ethyl pentanoate, ethyl propionate, ethyl valerate, eucalyptol, eugenol, furfural, gamma-decalactone, geraniol, guaiacol, heptanyl acetate, hexanal, hexanol, isoamyl acetate, isoamyl alcohol, isobutyl acetate, isobutyl alcohol, isoeugenol, isopentyl hexanoate, isobutanol, isovaleric acid, linalool, maltol, menthol, methyl sulfide, methylcyclopentenolone, myrcene, nonanal, n-propyl acetate, octanoic acid, octyl acetate, orange oil, p-anisyl acetate, p-cresol, p-cymene, p-ethylphenol, phenethyl alcohol, phenethyl isovalerate, phenethyl acetate, phenylethyl alcohol, piperine, piperonal, p-methoxybenzaldehyde, rum ether, tetrahydrofurfuryl acetate, valeraldehyde, vanillin, vanillin erythro and threo-butan-2,3-diol acetal, and whiskey lactone.

In some embodiments, the total measured amount of VOCs is based on the total measured amount of VOCs in the group that includes isobutanol, isoamyl acetate, D-limonene, beta-pinene, myrcene, beta-caryophyllene, ethyl hexanoate, ethyl heptanoate, ethyl octanoate, acetic acid, furfural, whiskey lactone, dimethyl disulfide, 2,3-pentanedione, n-propyl acetate, isobutyl acetate, isoamyl acetate, butyl acetate, heptanyl acetate, octyl acetate, phenethyl acetate, tetrahydrofurfuryl acetate, p-anisyl acetate, octanoic acid, decanoic acid, dodecanoic acid, 1-propanol, 2-methyl-1-butanol, 1-octen-3-ol, phenylethyl alcohol, 1-decanol, maltol, hexanal, benzeneacetaldehyde, nonanal, decanal, citral, valeraldehyde, 2,3-hexanedione, benzaldehyde, 5-methyl-furfural, p-cymene, (1)-menthol, ethyl propionate, ethyl butyrate, ethyl benzoate, ethyl dodecanoate, isopentyl hexanoate, allyl hexanoate, benzyl butyrate, ethyl pentanoate, ethyl acetate, 2-acetylfuran, 2-pentylfuran, diethyl butanedioate, rum ether, beta-bisabolene, and linalool.

In some embodiments, the total measured amount of VOCs is based on the total measured amount of VOCs in the group that includes 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone. For example, the total measured amount of VOCs can be based on the total measured amount of (a) 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone; (b) the total amount of 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone; (c) the total amount of 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone; or (d) the total amount of 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

In some cases, the total amount of VOCs in a rum replica can be less than the total amount of VOCs in a corresponding reference rum. For example, a rum replica can have a total VOC content (in mg/L) that is less than 95% (e.g., less than 90%, 85%, 80%, 70%, 60%, 50% or 40%) of the total VOC content (in mg/L) of a corresponding reference rum. Further, the amount of any particular VOC in a rum replica may be different than the amount of that VOC in a corresponding reference rum. In some cases, the amount of a VOC in a rum replica can be 75% or less (e.g., 70% or less, 60% or less, 50% or less, 40% or less, 30% or less, 20% or less, or 10% or less), by concentration or percent mass, than the amount of the same VOC in a corresponding reference rum. In some cases, the amount of a VOC in a rum replica can be 125% or more (e.g., 150% or more, 200% or more, or 300% or more), by concentration or percent mass, than the amount of the same VOC in a corresponding reference rum.

It will be understood that when both a range (or subrange) and an “at least” or “less than” amount (or percent by mass) are disclosed, these together disclose all ranges that exist in the overlap of the range (or subrange) and one of the “at least” or “less than” values in any combination. By way of example only, if 1-decanol can be present in an amount of about 0.001 mg/L to about 0.8 mg/L and the one or more additional VOCs can include 1-decanol in an amount of at least about 0.17 mg/L, then 1-decanol can be present in an amount of about 0.17 mg/L to about 0.8 mg/L (e.g., about 0.17 to about to about 0.2 mg/L, about 0.17 to about 0.4 mg/L, about 0.17 to about 0.6 mg/L, or about 0.17 to about 0.8 mg/L); 1-decanol can be present in an amount of about 0.2 mg/L to about 0.8 mg/L (e.g., about 0.2 to about 0.4 mg/L, about 0.2 to about 0.6 mg/L, or about 0.2 to about 0.8 mg/L); 1-decanol can be present in an amount of about 0.4 mg/L to about 0.8 mg/L (e.g., about 0.4 to about 0.6 mg/L, or about 0.4 to about 0.8 mg/L); or 1-decanol can be present in an amount of about 0.6 mg/L to about 0.8 mg/L. Further, it will be understood that if both a range and an “at least” or “less than” value are described for a rum replica, the interpretation will be the largest overlap of those descriptions. For example, if a rum replica is described with both “1-decanol can be present in an amount of about 0.001 mg/L to about 0.8 mg/L” and “the one or more additional VOCs include 1-decanol in an amount of at least about 0.17 mg/L”, the interpretation shall be that 1-decanol is present in an amount of about 0.17 mg/L to about 0.8 mg/L.

In some embodiments, the one or more VOCs in a rum replica can include one or more compounds selected from the group consisting of 1-decanol, 1-octen-3-ol, 1-propanol, 2,3-hexanedione, 2,3-pentanedione, 2-acetoxy-3-butanone, 2-acetylfuran, 2-methoxy-4-propylphenol, 2-methyl-1-butanol, 2-methylbutyraldehyde, 2-methylbutyric acid, 2-pentylfuran, 2-trans,4-trans-decadienal, 3,4-dimethyl-1,2-cyclopentadione, 3-ethyl-2-hydroxy-2-cyclopenten-1-one, 3-methylbutyraldehyde, 4,5-dimethyl-3-hydroxy-2,5-dihydrofuran-2-one, 4-allyl-2,6-dimethoxyphenol, 4-ethylguaiacol, 5-butyl-4-methyldihydro-2(3h)-furanone, 5-methyl-furfural, 6-methyl-5-hepten-2-one, acetal, acetic acid, acetoin, allyl hexanoate, benzaldehyde, benzeneacetaldehyde, benzyl butyrate, beta damascenone, beta-bisabolene, beta-caryophyllene, beta-pinene, butyl acetate, butyric acid, cinnamaldehyde, citral, decanal, decanoic acid, diacetyl, diethyl butanedioate, diethyl succinate, dimethyl disulfide, d-limonene, dodecanoic acid, ethyl 2-methylbutyrate, ethyl 3-phenylpropionate, ethyl acetate, ethyl acrylate, ethyl octanoate, ethyl benzoate, ethyl butyrate, ethyl dodecanoate, ethyl heptanoate, ethyl hexanoate, ethyl isovalerate, ethyl pentanoate, ethyl propionate, ethyl valerate, eucalyptol, eugenol, furfural, gamma-decalactone, geraniol, guaiacol, heptanyl acetate, hexanal, hexanol, isoamyl acetate, isoamyl alcohol, isobutyl acetate, isobutyl alcohol, isoeugenol, isopentyl hexanoate, isobutanol, isovaleric acid, linalool, maltol, menthol, methyl sulfide, methylcyclopentenolone, myrcene, nonanal, n-propyl acetate, octanoic acid, octyl acetate, orange oil, p-anisyl acetate, p-cresol, p-cymene, p-ethylphenol, phenethyl alcohol, phenethyl isovalerate, phenethyl acetate, phenylethyl alcohol, piperine, piperonal, p-methoxybenzaldehyde, rum ether, tetrahydrofurfuryl acetate, valeraldehyde, vanillin, vanillin erythro and threo-butan-2,3-diol acetal, and whiskey lactone, in any appropriate amount.

In some cases, the one or more additional VOCs in a rum-like alcoholic beverage can include 2-methylbutyric acid. The 2-methylbutryic acid can be present in the rum-like alcoholic beverage in an amount of, for example, about 0.00004 wt % to about 0.00018 wt % (e.g., about 0.00004 to about 0.00007 wt %, about 0.00007 to about 0.0001 wt %, about 0.0001 to about 0.00014 wt %, or about 0.00014 to about 0.00018 wt %). In some cases, the one or more additional VOCs can include no 2-methylbutyric acid.

In some cases, the one or more additional VOCs in a rum-like alcoholic beverage can include whiskey lactone (also referred to as 4-hydroxy-3-methyloctanoic acid lactone). The whiskey lactone can be present at a concentration of, for example, about 0.008 to about 2 mg/L (e.g. about 0.008 to about 0.08 mg/L, about 0.08 to about 0.8 mg/L, or about 0.8 to about 2 mg/L). The whiskey lactone can be present in the rum-like alcoholic beverage in an amount of, for example, about 0.000013 wt % to about 0.0002 wt % (e.g., about 0.000013 to about 0.00003 wt %, about 0.00003 to about 0.00005 wt %, about 0.00005 to about 0.00008 wt %, about 0.00008 to about 0.0001 wt %, about 0.0001 to about 0.00015 wt %, or about 0.00015 to about 0.0002 wt %). In some cases, the one or more additional VOCs in a rum-like alcoholic beverage can include whiskey lactone. In some cases, about 0.0001 wt % to about 2 wt % (e.g. about 0.0001 wt % to about 0.001 wt %, about 0.001 wt % to about 0.01 wt %, about 0.01 wt % to about 0.1 wt %, or about 0.1 wt % to about 2 wt %) of the one or more additional VOCs can be whiskey lactone. In some cases, the one or more additional VOCs can include no whiskey lactone.

In some cases, the one or more additional VOCs in a rum-like alcoholic beverage can include acetic acid. The acetic acid can be present in the rum-like alcoholic beverage at a concentration of, for example, about 1 to about 2480 mg/L (e.g., about 1 to about 20 mg/L, about 20 to about 40 mg/L, about 40 to about 60 mg/L, about 60 to about 80 mg/L, about 80 to about 100 mg/L, about 100 to about 200 mg/L, about 200 to about 300 mg/L, about 300 to about 400 mg/L, about 400 to about 500 mg/L, about 500 to about 600 mg/L, about 600 to about 700 mg/L, about 700 to about 800 mg/L, about 800 to about 900 mg/L, about 900 to about 1000 mg/L, about 1000 to about 1200 mg/L, about 1200 to about 1400 mg/L, about 1400 to about 1600 mg/L, about 1600 to about 1800 mg/L, about 1800 to about 2000 mg/L, about 2000 to about 2200 mg/L, or about 2200 to about 2480 mg/L). In some cases, a rum replica can contain acetic acid in an amount less than about 7.5 mg/L (e.g., less than about 7 mg/L, less than about 5 mg/L, less than about 3 mg/L, or less than about 2 mg/L). In some cases, the acetic acid can be present in the rum-like alcoholic beverage in an amount of, for example, about 0.013 wt % to about 0.052 wt % (e.g., about 0.013 to about 0.02 wt %, about 0.02 to about 0.03 wt %, about 0.03 to about 0.04 wt %, or about 0.04 to about 0.052 wt %). In some cases, about 0.052 wt % to about 72 wt % (e.g., about 0.052 wt % to about 0.5 wt %, about 0.5 wt % to about 1 wt %, about 1 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, or about 70 wt % to about 72 wt %) of the one or more additional VOCs can be acetic acid. In some cases, less than about 0.001 wt % (e.g., less than about 0.0009 wt %, or less than about 0.0008 wt %) of the added VOCs can be acetic acid. In some cases, the one or more additional VOCs can include no acetic acid.

In some cases, the one or more additional VOCs in a rum-like alcoholic beverage can include butyric acid. The butyric acid can be present in the rum-like alcoholic beverage in an amount of, for example, about 0.00003 wt % to about 0.00012 wt % (e.g., about 0.00003 to about 0.00005 wt %, about 0.00005 to about 0.00007 wt %, about 0.00007 to about 0.00009 wt %, or about 0.00009 to about 0.00012 wt %). In some cases, the one or more additional VOCs can include no butyric acid.

In some cases, the one or more additional VOCs in a rum-like alcoholic beverage can include decanoic acid. The decanoic acid can be present in the rum-like alcoholic beverage in an amount of, for example, about 0.00027 wt % to about 0.0011 wt % (e.g., about 0.00027 to about 0.0005 wt %, about 0.0005 to about 0.0007 wt %, about 0.0007 to about 0.0009 wt %, or about 0.0009 to about 0.0011 wt %). In some cases, the one or more additional VOCs can include no decanoic acid.

In some cases, the one or more additional VOCs in a rum-like alcoholic beverage can include isovaleric acid. The isovaleric acid can be present in the rum-like alcoholic beverage in an amount of, for example, about 0.000045 wt % to about 0.00018 wt % (e.g., about 0.000045 to about 0.00008 wt %, about 0.00008 to about 0.00012 wt %, about 0.00012 to about 0.00015 wt %, or about 0.00015 to about 0.00018 wt %). In some cases, the one or more additional VOCs can include no isovaleric acid.

In some cases, the one or more additional VOCs in a rum-like alcoholic beverage can include (±)-2-methyl-1-butanol. The (±)-2-methyl-1-butanol can be present in the rum-like alcoholic beverage at a concentration of, for example, about 0.01 to about 400 mg/L (e.g., about 0.01 to about 0.1 mg/L, about 0.1 to about 1 mg/L, about 1 to about 10 mg/L, about 10 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L). In some cases, a rum replica can contain 2-methyl-1-butanol at a concentration less than about 3.1 mg/L (e.g., less than about 3 mg/L, less than about 2 mg/L, less than about 1 mg/L, or less than about 0.1 mg/L). In some cases, the (±)-2-methyl-1-butanol can be present in the rum-like alcoholic beverage in an amount of, for example, about 0.00005 wt % to about 0.0245 wt % (e.g., about 0.00005 to about 0.0001 wt %, about 0.0001 to about 0.0005 wt %, about 0.0005 to about 0.001 wt %, about 0.001 to about 0.005 wt %, about 0.005 to about 0.01 wt %, or about 0.01 to about 0.0245 wt %). In some cases, about 0.0006 wt % to about 20 wt % (e.g., 0.0006 to about 0.006 wt %, about 0.006 to about 0.02 wt %, about 0.02 wt % to about 0.2 wt %, about 0.2 wt % to about 2 wt %, about 2 wt % to about 4 wt %, about 4 wt % to about 6 wt %, about 6 wt % to about 8 wt %, about 8 wt % to about 10 wt %, about 10 wt % to about 12 wt %, about 12 wt % to about 14 wt %, about 14 wt % to about 16 wt %, about 16 wt % to about 18 wt %, or about 18 wt % to about 20 wt %) of the one or more additional VOCs can be 2-methyl-1-butanol. In some cases, less than about 0.0003 wt % (e.g., less than about 0.0001 wt %) of the one or more additional VOCs can be 2-methyl-1-butanol. In some cases, the one or more additional VOCs can include no (±)-2-methyl-1-butanol.

In some cases, the one or more additional VOCs in a rum-like alcoholic beverage can include 1-octen-3-ol. The 1-octen-3-ol can be present in the rum-like alcoholic beverage at a concentration of, for example, about 0.01 to about 0.7 mg/L (e.g., about 0.01 to about 0.1 mg/L, about 0.1 to about 0.3 mg/L, about 0.3 to about 0.5 mg/L, or about 0.5 to about 0.7 mg/L). In some cases, the 1-octen-3-ol can be present in the rum-like alcoholic beverage in an amount of, for example, about 0.000012 wt % to about 0.00005 wt % (e.g., about 0.000012 to about 0.00002 wt %, about 0.00002 to about 0.00003 wt %, about 0.00003 to about 0.00004 wt %, or about 0.00004 to about 0.00005 wt %). In some cases, about 0.00005 wt % to about 0.03 wt % (e.g., about 0.00005 wt % to about 0.0005 wt %, about 0.0005 wt % to about 0.005 wt %, about 0.005 wt % to about 0.03 wt %) of the one or more additional VOCs can be 1-octen-3-ol. In some cases, the one or more additional VOCs can include no 1-octen-3-ol. In some cases, the one or more additional VOCs can include no 1-octen-3-ol.

In some cases, the one or more additional VOCs in a rum-like alcoholic beverage can include 2-methoxy-4-propylphenol. The 2-methoxy-4-propylphenol can be present in the rum-like alcoholic beverage in an amount of, for example, about 0.000001 wt % to about 0.000004 wt % (e.g., about 0.000001 to about 0.000002 wt %, about 0.000002 to about 0.000003 wt %, or about 0.000003 to about 0.000004 wt %). In some cases, the one or more additional VOCs can include no 2-methyoxy-4-propylphenol.

In some cases, the one or more additional VOCs in a rum-like alcoholic beverage can include 4-allyl-2,6-dimethoxyphenol. The 4-allyl-2,6-dimethoxyphenol can be present in the rum-like alcoholic beverage in an amount of, for example, about 0.000005 wt % to about 0.00002 wt % (e.g., about 0.000005 to about 0.000008 wt %, about 0.000008 to about 0.000012 wt %, about 0.000012 to about 0.000016 wt %, or about 0.000016 to about 0.00002 wt %). In some cases, the one or more additional VOCs can include no 4-allyl-2,6-dimethoxyphenol.

In some cases, the one or more additional VOCs in a rum-like alcoholic beverage can include 4-ethylguaiacol. The 4-ehtylguaiacol can be present in the rum-like alcoholic beverage in an amount of, for example, about 0.000014 wt % to about 0.000054 wt % (e.g., about 0.000014 to about 0.000024 wt %, about 0.000024 to about 0.000034 wt %, about 0.000034 to about 0.000044 wt %, or about 0.000044 to about 0.000054 wt %). In some cases, the one or more additional VOCs can include no 4-ethylguaiacol.

In some cases, the one or more additional VOCs in a rum-like alcoholic beverage can include eucalyptol. The eucalyptol can be present in the rum-like alcoholic beverage in an amount of, for example, about 0.000005 wt % to about 0.00002 wt % (e.g., about 0.000005 to about 0.000008 wt %, about 0.000008 to about 0.000012 wt %, about 0.000012 to about 0.000016 wt %, or about 0.000016 to about 0.00002 wt %). In some cases, the one or more additional VOCs can include no eucalyptol.

In some cases, the one or more additional VOCs in a rum-like alcoholic beverage can include eugenol. The eugenol can be present in the rum-like alcoholic beverage in an amount of, for example, about 0.000015 wt % to about 0.00005 wt % (e.g., about 0.000015 to about 0.000025 wt %, about 0.000025 to about 0.000035 wt %, or about 0.000035 to about 0.00005 wt %). In some cases, the one or more additional VOCs can include no eugenol.

In some cases, the one or more additional VOCs in a rum-like alcoholic beverage can include geraniol. The geraniol can be present in the rum-like alcoholic beverage in an amount of, for example, about 0.0001 wt % to about 0.0004 wt % (e.g., about 0.0001 to about 0.0002 wt %, about 0.0002 to about 0.0003 wt %, or about 0.0003 to about 0.0004 wt %). In some cases, the one or more additional VOCs can include no geraniol.

In some cases, the one or more additional VOCs in a rum-like alcoholic beverage can include guaiacol. The guaiacol can be present in the rum-like alcoholic beverage in an amount of, for example, about 0.0000025 wt % to about 0.00001 wt % (e.g., about 0.0000025 to about 0.000005 wt %, about 0.000005 to about 0.0000075 wt %, or about 0.0000075 to about 0.00001 wt %), or about 0.00001 wt % to about 0.00004 wt % (e.g., about 0.00001 to about 0.00002 wt %, about 0.00002 to about 0.00003 wt %, or about 0.00003 to about 0.00004 wt %). In some cases, the one or more additional VOCs can include no guaiacol.

In some cases, the one or more additional VOCs in a rum-like alcoholic beverage can include hexanol. The hexanol can be present in the rum-like alcoholic beverage in an amount of, for example, about 0.000002 wt % to about 0.000008 wt % (e.g., about 0.000002 to about 0.000004 wt %, about 0.000004 to about 0.000006 wt %, or about 0.000006 to about 0.000008 wt %). In some cases, the one or more additional VOCs can include no hexanol.

In some cases, the one or more additional VOCs in a rum-like alcoholic beverage can include isoamyl alcohol. The isoamyl alcohol can be present in a rum-like alcoholic beverage in a concentration of, for example, about 5.1 mg/L to about 600 mg/L (e.g., about 5.1 to about 10 mg/L, about 10 to about 50 mg/L, about 50 to about 100 mg/L, about 100 to about 200 mg/L, about 200 to about 400 mg/L, or about 400 to about 600 mg/L). The isoamyl alcohol can be present in the rum-like alcoholic beverage in an amount of, for example, about 0.04 wt % to about 0.16 wt % (e.g., about 0.04 to about 0.07 wt %, about 0.07 to about 0.1 wt %, about 0.1 to about 0.13 wt %, or about 0.13 to about 0.16 wt %). In some cases, about 0.056 wt % to about 26 wt % (e.g., about 0.06 to about 0.5 wt %, about 0.5 to about 1 wt %, about 1 to about 5 wt %, about 5 to about 10 wt %, about 10 to about 20 wt %, or about 20 to about 26 wt %) of the one or more additional VOCs can be isoamyl alcohol. In some cases, the one or more additional VOCs can include no isoamyl alcohol.

In some cases, the one or more additional VOCs in a rum-like alcoholic beverage can include isobutyl alcohol. The isobutyl alcohol can be present in the rum-like alcoholic beverage in an amount of, for example, about 0.0452 wt %. In some cases, the one or more additional VOCs can include no isobutyl alcohol.

In some cases, the one or more additional VOCs in a rum-like alcoholic beverage can include isoeugenol. The isoeugenol can be present in the rum-like alcoholic beverage in an amount of, for example, about 0.000006 wt % to about 0.00006 wt % (e.g., about 0.000006 to about 0.00001 wt %, about 0.00001 to about 0.00002 wt %, about 0.00002 to about 0.00004 wt %, or about 0.00004 to about 0.00006 wt %). In some cases, the one or more additional VOCs can include no isoeugenol.

In some cases, the one or more additional VOCs in a rum-like alcoholic beverage can include p-ethylphenol. The p-ethylphenol can be present in the rum-like alcoholic beverage in an amount of, for example, about 0.000006 wt % to about 0.000024 wt % (e.g., about 0.000006 to about 0.00001 wt %, about 0.00001 to about 0.000015 wt %, about 0.000015 to about 0.00002 wt %, or about 0.00002 to about 0.000024 wt %). In some cases, the one or more additional VOCs can include no p-ethylphenol.

In some cases, the one or more additional VOCs in a rum-like alcoholic beverage can include phenethyl alcohol. The phenethyl alcohol can be present in the rum-like alcoholic beverage in an amount of, for example, about 0.0008 wt % to about 0.0034 wt % (e.g., about 0.0008 to about 0.0015 wt %, about 0.0015 to about 0.002 wt %, about 0.002 to about 0.0025 wt %, about 0.0025 to about 0.003 wt %, or about 0.003 to about 0.0034 wt %). In some cases, the one or more additional VOCs can include no phenethyl alcohol.

In some cases, the one or more additional VOCs in a rum-like alcoholic beverage can include 2-methylbutyraldehyde. The 2-methylbutyraldehyde can be present in the rum-like alcoholic beverage in an amount of, for example, about 0.000003 wt %. In some cases, the one or more additional VOCs can include no 2-methylbutyraldehyde.

In some cases, the one or more additional VOCs in a rum-like alcoholic beverage can include 3-methylbutyraldehyde. The 3-methybutyraldehyde can be present in the rum-like alcoholic beverage in an amount of, for example, about 0.00001 wt % to about 0.00005 wt % (e.g., about 0.00001 to about 0.00002 wt %, about 0.00002 to about 0.00003 wt %, about 0.00003 to about 0.00004 wt %, or about 0.00004 to about 0.00005 wt %). In some cases, the one or more additional VOCs can include no 3-methylbutyraldehyde.

In some cases, the one or more additional VOCs in a rum-like alcoholic beverage can include acetal. The acetal can be present in the rum-like alcoholic beverage in an amount of, for example, about 0.0012 wt % to about 0.005 wt % (e.g., about 0.0012 to about 0.002 wt %, about 0.002 to about 0.003 wt %, about 0.003 to about 0.004 wt %, or about 0.004 to about 0.005 wt %). In some cases, the one or more additional VOCs can include no acetal.

In some cases, the one or more additional VOCs in a rum-like alcoholic beverage can include cinnamaldehyde. The cinnamaldehyde can be present in the rum-like alcoholic beverage in an amount of, for example, about 0.000003 wt % to about 0.0004 wt % (e.g., about 0.000003 to about 0.00001 wt %, about 0.00001 to about 0.00005 wt %, about 0.00005 to about 0.0001 wt %, about 0.0001 to about 0.0002 wt %, or about 0.0002 to about 0.0004 wt %). In some cases, the one or more additional VOCs can include no cinnamaldehyde.

In some cases, the one or more additional VOCs in a rum-like alcoholic beverage can include citral. The citral can be present in the rum-like alcoholic beverage at a concentration of, for example, about 0.2 to about 0.4 mg/L (e.g., about 0.2 to about 0.3 mg/L or about 0.3 to about 0.4 mg/L). In some cases, the citral can be present in the rum-like alcoholic beverage in an amount of, for example, about 0.00002 wt % to about 0.000075 wt % (e.g., about 0.00002 to about 0.00004 wt %, about 0.00004 to about 0.00006 wt %, or about 0.00006 to about 0.00075 wt %). In some cases, about 0.000075 wt % to about 0.02 wt % (e.g., about 0.000075 to about 0.0007 wt %, about 0.0007 wt % to about 0.007 wt %, about 0.007 wt % to about 0.02 wt %) of the one or more additional VOCs can be citral. In some cases, the one or more additional VOCs can include no citral.

In some cases, the one or more additional VOCs in a rum-like alcoholic beverage can include furfural. The furfural can be present in the rum-like alcoholic beverage at a concentration of, for example, about 0.2 to about 100 mg/L (e.g., about 0.2 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, about 35 to about 40 mg/L, about 40 to about 45 mg/L, about 45 to about 50 mg/L, about 50 to about 55 mg/L, about 55 to about 60 mg/L, about 60 to about 65 mg/L, about 65 to about 70 mg/L, about 70 to about 75 mg/L, about 75 to about 80 mg/L, about 80 to about 85 mg/L, about 85 to about 90 mg/L, about 90 to about 95 mg/L, or about 95 to about 100 mg/L). In some cases, the furfural can be present in the rum-like alcoholic beverage in an amount of, for example, about 0.000025 wt % to about 0.0001 wt % (e.g., about 0.000025 to about 0.00005 wt %, about 0.00005 to about 0.000075 wt %, or about 0.000075 to about 0.0001 wt %). In some cases, about 0.0001 wt % to about 6 wt % (e.g., about 0.0001 wt % to about 0.001 wt %, about 0.001 wt % to about 0.01 wt %, about 0.01 wt % to about 0.1 wt %, about 0.1 wt % to about 2 wt %, about 2 wt % to about 4 wt %, or about 4 wt % to about 6 wt %) of the one or more additional VOCs can be furfural. In some cases, the one or more additional VOCs can include no furfural.

In some cases, the one or more additional VOCs in a rum-like alcoholic beverage can include hexanal. The hexanal can be present in the rum-like alcoholic beverage at a concentration of, for example, about 0.003 to about 0.3 mg/L (e.g., about 0.003 wt % to about 0.03 wt %, or about 0.03 wt % to about 0.3 wt %). In some cases, the hexanal can be present in the rum-like alcoholic beverage in an amount of, for example, about 0.000006 wt % to about 0.000026 wt % (e.g., about 0.000006 to about 0.000011 wt %, about 0.000011 to about 0.000016 wt %, about 0.000016 to about 0.000021 wt %, or about 0.000021 to about 0.000026 wt %). In some cases, about 0.000026 wt % to about 0.02 wt % (e.g., about 0.000026 to about 0.0002 wt %, about 0.0002 wt % to about 0.002 wt %, or about 0.002 wt % to about 0.02 wt %) of the one or more additional VOCs can be hexanal. In some cases, the one or more additional VOCs can include no hexanal.

In some cases, the one or more additional VOCs in a rum-like alcoholic beverage can include piperonal. The piperonal can be present in the rum-like alcoholic beverage in an amount of, for example, about 0.00005 wt % to about 0.0008 wt % (e.g., about 0.00005 to about 0.0005 wt %, or about 0.0005 to about 0.0008 wt %), or about 0.00005 wt % to about 0.0005 wt % (e.g., about 0.00005 to about 0.0001 wt %, about 0.0001 to about 0.0002 wt %, about 0.0002 to about 0.0003 wt %, about 0.0003 to about 0.0004 wt %, or about 0.0004 to about 0.0005 wt %). In some cases, the one or more additional VOCs can include no piperonal.

In some cases, the one or more additional VOCs in a rum-like alcoholic beverage can include p-methoxybenzaldehyde. The p-methoxybenzaldehyde can be present in the rum-like alcoholic beverage in an amount of, for example, about 0.00001 wt % to about 0.0001 wt % (e.g., about 0.00001 to about 0.00003 wt %, about 0.00003 to about 0.0005 wt %, about 0.00005 to about 0.00007 wt %, or about 0.00007 to about 0.0001 wt %). In some cases, the one or more additional VOCs can include no p-methoxybenzaldehyde.

In some cases, the one or more additional VOCs in a rum-like alcoholic beverage can include valeraldehyde. The valeraldehyde can be present in the rum-like alcoholic beverage at a concentration of, for example, about 0.001 to about 0.7 mg/L (e.g., about 0.001 to about 0.01 mg/L, about 0.01 to about 0.1 mg/L, about 0.1 to about 0.3 mg/L, about 0.3 to about 0.5 mg/L, or about 0.5 to about 0.7 mg/L). In some cases, a rum replica can contain valeraldehyde at a concentration less than about 0.0024 mg/L (e.g., less than about 0.002 mg/L, or less than about 0.0015 mg/L). In some cases, the valeraldehyde can be present in the rum-like alcoholic beverage in an amount of, for example, about 0.000025 wt % to about 0.0001 wt % (e.g., about 0.000025 to about 0.00005 wt %, about 0.00005 to about 0.000075 wt %, or about 0.000075 to about 0.0001 wt %). In some cases, about 0.0001 wt % to about 0.05 wt % (e.g., about 0.0001 wt % to about 0.001 wt %, about 0.001 wt % to about 0.01 wt %, or about 0.01 wt % to about 0.05 wt %) of the one or more additional VOCs can be valeraldehyde. In some cases, the one or more additional VOCs can include no valeraldehyde.

In some cases, the one or more additional VOCs in a rum-like alcoholic beverage can include vanillin. The vanillin can be present in the rum-like alcoholic beverage in an amount of, for example, about 0.00005 wt % to about 0.000235 wt % (e.g., about 0.00005 to about 0.0001 wt %, about 0.0001 to about 0.00015 wt %, about 0.00015 to about 0.0002 wt %, or about 0.0002 to about 0.000235 wt %), or about 0.0006 wt % to about 0.0008 wt % (e.g., about 0.0006 to about 0.00065 wt %, about 0.00065 to about 0.0007 wt %, about 0.0007 to about 0.00075 wt %, or about 0.00075 to about 0.0008 wt %). In some cases, the one or more additional VOCs can include no vanillin.

In some cases, the one or more additional VOCs in a rum-like alcoholic beverage can include vanillin erythro and threo-butan-2,3-diol acetal. The vanillin erythro and threo-butan-2,3-diol acetal can be present in the rum-like alcoholic beverage in an amount of, for example, about 0.0008 wt % to about 0.0022 wt % (e.g., about 0.0008 to about 0.0012 wt %, about 0.0012 to about 0.0016 wt %, about 0.0016 to about 0.0019 wt %, or about 0.0019 to about 0.0022 wt %), or about 0.0019 wt % to about 0.003 wt % (e.g., about 0.0019 to about 0.0022 wt %, about 0.0022 to about 0.0025 wt %, about 0.0025 to about 0.0028 wt %, or about 0.0028 to about 0.003 wt %). In some cases, the one or more additional VOCs can include no vanillin erythro and threo-butan-2,3-diol acetal.

In some cases, the one or more additional VOCs in a rum-like alcoholic beverage can include allyl hexanoate. The allyl hexanoate can be present in the rum-like alcoholic beverage at a concentration of, for example, about 0.001 to about 2 mg/L (e.g., about 0.001 to about 0.01 mg/L, about 0.01 to about 0.1 mg/L, about 0.1 to about 1 mg/L, or about 1 to about 2 mg/L). In some cases, a rum replica can contain allyl hexanoate at a concentration greater than about 0.034 mg/L (e.g., at least about 0.04 mg/L, at least about 0.1 mg/L, at least about 0.5 mg/L, at least about 1 mg/L, or at least about 1.5 mg/L). In some cases, the allyl hexanoate can be present in the rum-like alcoholic beverage in an amount of, for example, about 0.00001 to about 0.0001 wt % of the one or more additional VOCs can be allyl hexanoate. In some cases, the allyl hexanoate can be present in the rum-like alcoholic beverage in an amount of, for example, about 0.0001 wt % to about 0.0002 wt % (e.g., about 0.0001 to about 0.000125 wt %, about 0.00125 to about 0.00015 wt %, about 0.00015 to about 0.000175 wt %, or about 0.000175 to about 0.0002 wt %). In some cases, about 0.0002 wt % to about 0.07 wt % (e.g., about 0.0002 to about 0.002 mg/L, about 0.002 to about 0.02 mg/L, about 0.02 to about 0.05 mg/L, or about 0.05 to about 0.07 mg/L) of the one or more additional VOCs can be allyl hexanoate. In some cases, the one or more additional VOCs can include no allyl hexanoate.

In some cases, the one or more additional VOCs in a rum-like alcoholic beverage can include benzyl butyrate. The benzyl butyrate can be present in the rum-like alcoholic beverage at a concentration of, for example, about 0.005 to about 1.6 mg/L (e.g., about 0.005 to about 0.05 mg/L, about 0.05 to about 0.5 mg/L, or about 0.5 to about 1.6 mg/L). In some cases, a rum replica can contain benzyl butyrate at a concentration greater than about 0.37 mg/L (e.g., at least about 0.4 mg/L, at least about 0.8 mg/L, at least about 1 mg/L, or at least about 1.3 mg/L). In some cases, the benzyl butyrate can be present in the rum-like alcoholic beverage in an amount of, for example, about 0.00005 wt % to about 0.000075 wt %. In some cases, the benzyl butyrate can be present in the rum-like alcoholic beverage in an amount of, for example, about 0.000075 wt % to about 0.00015 wt % (e.g., about 0.000075 to about 0.0001 wt %, about 0.0001 to about 0.000125 wt %, or about 0.000125 to about 0.00015 wt %). In some cases, about 0.00015 wt % to about 0.04 wt % (e.g., about 0.00015 wt % to about 0.0001 wt %, about 0.0001 wt % to about 0.001 wt %, about 0.001 wt % to about 0.01 wt %, or about 0.01 wt % to about 0.04 wt %) of the one or more additional VOCs can be benzyl butyrate. In some cases, the one or more additional VOCs can include no benzyl butyrate.

In some cases, the one or more additional VOCs in a rum-like alcoholic beverage can include diethyl succinate. The diethyl succinate can be present in the rum-like alcoholic beverage in an amount of, for example, about 0.000005 wt % to about 0.000022 wt % (e.g., about 0.000005 to about 0.000008 wt %, about 0.000008 to about 0.000011 wt %, about 0.000011 to about 0.000014 wt %, about 0.000014 to about 0.000018 wt %, or about 0.000018 to about 0.000022 wt %). In some cases, the one or more additional VOCs can include no diethyl succinate.

In some cases, the one or more additional VOCs in a rum-like alcoholic beverage can include ethyl 2-methylbutyrate. The ethyl 2-methylbutyrate can be present in the rum-like alcoholic beverage in an amount of, for example, about 0.000012 wt % to about 0.000046 wt % (e.g., about 0.000012 to about 0.000023 wt %, about 0.000023 to about 0.000034 wt %, or about 0.000034 to about 0.000046 wt %). In some cases, the one or more additional VOCs can include no ethyl 2-methylbutryate.

In some cases, the one or more additional VOCs in a rum-like alcoholic beverage can include ethyl acetate. The ethyl acetate can be present in the rum-like alcoholic beverage at a concentration of, for example, about 0.2 to about 365 mg/L (e.g., about 0.2 to about 10 mg/L, about 10 to about 50 mg/L, about 50 to about 100 mg/L, about 100 to about 150 mg/L, about 150 to about 200 mg/L, about 200 to about 250 mg/L, about 250 to about 300 mg/L, or about 300 to about 365 mg/L). In some cases, a rum replica can contain ethyl acetate at a concentration less than about 4.6 mg/L (e.g., less than about 4.5 mg/L, less than about 4 mg/L, less than about 2 mg/L, less than about 1 mg/L, or less than about 0.5 mg/L). In some cases, the ethyl acetate can be present in the rum-like alcoholic beverage in an amount of, for example, about 0.0002 wt % to about 0.0008 wt % (e.g., about 0.0002 to about 0.0004 wt %, about 0.0004 to about 0.0006 wt %, or about 0.0006 to about 0.0008 wt %). In some cases, about 0.0008 wt % to about 20 wt % (e.g., about 0.0008 wt % to about 0.008 wt %, about 0.008 wt % to about 0.08 wt %, about 0.08 wt % to about 0.8 wt %, about 0.8 wt % to about 2 wt %, about 2 wt % to about 4 wt %, about 4 wt % to about 6 wt %, about 6 wt % to about 8 wt %, about 8 wt % to about 10 wt %, about 10 wt % to about 12 wt %, about 12 wt % to about 14 wt %, about 14 wt % to about 16 wt %, about 16 wt % to about 18 wt %, or about 18 wt % to about 20 wt %) of the one or more additional VOCs can be ethyl acetate. In some cases, the one or more additional VOCs can include no ethyl acetate.

In some cases, the one or more additional VOCs in a rum-like alcoholic beverage can include ethyl acrylate. The ethyl acrylate can be present in the rum-like alcoholic beverage in an amount of, for example, about 0.000025 wt % to about 0.0001 wt % (e.g., about 0.000025 to about 0.00005 wt %, about 0.00005 to about 0.000075 wt %, or about 0.000075 to about 0.0001 wt %). In some cases, the one or more additional VOCs can include no ethyl acrylate.

In some cases, the one or more additional VOCs in a rum-like alcoholic beverage can include ethyl heptanoate. The ethyl heptanoate can be present in the rum-like alcoholic beverage at a concentration of, for example, about 0.004 mg/L to about 2.4 mg/L (e.g., about 0.004 to about 0.04 mg/L, about 0.04 to about 0.4 mg/L, about 0.4 to about 1 mg/L, or about 1 to about 2.4 mg/L). The ethyl heptanoate can be present in the rum-like alcoholic beverage in an amount of, for example, about 0.00015 wt % to about 0.0002 wt % (e.g., 0.00015 to about 0.00016 wt %, about 0.00016 to about 0.00017 wt %, about 0.00017 to about 0.00018 wt %, about 0.00018 to about 0.00019 wt %, or about 0.00019 to about 0.0002 wt %). In some cases, about 0.000045 wt % to about 0.076 wt % (e.g., about 0.000045 to about 0.0005 wt %, about 0.0005 to about 0.005 wt %, about 0.005 to about 0.05 wt %, or about 0.05 to about 0.075 wt %) of the one or more additional VOCs can be ethyl heptanoate. In some cases, the one or more additional VOCs can include no ethyl heptanoate.

In some cases, the one or more additional VOCs in a rum-like alcoholic beverage can include ethyl hexanoate. The ethyl hexanoate can be present in the rum-like alcoholic beverage at a concentration of about 0.03 mg/L to about 11.5 mg/L (e.g., about 0.03 to about 0.3 mg/L, about 0.3 to about 1 mg/L, about 1 to about 3 mg/L, about 3 to about 7 mg/L, or about 7 to about 11.5 mg/L). The ethyl hexanoate can be present in the rum-like alcoholic beverage in an amount of, for example, about 0.00008 wt % to about 0.00025 wt % (e.g., about 0.00008 to about 0.0001 wt %, about 0.0001 to about 0.00015 wt %, about 0.00015 to about 0.0002 wt %, or about 0.0002 to about 0.00025 wt %). In some cases, about 0.00045 wt % to about 0.74 wt % (e.g., about 0.0005 to about 0.005 wt %, about 0.005 to about 0.05 wt %, about 0.05 to about 0.5 wt %, or about 0.5 to about 0.74 wt %) of the one or more additional VOCs can be ethyl hexanoate. In some cases, the one or more additional VOCs can include no ethyl hexanoate.

In some cases, the one or more additional VOCs in a rum-like alcoholic beverage can include ethyl isovalerate. The ethyl isovalerate can be present in the rum-like alcoholic beverage in an amount of, for example, about 0.00001 wt % to about 0.00004 wt % (e.g., 0.00001 to about 0.00002 wt %, about 0.00002 to about 0.00003 wt %, or about 0.00003 to about 0.00004 wt %). In some cases, the one or more additional VOCs can include no ethyl isovalerate.

In some cases, the one or more additional VOCs in a rum-like alcoholic beverage can include isoamyl acetate. The isoamyl acetate can be present in the rum-like alcoholic beverage at a concentration of, for example, about 0.014 mg/L to about 133 mg/L (e.g., about 0.014 to about 0.01 mg/L, about 0.1 to about 1 mg/L, about 1 to about 5 mg/L, about 5 to about 10 mg/L, about 10 to about 25 mg/L, about 25 to about 50 mg/L, about 50 to about 75 mg/L, about 75 to about 100 mg/L, or about 100 to about 133 mg/L). In some cases, a rum replica can contain isoamyl acetate at a concentration greater than about 21.4 mg/L (e.g., at least about 25 mg/L, at least about 50 mg/L, or at least about 100 mg/L). The isoamyl acetate can be present in the rum-like alcoholic beverage in an amount of, for example, about 0.00008 wt % to about 0.00012 wt %, or about 0.0001 wt % to about 0.002 wt % (e.g., about 0.0001 to about 0.0005 wt %, about 0.0005 to about 0.001 wt %, about 0.001 to about 0.0015 wt %, or about 0.0015 to about 0.002 wt %). In some cases, about 0.00015 wt % to about 3.7 wt % (e.g., about 0.00015 to about 0.001 wt %, about 0.001 to about 0.01 wt %, about 0.01 to about 0.1 wt %, about 0.1 to about 1 wt %, or about 1 to about 3.7 wt %) of the one or more additional VOCs can be isoamyl acetate. In some cases, at least about 0.013 wt % (e.g., at least about 0.02 wt %, at least about 0.1 wt %, at least about 1 wt %, at least about 2 wt %, or at least about 3 wt %) of the one or more additional VOCs can be isoamyl acetate. In some cases, the one or more additional VOCs can include no isoamyl acetate.

In some cases, the one or more additional VOCs in a rum-like alcoholic beverage can include p-anisyl acetate. The p-anisyl acetate can be present in the rum-like alcoholic beverage at a concentration of, for example, about 0.004 to about 4 mg/L (e.g., about 0.004 to about 0.04 mg/L, about 0.04 to about 0.4 mg/L, about 0.4 to about 2 mg/L, or about 0.2 to about 4 mg/L). In some cases, the p-anisyl acetate can be present in the rum-like alcoholic beverage in an amount of, for example, about 0.00015 wt % to about 0.0003 wt % (e.g., about 0.00015 to about 0.0002 wt %, about 0.0002 to about 0.00025 wt %, or about 0.00025 to about 0.0003 wt %). In some cases, about 0.0003 wt % to about 0.3 wt % (e.g., about 0.0003 wt % to about 0.003 wt %, about 0.003 wt % to about 0.03 wt %, or about 0.03 wt % to about 0.3 wt %) of the one or more additional VOCs can be p-anisyl acetate. In some cases, the one or more additional VOCs can include no p-anisyl acetate.

In some cases, the one or more additional VOCs in a rum-like alcoholic beverage can include phenethyl isovalerate. The phenethyl isovalerate can be present in the rum-like alcoholic beverage in an amount of, for example, about 0.000025 wt % to about 0.0001 wt % (e.g., about 0.000025 to about 0.00005 wt %, about 0.00005 to about 0.000075 wt %, or about 0.000075 to about 0.0001 wt %). In some cases, the one or more additional VOCs can include no phenethyl isovalerate.

In some cases, the one or more additional VOCs in a rum-like alcoholic beverage can include tetrahydrofurfuryl acetate. The tetrahydrofurfuryl acetate can be present in the rum-like alcoholic beverage at a concentration of, for example, about 0.5 to about 2 mg/L (e.g., about 0.5 to about 1 mg/L or about 1 to about 2 mg/L). In some cases, the tetrahydrofurfuryl acetate can be present in the rum-like alcoholic beverage in an amount of, for example, about 0.00005 wt % to about 0.00014 wt % (e.g., about 0.00005 to about 0.00008 wt %, about 0.00008 to about 0.0001 wt %, about 0.0001 to about 0.00012 wt %, or about 0.00012 to about 0.00014 wt %), or about 0.00012 wt % to about 0.00019 wt % (e.g., about 0.00012 to about 0.00014 wt %, about 0.00014 to about 0.00017 wt %, or about 0.00017 to about 0.00019 wt %). In some cases, about 0.00017 to about 0.1 wt % (e.g., about 0.00017 wt % to about 0.001 wt %, about 0.001 wt % to about 0.01 wt %, or about 0.01 wt % to about 0.1 wt %) of the one or more additional VOCs can be tetrahydrofurfuryl acetate. In some cases, the one or more additional VOCs can include no tetrahydrofurfuryl acetate.

In some cases, the one or more additional VOCs in a rum-like alcoholic beverage can include 2,3-hexanedione. The 2,3-hexanedione can be present in the rum-like alcoholic beverage at a concentration of about 0.02 mg/L to about 0.07 mg/L (e.g., about 0.02 to about 0.03 mg/L, about 0.03 to about 0.04 mg/L, about 0.04 to about 0.05 mg/L, about 0.05 to about 0.06 mg/L, or about 0.06 to about 0.07 mg/L). The 2,3-hexanedione can be present in the rum-like alcoholic beverage in an amount of, for example, about 0.00001 wt % to about 0.000027 wt % (e.g., about 0.00001 to about 0.000015 wt %, about 0.000015 to about 0.00002 wt %, about 0.00002 to about 0.000024 wt %, or about 0.000024 to about 0.000027 wt %), or about 0.000024 wt % to about 0.000038 wt % (e.g., about 0.000024 to about 0.000028 wt %, about 0.000028 to about 0.000031 wt %, about 0.000031 to about 0.000034 wt %, or about 0.000034 to about 0.000038 wt %). In some cases, about 0.001 wt % to about 0.004 wt % (e.g., about 0.001 to about 0.002 wt %, about 0.002 to about 0.003 wt %, or about 0.003 to about 0.004 wt %) of the one or more additional VOCs can be 2,3-hexanedione. In some cases, the one or more additional VOCs can include no 2,3-hexanedione.

In some cases, the one or more additional VOCs in a rum-like alcoholic beverage can include 2,3-pentanedione. The 2,3-pentanedione can be present in the rum-like alcoholic beverage at a concentration of, for example, about 0.04 to about 4 mg/L (e.g., about 0.04 to about 0.4 mg/L, about 0.4 to about 2 mg/L, or about 2 to about 4 mg/L). In some cases, the 2,3-pentanedione can be present in the rum-like alcoholic beverage in an amount of, for example, about 0.00004 wt % to about 0.00012 wt % (e.g., about 0.00004 to about 0.00008 wt %, about 0.00008 to about 0.0001 wt %, or about 0.0001 to about 0.00012 wt %), or about 0.00018 wt % to about 0.00028 wt % (e.g., about 0.00018 to about 0.0002 wt %, about 0.0002 to about 0.00022 wt %, about 0.00022 to about 0.00024 wt %, about 0.00024 to about 0.00026 wt %, or about 0.00026 to about 0.00028 wt %). In some cases, about 0.0001 wt % to about 0.3 wt % (e.g., about 0.0001 wt % to about 0.001 wt %, about 0.001 wt % to about 0.01 wt %, about 0.01 wt % to about 0.1 wt %, about 0.1 wt % to about 2 wt %, or about 2 wt % to about 3 wt %) of the one or more additional VOCs can be 2,3-pentanedione. In some cases, the one or more additional VOCs can include no 2,3-pentanedione.

In some cases, the one or more additional VOCs in a rum-like alcoholic beverage can include 2-acetoxy-3-butanone. The 2-acetoxy-3-butanone can be present in the rum-like alcoholic beverage in an amount of, for example, about 0.0001 wt % to about 0.00027 wt % (e.g., about 0.0001 to about 0.00015 wt %, about 0.00015 to about 0.0002 wt %, about 0.0002 to about 0.00023 wt %, or about 0.00023 to about 0.00027 wt %), or about 0.00024 wt % to about 0.00038 wt % (e.g., about 0.00024 to about 0.00027 wt %, about 0.00027 to about 0.00031 wt %, about 0.00031 to about 0.00034 wt %, or about 0.00034 to about 0.00038 wt %). In some cases, the one or more additional VOCs can include no 2-acetoxy-3-butanone.

In some cases, the one or more additional VOCs in a rum-like alcoholic beverage can include 3,4-dimethyl-1,2-cyclopentadione. The 3,4-dimethyl-1,2-cyclopentadione can be present in the rum-like alcoholic beverage in an amount of, for example, about 0.000001 wt % to about 0.000003 wt % (e.g., about 0.000001 to about 0.0000015 wt %, about 0.0000015 to about 0.000002 wt %, about 0.000002 to about 0.000025 wt %, or about 0.0000025 to about 0.000003 wt %), or about 0.00006 wt % to about 0.0001 wt % (e.g., about 0.00006 to about 0.00007 wt %, about 0.00007 to about 0.00008 wt %, about 0.00008 to about 0.00009 wt %, or about 0.00009 to about 0.0001 wt %). In some cases, the one or more additional VOCs can include no 3,4-dimethyl-1,2-cyclopentadione.

In some cases, the one or more additional VOCs in a rum-like alcoholic beverage can include 3-ethyl-2-hydroxy-2-cyclopenten-1-one. The 3-ethyl-2-hydroxy-2-cyclopenten-1-one can be present in the rum-like alcoholic beverage in an amount of, for example, about 0.0006 wt % to about 0.0017 wt % (e.g., about 0.0006 to about 0.001 wt %, about 0.001 to about 0.0012 wt %, about 0.0012 to about 0.0015 wt %, or about 0.0015 to about 0.0017 wt %), or about 0.0014 wt % to about 0.0023 wt % (e.g., about 0.0014 to about 0.0016 wt %, about 0.0016 to about 0.0018 wt %, about 0.0018 to about 0.002 wt %, or about 0.002 to about 0.0023 wt %). In some cases, the one or more additional VOCs can include no 3-ethyl-2-hydroxy-2-cyclopenen-1-one.

In some cases, the one or more additional VOCs in a rum-like alcoholic beverage can include 4,5-dimethyl-3-hydroxy-2,5-dihydrofuran-2-one. The 4,5-dimethyl-3-hydroxy-2,5-dihydrofuran-2-one can be present in the rum-like alcoholic beverage in an amount of, for example, about 0.000001 wt % to about 0.000004 wt % (e.g., about 0.000001 to about 0.000002 wt %, about 0.000002 to about 0.000003 wt %, or about 0.000003 to about 0.000004 wt %). In some cases, the one or more additional VOCs can include no 4,5-dimethyl-3-hydroxy-2,5-dihydrofuran-2-one.

In some cases, the one or more additional VOCs in a rum-like alcoholic beverage can include 5-butyl-4-methyldihydro-2(3h)-furanone. The 5-butyl-4-methyldihydro-2(3h)-furanone can be present in the rum-like alcoholic beverage in an amount of, for example, about 0.000006 wt % to about 0.000024 wt % (e.g., about 0.000006 to about 0.000012 wt %, about 0.000012 to about 0.000018 wt %, or about 0.000018 to about 0.000024 wt %). In some cases, the one or more additional VOCs can include no 5-butyl-4-methyldihydro-2(3h)-furanone.

In some cases, the one or more additional VOCs in a rum-like alcoholic beverage can include 6-methyl-5-hepten-2-one. The 6-methyl-5-hepten-2-one can be present in the rum-like alcoholic beverage in an amount of, for example, about 0.0000025 wt % to about 0.00001 wt % (e.g., about 0.0000025 to about 0.000005 wt %, about 0.000005 to about 0.0000075 wt %, or about 0.0000075 to about 0.00001 wt %). In some cases, the one or more additional VOCs can include no 6-methyl-5-hepten-2-one.

In some cases, the one or more additional VOCs in a rum-like alcoholic beverage can include acetoin. The acetoin can be present in the rum-like alcoholic beverage in an amount of, for example, about 0.00019 wt % to about 0.0003 wt % (e.g., about 0.00019 to about 0.00021 wt %, about 0.00021 to about 0.00024 wt %, about 0.00024 to about 0.00027 wt %, or about 0.00027 to about 0.0003 wt %). In some cases, the one or more additional VOCs can include no acetoin.

In some cases, the one or more additional VOCs in a rum-like alcoholic beverage can include beta damascenone. The beta damascenone can be present in the rum-like alcoholic beverage in an amount of, for example, about 0.000004 wt % to about 0.0001 wt % (e.g., about 0.000004 to about 0.00001 wt %, about 0.00001 to about 0.00003 wt %, about 0.00003 to about 0.00007 wt %, or about 0.00007 to about 0.0001 wt %). In some cases, the one or more additional VOCs can include no beta damascenone.

In some cases, the one or more additional VOCs in a rum-like alcoholic beverage can include gamma-decalactone. The gamma-decalactone can be present in the rum-like alcoholic beverage in an amount of, for example, about 0.000025 wt % to about 0.0002 wt % (e.g., about 0.000025 to about 0.00005 wt %, about 0.00005 to about 0.0001 wt %, about 0.0001 to about 0.00015 wt %, or about 0.00015 to about 0.0002 wt %). In some cases, the one or more additional VOCs can include no gamma-decalactone.

In some cases, the one or more additional VOCs in a rum-like alcoholic beverage can include maltol. The maltol can be present in the rum-like alcoholic beverage at a concentration of about 0.04 mg/L to about 1.1 mg/L (e.g., about 0.04 to about 0.1 mg/L, about 0.1 to about 0.5 mg/L, about 0.5 to about 0.8 mg/L, or about 0.8 to about 1.1 mg/L). The maltol can be present in the rum-like alcoholic beverage in an amount of, for example, about 0.0001 wt % to about 0.00025 wt % (e.g., about 0.0001 to about 0.00015 wt %, about 0.00015 to about 0.0002 wt %, or about 0.0002 to about 0.00025 wt %). In some cases, about 0.0004 wt % to about 0.07 wt % (e.g., about 0.0004 to about 0.001 wt %, about 0.001 to about 0.01 wt %, about 0.01 to about 0.03 wt %, about 0.03 to about 0.05 wt %, or about 0.05 to about 0.07 wt %) of the one or more additional VOCs can be maltol. In some cases, the one or more additional VOCs can include no maltol.

In some cases, the one or more additional VOCs in a rum-like alcoholic beverage can include methylcyclopentenolone. The methylcyclopentenolone can be present in the rum-like alcoholic beverage in an amount of, for example, about 0.00032 wt % to about 0.00088 wt % (e.g., about 0.00032 to about 0.0004 wt %, about 0.0004 to about 0.0005 wt %, about 0.0005 to about 0.0006 wt %, about 0.0006 to about 0.00075 wt %, or about 0.00075 to about 0.00088 wt %), or about 0.0015 wt % to about 0.0023 wt %. In some cases, the one or more additional VOCs can include no methylcyclopentenolone.

In some cases, the one or more additional VOCs in a rum-like alcoholic beverage can include piperine. The piperine can be present in the rum-like alcoholic beverage in an amount of, for example, about 0.00003 wt % to about 0.0001 wt % (e.g., about 0.00003 to about 0.00005 wt %, about 0.00005 to about 0.00007 wt %, or about 0.00007 to about 0.0001 wt %). In some cases, the one or more additional VOCs can include no piperine.

In some cases, the one or more additional VOCs in a rum-like alcoholic beverage can include diacetyl. The diacetyl can be present in the rum-like alcoholic beverage in an amount of, for example, about 0.000004 wt %. In some cases, the one or more additional VOCs can include no diacetyl.

In some cases, the one or more additional VOCs in a rum-like alcoholic beverage can include dimethyl disulfide. The dimethyl disulfide can be present in the rum-like alcoholic beverage at a concentration of, for example, about 0.006 to about 2 mg/L (e.g., about 0.006 to about 0.06 mg/L, about 0.06 to about 0.6 mg/L, or about 0.6 to about 2 mg/L). In some cases, the dimethyl disulfide can be present in the rum-like alcoholic beverage in an amount of, for example, about 0.00005 wt % to about 0.0001 wt % (e.g., about 0.00005 to about 0.00006 wt %, about 0.00006 to about 0.00007 wt %, about 0.00007 to about 0.00008 wt %, about 0.00008 to about 0.00009 wt %, or about 0.00009 to about 0.0001 wt %). In some cases, about 0.0001 wt % to about 0.1 wt % (e.g., about 0.0001 wt % to about 0.001 wt %, about 0.001 wt % to about 0.01 wt %, or about 0.01 wt % to about 0.1 wt %) of the one or more additional VOCs can be dimethyl disulfide. In some cases, the one or more additional VOCs can include no dimethyl disulfide.

In some cases, the one or more additional VOCs in a rum-like alcoholic beverage can include methyl sulfide. The methyl sulfide can be present in the rum-like alcoholic beverage in an amount of, for example, about 0.00005 wt % to about 0.00018 wt % (e.g., about 0.00005 to about 0.00008 wt %, about 0.00008 to about 0.00012 wt %, about 0.00012 to about 0.00015 wt %, or about 0.00015 to about 0.00018 wt %). In some cases, the one or more additional VOCs can include no methyl sulfide.

In some cases, the one or more additional VOCs in a rum-like alcoholic beverage can include rum ether. The rum ether can be present in the rum-like alcoholic beverage at a concentration of, for example, about 470 to about 6850 mg/L (e.g., about 470 to about 1000 mg/L, about 1000 to about 1500 mg/L, about 1500 to about 2000 mg/L, about 2000 to about 2500 mg/L, about 2500 to about 3000 mg/L, about 3000 to about 3500 mg/L, about 3500 to about 4000 mg/L, about 4000 to about 5000 mg/L, about 5000 to about 6000 mg/L, or about 6000 to about 6850 mg/L). In some cases, the rum ether can be present in the rum-like alcoholic beverage in an amount of, for example, about 0.04 wt % to about 0.16 wt % (e.g., 0.04 to about 0.08 wt %, about 0.08 to about 0.12 wt %, or about 0.12 to about 0.16 wt %). In some cases, about 0.16 wt % to about 100 wt % (e.g., about 0.16 wt % to about 5 wt %, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 100 wt %) of the one or more additional VOCs can be rum ether. In some cases, the one or more additional VOCs can include no rum ether.

In some cases, the one or more additional VOCs in a rum-like alcoholic beverage can include beta-caryophyllene. The beta-caryophyllene can be present in the rum-like alcoholic beverage at a concentration of, for example, about 0.03 to about 0.06 mg/L (e.g., about 0.03 to about 0.04 mg/L or about 0.04 to about 0.06 mg/L). In some cases, the beta-caryophyllene can be present in the rum-like alcoholic beverage in an amount of, for example, about 0.00001 wt % to about 0.00002 wt % (e.g., about 0.00001 to about 0.000012 wt %, about 0.000012 to about 0.000015 wt %, about 0.000015 to about 0.000018 wt %, or about 0.000018 to about 0.00002 wt %). In some cases, about 0.00002 wt % to about 0.003 wt % (e.g., about 0.00002 wt % to about 0.0002 wt %, about 0.0002 wt % to about 0.002 wt %, or about 0.002 wt % to about 0.003 wt %) of the one or more additional VOCs can be beta-caryophyllene. In some cases, the one or more additional VOCs can include no beta-caryophyllene.

In some cases, the one or more additional VOCs in a rum-like alcoholic beverage can include beta-pinene. The beta-pinene can be present in the rum-like alcoholic beverage at a concentration of, for example, about 0.02 to about 0.04 mg/L. In some cases, the beta-pinene can be present in the rum-like alcoholic beverage in an amount of, for example, about 0.000005 wt % to about 0.00002 wt % (e.g., about 0.000005 to about 0.00001 wt %, about 0.00001 to about 0.000015 wt %, or about 0.000015 to about 0.00002 wt %). In some cases, about 0.00002 wt % to about 0.002 wt % (e.g., about 0.00002 wt % to about 0.0002 wt % or about 0.0002 wt % to about 0.002 wt %) of the one or more additional VOCs can be beta-pinene. In some cases, the one or more additional VOCs can include no beta-pinene.

In some cases, the one or more additional VOCs in a rum-like alcoholic beverage can include D-limonene. In some cases, the D-limonene can be present in the rum-like alcoholic beverage at a concentration of, for example, about 0.03 to about 0.6 mg/L (e.g. about 0.03 to about 0.3 mg/L or about 0.3 to about 0.6 mg/L). In some cases, the d-limonene can be present in the rum-like alcoholic beverage in an amount of, for example, about 0.00005 wt % to about 0.00015 wt % (e.g., about 0.00005 to about 0.0001 wt %, about 0.0001 to about 0.00012 wt %, or about 0.00012 to about 0.00015 wt %). In some cases, about 0.00015 wt % to about 0.04 wt % (e.g., about 0.00015 to about 0.002 wt %, about 0.002 to about 0.02 wt %, or about 0.02 to about 0.042 wt %) of the one or more additional VOCs can be D-limonene. In some cases, the one or more additional VOCs can include no D-limonene.

In some cases, the one or more additional VOCs in a rum-like alcoholic beverage can include linalool. The linalool can be present in the rum-like alcoholic beverage at a concentration of, for example, about 0.01 to about 0.2 mg/L (e.g., about 0.01 to about 0.1 mg/L or about 0.1 to about 0.2 mg/L). In some cases, the linalool can be present in the rum-like alcoholic beverage in an amount of, for example, about 0.000005 wt % to about 0.00004 wt % (e.g., about 0.000005 to about 0.00001 wt %, about 0.00001 to about 0.00002 wt %, about 0.00002 to about 0.00003 wt %, or about 0.00003 to about 0.00004 wt %). In some cases, about 0.00004 wt % to about 0.02 wt % (e.g., about 0.00004 wt % to about 0.0004 wt %, about 0.0004 wt % to about 0.004 wt %, or about 0.004 wt % to about 0.02 wt %) of the one or more additional VOCs can be linalool. In some cases, the one or more additional VOCs can include no linalool.

In some cases, the one or more additional VOCs in a rum-like alcoholic beverage can include myrcene. The myrcene can be present in the rum-like alcoholic beverage at a concentration of, for example, about 0.01 to about 0.03 mg/L (e.g., about 0.01 to about 0.02 mg/L or about 0.02 to about 0.03 mg/L). In some cases, the myrcene can be present in the rum-like alcoholic beverage in an amount of, for example, about 0.000005 wt % to about 0.00001 wt % (e.g., about 0.000005 to about 0.000006 wt %, about 0.000006 to about 0.000007 wt %, about 0.000007 to about 0.000008 wt %, about 0.000008 to about 0.000009 wt %, or about 0.000009 to about 0.00001 wt %). In some cases, about 0.00001 wt % to about 0.002 wt % (e.g., about 0.00001 wt % to about 0.0001 wt %, about 0.0001 wt % to about 0.001 wt %, or about 0.001 wt % to about 0.002 wt %) of the one or more additional VOCs can be myrcene. In some cases, the one or more additional VOCs can include no myrcene.

In some cases, the one or more additional VOCs in a rum-like alcoholic beverage can include 2-pentylfuran, octyl acetate, 1-decanol, decanal, or any combination thereof.

In some cases, the one or more additional VOCs in a rum-like alcoholic beverage can include isobutanol. The isobutanol can be present at a concentration of, for example, about 0.6 to about 438 mg/L (e.g. about 0.6 to about 10 mg/L, about 10 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L, or about 400 to about 438 mg/L). In some cases, a rum replica can contain isobutanol at a concentration greater than about 315 mg/L (e.g., at least about 320 mg/L, at least about 350 mg/L, or at least about 400 mg/L, or about 380 to about 438 mg/L). In some cases, about 0.008 wt % to about 12 wt % (e.g. about 0.008 wt % to about 0.08 wt %, about 0.08 wt % to about 0.8 wt %, about 0.8 wt % to about 2 wt %, about 2 wt % to about 4 wt %, about 4 wt % to about 6 wt %, about 6 wt % to about 8 wt %, about 8 wt % to about 10 wt %, or about 10 wt % to about 12 wt %) of the one or more additional VOCs can be isobutanol. In some cases, the one or more additional VOCs can include no isobutanol.

In some cases, the one or more additional VOCs in a rum-like alcoholic beverage can include isoamyl acetate. The isoamyl acetate can be present at a concentration of, for example, about 5 to about 602 mg/L (e.g. about 5 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L, about 400 to about 450 mg/L, about 450 to about 500 mg/L, about 500 to about 550 mg/L, or about 550 to about 602 mg/L,). In some cases, about 0.06 wt % to about 26 wt % (e.g. about 0.06 wt % to about 0.6 wt %, about 0.6 wt % to about 2 wt %, about 2 wt % to about 4 wt %, about 4 wt % to about 6 wt %, about 6 wt % to about 8 wt %, about 8 wt % to about 10 wt %, about 10 wt % to about 12 wt %, about 12 wt % to about 14 wt %, about 14 wt % to about 16 wt %, about 16 wt % to about 18 wt %, about 18 wt % to about 20 wt %, about 20 wt % to about 22 wt %, about 22 wt % to about 24 wt %, or about 24 wt % to about 26 wt %) of the one or more additional VOCs can be isoamyl acetate. In some cases, the one or more additional VOCs can include no isoamyl acetate.

In some cases, the one or more additional VOCs in a rum-like alcoholic beverage can include ethyl hexanoate. The ethyl hexanoate can be present at a concentration of, for example, about 0.03 to about 12 mg/L (e.g. about 0.03 to about 0.3 mg/L, about 0.3 to about 2 mg/L, about 2 to about 4 mg/L, about 4 to about 6 mg/L, about 6 to about 8 mg/L, about 8 to about 10 mg/L, or about 10 to about 12 mg/L). In some cases, about 0.0004 wt % to about 0.7 wt % (e.g. about 0.0004 wt % to about 0.004 wt %, about 0.004 wt % to about 0.04 wt %, or about 0.04 wt % to about 0.7 wt %,) of the one or more additional VOCs can be ethyl hexanoate. In some cases, the one or more additional VOCs can include no ethyl hexanoate.

In some cases, the one or more additional VOCs in a rum-like alcoholic beverage can include ethyl heptanoate. The ethyl heptanoate can be present at a concentration of, for example, about 0.004 to about 2 mg/L (e.g. about 0.004 to about 0.04 mg/L, about 0.04 to about 0.4 mg/L, or about 0.4 to about 2 mg/L). In some cases, a rum replica can contain ethyl heptanoate at a concentration greater than about 1.84 mg/L (e.g., at least about 1.85 mg/L, or at least about 1.9 mg/L). In some cases, about 0.00005 wt % to about 0.08 wt % (e.g. about 0.00005 wt % to about 0.0005 wt %, about 0.0005 wt % to about 0.005 wt %, about 0.005 wt % to about 0.05 wt %, or about 0.05 wt % to about 0.08 wt %,) of the one or more additional VOCs can be ethyl heptanoate. In some cases, the one or more additional VOCs can include no ethyl heptanoate.

In some cases, the one or more additional VOCs in a rum-like alcoholic beverage can include ethyl octanoate. The ethyl octanoate can be present at a concentration of, for example, about 0.09 to about 8 mg/L (e.g. about 0.09 to about 0.9 mg/L, about 0.9 to about 2 mg/L, about 2 to about 4 mg/L, about 4 to about 6 mg/L, or about 6 to about 8 mg/L). The ethyl octanoate can be present in the rum-like alcoholic beverage in an amount of, for example, about 0.000025 wt % to about 0.00005 wt % (e.g., about 0.000025 to about 0.00003 wt %, about 0.00003 to about 0.00004 wt %, or about 0.00004 to about 0.00005 wt %). In some cases, about 0.0009 wt % to about 0.5 wt % (e.g. about 0.0009 wt % to about 0.009 wt %, about 0.009 wt % to about 0.09 wt %, or about 0.09 wt % to about 0.5 wt %) of the one or more additional VOCs can be ethyl octanoate. In some cases, the one or more additional VOCs can include no ethyl octanoate.

In some cases, the one or more additional VOCs in a rum-like alcoholic beverage can include n-propyl acetate. The n-propyl acetate can be present at a concentration of, for example, about 0.007 to about 5 mg/L (e.g. about 0.007 to about 0.07 mg/L, about 0.07 to about 0.7 mg/L, about 0.7 to about 2 mg/L, about 2 to about 4 mg/L, or about 4 to about 5 mg/L). In some cases, a rum replica can contain n-propyl acetate at a concentration less than about 0.12 mg/L (e.g., less than about 0.1 mg/L, less than about 0.05 mg/L, or less than about 0.01 mg/L). In some cases, about 0.0002 wt % to about 0.3 wt % (e.g. about 0.0002 wt % to about 0.002 wt %, about 0.002 wt % to about 0.02 wt %, or about 0.02 wt % to about 0.3 wt %) of the one or more additional VOCs can be n-propyl acetate. In some cases, the one or more additional VOCs can include no n-propyl acetate.

In some cases, the one or more additional VOCs in a rum-like alcoholic beverage can include isobutyl acetate. The isobutyl acetate can be present at a concentration of, for example, about 0.1 to about 1.5 mg/L (e.g. about 0.1 to about 0.5 mg/L, about 0.5 to about 1.0 mg/L, or about 1.0 to about 1.5 mg/L). In some cases, about 0.001 wt % to about 0.08 wt % (e.g. about 0.001 wt % to about 0.01 wt %, about 0.01 wt % to about 0.05 wt %, or about 0.05 wt % to about 0.08 wt %) of the one or more additional VOCs can be isobutyl acetate. In some cases, the one or more additional VOCs can include no isobutyl acetate.

In some cases, the one or more additional VOCs in a rum-like alcoholic beverage can include isoamyl acetate. The isoamyl acetate can be present at a concentration of, for example, about 0.01 to about 133 mg/L (e.g. about 0.01 to about 0.1 mg/L, about 0.1 to about 1 mg/L, about 1 to about 5 mg/L, about 5 to about 10 mg/L, about 10 to about 15 mg/L, about 15 to about 20 mg/L, about 20 to about 25 mg/L, about 25 to about 30 mg/L, about 30 to about 35 mg/L, about 35 to about 40 mg/L, about 40 to about 45 mg/L, about 45 to about 50 mg/L, about 50 to about 55 mg/L, about 55 to about 60 mg/L, about 60 to about 65 mg/L, about 65 to about 70 mg/L, about 70 to about 75 mg/L, about 75 to about 80 mg/L, about 80 to about 85 mg/L, about 85 to about 90 mg/L, about 90 to about 95 mg/L, about 95 to about 100 mg/L, about 100 to about 105 mg/L, about 105 to about 110 mg/L, about 110 to about 115 mg/L, about 115 to about 120 mg/L, about 120 to about 125 mg/L, about 125 to about 130 mg/L, or about 130 to about 135 mg/L). In some cases, about 0.0002 wt % to about 4 wt % (e.g. about 0.0002 wt % to about 0.002 wt %, about 0.002 wt % to about 0.02 wt %, about 0.02 wt % to about 0.2 wt %, about 0.2 wt % to about 2 wt %, or about 2 wt % to about 4 wt %) of the one or more additional VOCs can be isoamyl acetate. In some cases, the one or more additional VOCs can include no isoamyl acetate.

In some cases, the one or more additional VOCs in a rum-like alcoholic beverage can include butyl acetate. The butyl acetate can be present at a concentration of, for example, about 0.009 to about 0.1 mg/L (e.g. about 0.009 to about 0.09 mg/L, or about 0.09 to about 0.1 mg/L). In some cases, about 0.00009 wt % to about 0.009 wt % (e.g. about 0.00009 wt % to about 0.0009 wt %, or about 0.0009 wt % to about 0.009 wt %) of the one or more additional VOCs can be butyl acetate. In some cases, the one or more additional VOCs can include no butyl acetate.

In some cases, the one or more additional VOCs in a rum-like alcoholic beverage can include heptanyl acetate. The heptanyl acetate can be present at a concentration of, for example, about 0.2 to about 0.4 mg/L (e.g. about 0.2 to about 0.3 mg/L, or about 0.3 to about 0.4). In some cases, about 0.007 wt % to about 0.01 wt % of the one or more additional VOCs can be heptanyl acetate. In some cases, the one or more additional VOCs can include no heptanyl acetate.

In some cases, the one or more additional VOCs in a rum-like alcoholic beverage can include phenethyl acetate. The phenethyl acetate can be present at a concentration of, for example, about 0.009 to about 1 mg/L (e.g. about 0.009 to about 0.09 mg/L, about 0.09 to about 0.9 mg/L, or about 0.9 to about 1 mg/L). In some cases, about 0.0001 wt % to about 0.06 wt % (e.g. about 0.0001 wt % to about 0.001 wt %, or about 0.001 wt % to about 0.06 wt %) of the one or more additional VOCs can be phenethyl acetate. In some cases, the one or more additional VOCs can include no phenethyl acetate.

In some cases, the one or more additional VOCs in a rum-like alcoholic beverage can include octanoic acid. The octanoic acid can be present at a concentration of, for example, about 1.5 to about 8 mg/L (e.g. about 1.5 to about 2 mg/L, about 2 to about 2.5 mg/L, about 2.5 to about 3 mg/L, about 3 to about 3.5 mg/L, about 3.5 to about 4 mg/L, about 4 to about 4.5 mg/L, about 4.5 to about 5 mg/L, about 5 to about 5.5 mg/L, about 5.5 to about 6 mg/L, about 6 to about 6.5 mg/L, about 6.5 to about 7 mg/L, about 7 to about 7.5 mg/L, or about 7.5 to about 8 mg/L). In some cases, about 0.02 wt % to about 0.5 wt % (e.g. about 0.02 wt % to about 0.2 wt %, or about 0.2 wt % to about 0.5 wt %) of the one or more additional VOCs can be octanoic acid. In some cases, the one or more additional VOCs can include no octanoic acid.

In some cases, the one or more additional VOCs in a rum-like alcoholic beverage can include dodecanoic acid. The dodecanoic acid can be present at a concentration of, for example, about 0.9 to about 11 mg/L (e.g. about 0.9 to about 2 mg/L, about 2 to about 4 mg/L, about 4 to about 6 mg/L, about 6 to about 8 mg/L, about 8 to about 10 mg/L, about 10 to about 11 mg/L,). In some cases, about 0.009 wt % to about 0.7 wt % (e.g. about 0.009 wt % to about 0.09 wt % or about 0.09 wt % to about 0.7 wt %) of the one or more additional VOCs can be dodecanoic acid. In some cases, the one or more additional VOCs can include no dodecanoic acid.

In some cases, the one or more additional VOCs in a rum-like alcoholic beverage can include 1-propanol. The 1-propanol can be present at a concentration of, for example, about 380 to about 1300 mg/L (e.g. about 380 to about 400 mg/L, about 400 to about 450 mg/L, about 450 to about 500 mg/L, about 500 to about 550 mg/L, about 550 to about 600 mg/L, about 600 to about 650 mg/L, about 650 to about 700 mg/L, about 700 to about 750 mg/L, about 750 to about 800 mg/L, about 800 to about 850 mg/L, about 850 to about 900 mg/L, about 900 to about 950 mg/L, about 950 to about 1000 mg/L, about 1000 to about 1050 mg/L, about 1050 to about 1100 mg/L, about 1100 to about 1150 mg/L, about 1150 to about 1200 mg/L, about 1200 to about 1250 mg/L, or about 1250 to about 1300 mg/L). In some cases, about 4 wt % to about 66 wt % (e.g. about 4 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, or about 65 wt % to about 66 wt %) of the one or more additional VOCs can be 1-propanol. In some cases, the one or more additional VOCs can include no 1-propanol.

In some cases, the one or more additional VOCs in a rum-like alcoholic beverage can include phenylethyl alcohol. The phenylethyl alcohol can be present at a concentration of, for example, about 0.2 to about 11 mg/L (e.g. about 0.2 to about 2 mg/L, about 2 to about 4 mg/L, about 4 to about 6 mg/L, about 6 to about 8 mg/L, about 8 to about 10 mg/L, or about 10 to about 11 mg/L). In some cases, about 0.002 wt % to about 0.7 wt % (e.g. about 0.002 wt % to about 0.02 wt %, or about 0.02 wt % to about 0.7 wt %,) of the one or more additional VOCs can be phenylethyl alcohol. In some cases, the one or more additional VOCs can include no phenylethyl alcohol.

In some cases, the one or more additional VOCs in a rum-like alcoholic beverage can include benzeneacetaldehyde. The benzeneacetaldehyde can be present at a concentration of, for example, about 0.0005 to about 0.2 mg/L (e.g. about 0.0005 to about 0.001 mg/L, about 0.001 to about 0.05 mg/L, or about 0.05 to about 0.2 mg/L). In some cases, a rum replica can contain benzeneacetaldehyde at a concentration less than about 0.0012 mg/L (e.g., less than about 0.001 mg/L, less than about 0.0008 mg/L, or less than about 0.0006 mg/L). In some cases, about 0.00002 wt % to about 0.01 wt % (e.g. about 0.00002 wt % to about 0.0002 wt %, about 0.0002 wt % to about 0.002 wt %, or about 0.002 wt % to about 0.01 wt %) of the one or more additional VOCs can be benzeneacetaldehyde. In some cases, the one or more additional VOCs can include no benzeneacetaldehyde.

In some cases, the one or more additional VOCs in a rum-like alcoholic beverage can include nonanal. The nonanal can be present at a concentration of, for example, about 0.04 to about 0.4 mg/L (e.g., about 0.04 to about 0.07 mg/L, about 0.07 to about 0.1 mg/L, about 0.1 to about 0.2 mg/L, about 0.2 to about 0.3 mg/L, or about 0.3 to about 0.4 mg/L). In some cases, a rum replica can contain nonanal at a concentration greater than about 0.1 mg/L (e.g., at least about 0.12 mg/L, at least about 0.15 mg/L, at least about 0.2 mg/L, or at least about 0.3 mg/L). In some cases, about 0.0004 wt % to about 0.03 wt % (e.g. about 0.0004 wt % to about 0.004 wt % or about 0.004 wt % to about 0.03 wt %) of the one or more additional VOCs can be nonanal. In some cases, the one or more additional VOCs can include no nonanal.

In some cases, the one or more additional VOCs in a rum-like alcoholic beverage can include benzaldehyde. The benzaldehyde can be present at a concentration of, for example, about 0.1 to about 0.8 mg/L (e.g. about 0.1 to about 0.5 mg/L or about 0.5 to about 0.8 mg/L). In some cases, about 0.001 wt % to about 0.05 wt % (e.g. about 0.001 wt % to about 0.01 wt %, about 0.01 wt % to about 0.05 wt %) of the one or more additional VOCs can be benzaldehyde. In some cases, the one or more additional VOCs can include no benzaldehyde.

In some cases, the one or more additional VOCs in a rum-like alcoholic beverage can include 5-methyl-furfural. The 5-methyl-furfural can be present at a concentration of, for example, about 0.01 to about 2 mg/L (e.g. about 0.01 to about 0.1 mg/L or about 0.1 to about 2 mg/L). In some cases, about 0.002 wt % to about 0.1 wt % (e.g. about 0.002 wt % to about 0.02 wt % or about 0.02 wt % to about 0.1 wt %) of the one or more additional VOCs can be 5-methyl-furfural. In some cases, the one or more additional VOCs can include no 5-methyl-furfural.

In some cases, the one or more additional VOCs in a rum-like alcoholic beverage can include p-cymene. The p-cymene can be present at a concentration of, for example, about 0.002 to about 0.07 mg/L (e.g. about 0.002 to about 0.02 mg/L or about 0.02 to about 0.07 mg/L). In some cases, about 0.00003 wt % to about 0.004 wt % (e.g. about 0.00003 wt % to about 0.0003 wt %, about 0.0003 wt % to about 0.003 wt %, or about 0.003 wt % to about 0.004 wt %) of the one or more additional VOCs can be p-cymene. In some cases, the one or more additional VOCs can include no p-cymene.

In some cases, the one or more additional VOCs in a rum-like alcoholic beverage can include (1)-menthol. The (1)-menthol can be present at a concentration of, for example, about 0.2 to about 0.9 mg/L (e.g. about 0.2 to about 0.4 mg/L or about 0.4 to about 0.9 mg/L). In some cases, about 0.002 wt % to about 0.06 wt % (e.g. about 0.002 wt % to about 0.02 wt %, about 0.02 wt % to about 0.04 wt %, or about 0.04 wt % to about 0.06 wt %) of the one or more additional VOCs can be (1)-menthol. In some cases, the one or more additional VOCs can include no (1)-menthol.

In some cases, the one or more additional VOCs in a rum-like alcoholic beverage can include ethyl propionate. The ethyl propionate can be present at a concentration of, for example, about 0.5 to about 16 mg/L (e.g. about 0.5 to about 1 mg/L, about 1 to about 2 mg/L, about 2 to about 4 mg/L, about 4 to about 6 mg/L, about 6 to about 8 mg/L, about 8 to about 10 mg/L, about 10 to about 12 mg/L, about 12 to about 14 mg/L, or about 14 to about 16 mg/L). In some cases, about 0.0006 wt % to about 1 wt % (e.g. about 0.0006 wt % to about 0.006 wt %, about 0.006 wt % to about 0.06 wt %, about 0.06 wt % to about 0.6 wt %, about 0.6 wt % to about 1 wt %) of the one or more additional VOCs can be ethyl propionate. In some cases, the one or more additional VOCs can include no ethyl propionate.

In some cases, the one or more additional VOCs in a rum-like alcoholic beverage can include ethyl butyrate. The ethyl butyrate can be present at a concentration of, for example, about 0.01 to about 41 mg/L (e.g. about 0.01 to about 0.1 mg/L, about 0.1 to about 2 mg/L, about 2 to about 4 mg/L, about 4 to about 6 mg/L, about 6 to about 8 mg/L, about 8 to about 10 mg/L, about 10 to about 12 mg/L, about 12 to about 14 mg/L, about 14 to about 16 mg/L, about 16 to about 18 mg/L, about 18 to about 20 mg/L, about 20 to about 22 mg/L, about 22 to about 24 mg/L, about 24 to about 26 mg/L, about 26 to about 28 mg/L, about 28 to about 30 mg/L, about 30 to about 32 mg/L, about 32 to about 34 mg/L, about 34 to about 36 mg/L, about 36 to about 38 mg/L, about 38 to about 40 mg/L, or about 40 to about 41 mg/L). In some cases, about 0.0001 wt % to about 3 wt % (e.g. about 0.0003 wt % to about 0.003 wt %, about 0.003 wt % to about 0.03 wt %, about 0.03 wt % to about 0.3 wt %, about 0.3 wt % to about 1 wt %, about 1 wt % to about 2 wt %, or about 2 wt % to about 3 wt %) of the one or more additional VOCs can be ethyl butyrate. In some cases, the one or more additional VOCs can include no ethyl butyrate.

In some cases, the one or more additional VOCs in a rum-like alcoholic beverage can include ethyl benzoate. The ethyl benzoate can be present at a concentration of, for example, about 0.008 to about 0.3 mg/L (e.g. about 0.008 to about 0.08 mg/L or about 0.08 to about 0.3 mg/L). In some cases, about 0.00009 wt % to about 0.02 wt % (e.g. about 0.00009 wt % to about 0.0009 wt %, about 0.0009 wt % to about 0.009 wt %, or about 0.009 wt % to about 0.02 wt %) of the one or more additional VOCs can be ethyl benzoate. In some cases, the one or more additional VOCs can include no ethyl benzoate.

In some cases, the one or more additional VOCs in a rum-like alcoholic beverage can include ethyl dodecanoate. The ethyl dodecanoate can be present at a concentration of, for example, about 0.1 to about 18 mg/L (e.g. about 0.1 to about 2 mg/L, about 2 to about 4 mg/L, about 4 to about 6 mg/L, about 6 to about 8 mg/L, about 8 to about 10 mg/L, about 10 to about 12 mg/L, about 12 to about 14 mg/L, about 14 to about 16 mg/L, or about 16 to about 18 mg/L). In some cases, about 0.001 wt % to about 1 wt % (e.g. about 0.001 wt % to about 0.01 wt %, about 0.01 wt % to about 0.1 wt %, or about 0.1 wt % to about 1 wt %) of the one or more additional VOCs can be ethyl dodecanoate. In some cases, the one or more additional VOCs can include no ethyl dodecanoate.

In some cases, the one or more additional VOCs in a rum-like alcoholic beverage can include isopentyl hexanoate. The isopentyl hexanoate can be present at a concentration of, for example, about 0.02 to about 0.03 mg/L. In some cases, about 0.0002 wt % to about 0.002 wt % of the one or more additional VOCs can be isopentyl hexanoate. In some cases, the one or more additional VOCs can include no isopentyl hexanoate.

In some cases, the one or more additional VOCs in a rum-like alcoholic beverage can include ethyl pentanoate (also referred to as ethyl valerate). The ethyl pentanoate can be present at a concentration of, for example, about 0.1 to about 2 mg/L (e.g. about 0.1 to about 1 mg/L, about 0.1 to about 1.5 mg/L, or about 1.5 to about 2 mg/L). In some cases, the ethyl valerate can be present in the rum-like alcoholic beverage in an amount of, for example, about 0.000005 wt % to about 0.00005 wt % (e.g., about 0.000005 to about 0.00001 wt %, about 0.00001 to about 0.00002 wt %, about 0.00002 to about 0.00003 wt %, about 0.00003 to about 0.00004 wt %, or about 0.00004 to about 0.00005 wt %). In some cases, about 0.001 wt % to about 0.09 wt % (e.g. about 0.001 wt % to about 0.01 wt % or about 0.01 wt % to about 0.09 wt %) of the one or more additional VOCs can be ethyl pentanoate. In some cases, the one or more additional VOCs can include no ethyl pentanoate.

In some cases, the one or more additional VOCs in a rum-like alcoholic beverage can include 2-acetylfuran. The 2-acetylfuran can be present at a concentration of, for example, about 0.003 to about 5 mg/L (e.g. about 0.003 to about 0.03 mg/L, about 0.03 to about 0.3 mg/L, about 0.3 to about 1 mg/L, about 1 to about 3 mg/L, or about 3 to about 5 mg/L). In some cases, about 0.00003 wt % to about 0.3 wt % (e.g. about 0.00003 wt % to about 0.0003 wt %, about 0.0003 wt % to about 0.003 wt %, about 0.003 wt % to about 0.03 wt %, or about 0.03 wt % to about 0.3 wt %) of the one or more additional VOCs can be 2-acetylfuran. In some cases, the one or more additional VOCs can include no 2-acetylfuran.

In some cases, the one or more additional VOCs in a rum-like alcoholic beverage can include diethyl butanedioate. The diethyl butanedioate can be present at a concentration of, for example, about 0.2 to about 0.7 mg/L (e.g. about 0.2 to about 0.4 mg/L, about 0.4 to about 0.6 mg/L, or about 0.6 to about 0.7 mg/L). In some cases, about 0.002 wt % to about 0.04 wt % (e.g. about 0.002 wt % to about 0.02 wt % or about 0.02 wt % to about 0.04 wt %) of the one or more additional VOCs can be diethyl butanedioate. In some cases, the one or more additional VOCs can include no diethyl butanedioate.

In some cases, the one or more additional VOCs in a rum-like alcoholic beverage can include beta-bisabolene. The beta-bisabolene can be present at a concentration of, for example, about 0.05 to about 0.1 mg/L. In some cases, about 0.0006 wt % to about 0.007 wt % of the one or more additional VOCs can be beta-bisabolene. In some cases, the one or more additional VOCs can include no beta-bisabolene.

In some cases, the rum replicas provided herein can include one or more non-volatile compounds. A non-limiting example of a non-volatile compound that can be included in a rum replica is a coloring agent (e.g., a caramel coloring agent, a Food, Drugs and Cosmetics (FD&C) color, or a naturally-sourced color from a fruit or a vegetable). The non-volatile compound(s) can be present at any suitable amount within a rum replica. In some cases, for example, added non-volatile compound(s) can make up about 0.001 to about 0.1 wt % (e.g., about 0.001% to about 0.005 wt %, about 0.005 to about 0.01 wt %, about 0.01 to about 0.05 wt %, or about 0.05 to about 0.1 wt %) of a rum replica. In some cases, a rum replica can include no added non-volatile compounds.

In some embodiments, the non-volatile compounds can include one or more non-volatile compounds that are not present in a corresponding traditional rum. For example, a rum replica provided herein can include one or more (e.g., one, two, three, four, five, six, seven, eight, nine, ten, 15, 20, or more than 20) non-volatile compounds that are not present in a corresponding traditional rum. It is surprising that the rum replicas described herein include one or more compounds not found in any tested traditional rum, as it would be expected that to create a rum replica, one would only think to use compounds found in one or more traditional rums.

In some embodiments, the non-volatile compounds can exclude one or more non-volatile compounds that are present in a corresponding traditional rum. It is surprising that the rum replicas described herein lack one or more compounds found in every tested traditional rums, as one would believe that compounds present in every tested traditional rum to be important to rum flavor.

The non-volatile compounds present in a rum replica can include compounds that fall into any of several categories, including sugars, sugar alcohols, or any combination thereof, amino acids, amino acid derivatives, or any combination thereof, pH-modifying salts; organic acids; nucleobases, nucleotides, or any combination thereof; nitrogen-containing heterocycles; phenolic compounds. Additional categories can include lipids, vitamins, other flavorants, colors, tannin components, salt (e.g., NaCl). It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

Again, non-volatile compounds can be detected in traditional rums using any suitable method, including the LC-MS method described in Example 3 herein. A non-volatile compound that is “not present” in a reference rum is one that is not detected in the reference rum using the methods set forth in Example 3.

A rum replica can include any appropriate number of non-volatile compounds. For example, a rum replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some cases, the number of non-volatile compounds in a rum replica can be less than the number of non-volatile compounds in a single corresponding reference rum.

Further, in some embodiments, the rum replicas provided herein can lack one or more (e.g., one, two, three, four, five, six, seven, eight, nine, ten, or more than ten) non-volatile compounds that are present in corresponding traditional rums. In some cases, the overall population of non-volatile compounds in a rum replica can have less than 95% identity to the non-volatile compounds in a corresponding reference rum (e.g., in a single type of traditionally made rum corresponding to the replica). For example, the non-volatile compounds in a rum replica can have less than 90%, less than 80%, less than 70%, less than 60%, less than 50%, less than 40%, less than 30%, or less than 25% identity to the population of non-volatile compounds in a corresponding reference rum. Some rum replicas may contain at least 1 (e.g., at least 2, at least 5, at least 10, at least 15, at least 20, at least 25, or at least 30) non-volatile compounds that are not found in a single reference rum. Moreover, some rum replicas may contain no more than 50 (e.g., no more than 45, 40, 35, 30, 25, 20, 15, or 10) non-volatile compounds that are present in a single reference rum. For example, in some embodiments, a rum replica can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference rum; in some embodiments, m can be equal to 5, 6, 7, 8, 9, 10, 11, 12, 13, 14, 15, 16, 17, 18, 19, 20, 25, 30, 35, 40, 45, 50, 55, or 60.

As noted above, the amounts of non-volatile compounds in reference rums are measured using the LC-MS methods described herein. In some embodiments, the amount of a particular non-volatile compound in a rum replica can be an amount, based on concentration or percent composition, that is within a range 30% higher and lower than a measured amount for that non-volatile compound in a corresponding reference rum. For example, a non-volatile compound can be present in a rum replica in an amount that is 70 to 90%, 80 to 100%, 90 to 110%, 100 to 120%, 110 to 130%, 70 to 100%, 80 to 110%, 90 to 120%, or 100 to 130% of an amount measured for that non-volatile compound in a corresponding reference rum.

In some cases, the amount of any particular non-volatile compound in a rum replica may be different than the amount of that non-volatile compound in a corresponding reference rum. In some cases, the amount of a non-volatile compound in a rum replica can be 75% or less (e.g., 70% or less, 60% or less, 50% or less, 40% or less, 30% or less, 20% or less, or 10% or less), by concentration or percent mass, than the amount of the same non-volatile compound in a corresponding reference rum. In some cases, the amount of a non-volatile compound in a rum replica can be 125% or more (e.g., 150% or more, 200% or more, or 300% or more), by concentration or percent mass, than the amount of the same non-volatile compound in a corresponding reference rum.

Because of the methods by which they are made, the rum-like alcoholic beverages provided herein can lack contaminants and other detrimental compounds that sometimes are encountered in traditional alcoholic beverages. These include, without limitation, organisms such as Escherichia coli, Salmonella sp., Brettanomyces sp., Lactobacillales, Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, dichloromethane, and heavy metals.

It is noted that while rum replicas can include volatile and non-volatile compounds as listed herein, the added compounds may react with one another to generate additional compounds, or to change the effective amount of one or more of the added compounds within the rum replica formulation.

This document also provides methods for making rum replicas. In some cases, the methods provided herein can be carried out by first mixing water with ethanol (e.g., a grain neutral spirit and optionally a traditional rum, where the traditional rum (if included) is added in an amount such that it makes up about 10 wt % or less (e.g., about 5 wt % or less, or about 1 wt % or less) of the rum replica product), glycerin, optionally an oak extract, optionally one or more salts, optionally one or more sugars or other sweeteners, optionally one or more tannins, optionally, one or more plant oils, fruit oils, plant flavors, or fruit flavors, and small quantities of diluted VOCs and, optionally, non-volatile compounds. In general, the water, ethanol, glycerin, oak extract (when included), salt (when included), sugar/sweetener (when included), tannins (when included), and added VOCs and non-volatile compounds (when included) are all used to generate a final product having the characteristics of a traditionally-produced rum.

In some cases, a method of making a rum replica provided herein can include providing an aqueous solution and adding to the aqueous solution ingredients including ethanol (e.g., a grain neutral spirit and optionally a traditional rum, where the traditional rum (if present) is added in an amount such that it makes up about 10 wt % or less (e.g., about 5 wt % or less, or about 1 wt % or less) of the rum replica product), glycerin, optionally an oak extract, optionally one or more salts, optionally one or more sugars or other sweeteners, optionally one or more tannins, optionally, one or more plant oils, fruit oils, plant flavors, or fruit flavors, optionally one or more nonvolatile compounds (e.g., coloring agents), and one or more (e.g., five or more, 10 or more, 15 or more, 20 or more, 25, or more, 30 or more, 35 or more, or 40 or more) additional VOCs, where the added VOCs are selected from acids, alcohols, aldehydes, esters, ketones, terpenes, furans, and other VOCs that do not fall into one of the foregoing categories. For example, the added VOCs that are combined with the other ingredients can be selected from 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, piperine, diacetyl, dimethyl disulfide, methyl sulfide, rum ether, beta-caryophyllene, beta-pinene, d-limonene, linalool, and myrcene. In some cases, the added VOCs that are combined with the other ingredients can be selected from 1-decanol, 1-octen-3-ol, 1-propanol, 2,3-hexanedione, 2,3-pentanedione, 2-acetoxy-3-butanone, 2-acetylfuran, 2-methoxy-4-propylphenol, 2-methyl-1-butanol, 2-methylbutyraldehyde, 2-methylbutyric acid, 2-pentylfuran, 2-trans,4-trans-decadienal, 3,4-dimethyl-1,2-cyclopentadione, 3-ethyl-2-hydroxy-2-cyclopenten-1-one, 3-methylbutyraldehyde, 4,5-dimethyl-3-hydroxy-2,5-dihydrofuran-2-one, 4-allyl-2,6-dimethoxyphenol, 4-ethylguaiacol, 5-butyl-4-methyldihydro-2(3h)-furanone, 5-methyl-furfural, 6-methyl-5-hepten-2-one, acetal, acetic acid, acetoin, allyl hexanoate, benzaldehyde, benzeneacetaldehyde, benzyl butyrate, beta damascenone, beta-bisabolene, beta-caryophyllene, beta-pinene, butyl acetate, butyric acid, cinnamaldehyde, citral, decanal, decanoic acid, diacetyl, diethyl butanedioate, diethyl succinate, dimethyl disulfide, d-limonene, dodecanoic acid, ethyl 2-methylbutyrate, ethyl 3-phenylpropionate, ethyl acetate, ethyl acrylate, ethyl octanoate, ethyl benzoate, ethyl butyrate, ethyl dodecanoate, ethyl heptanoate, ethyl hexanoate, ethyl isovalerate, ethyl pentanoate, ethyl propionate, ethyl valerate, eucalyptol, eugenol, furfural, gamma-decalactone, geraniol, guaiacol, heptanyl acetate, hexanal, hexanol, isoamyl acetate, isoamyl alcohol, isobutyl acetate, isobutyl alcohol, isoeugenol, isopentyl hexanoate, isobutanol, isovaleric acid, linalool, maltol, menthol, methyl sulfide, methylcyclopentenolone, myrcene, nonanal, n-propyl acetate, octanoic acid, octyl acetate, orange oil, p-anisyl acetate, p-cresol, p-cymene, p-ethylphenol, phenethyl alcohol, phenethyl isovalerate, phenethyl acetate, phenylethyl alcohol, piperine, piperonal, p-methoxybenzaldehyde, rum ether, tetrahydrofurfuryl acetate, valeraldehyde, vanillin, vanillin erythro and threo-butan-2,3-diol acetal, and whiskey lactone. In some cases, the added VOCs that are combined with the other ingredients can be selected from isobutanol, isoamyl acetate, D-limonene, beta-pinene, myrcene, beta-caryophyllene, ethyl hexanoate, ethyl heptanoate, ethyl octanoate, acetic acid, furfural, whiskey lactone, dimethyl disulfide, 2,3-pentanedione, n-propyl acetate, isobutyl acetate, isoamyl acetate, butyl acetate, heptanyl acetate, octyl acetate, phenethyl acetate, tetrahydrofurfuryl acetate, p-anisyl acetate, octanoic acid, decanoic acid, dodecanoic acid, 1-propanol, 2-methyl-1-butanol, 1-octen-3-ol, phenylethyl alcohol, 1-decanol, maltol, hexanal, benzeneacetaldehyde, nonanal, decanal, citral, valeraldehyde, 2,3-hexanedione, benzaldehyde, 5-methyl-furfural, p-cymene, (1)-menthol, ethyl propionate, ethyl butyrate, ethyl benzoate, ethyl dodecanoate, isopentyl hexanoate, allyl hexanoate, benzyl butyrate, ethyl pentanoate, ethyl acetate, 2-acetylfuran, 2-pentylfuran, diethyl butanedioate, rum ether, beta-bisabolene, and linalool. In some cases, the added VOCs that are combined with the other ingredients can be selected from 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

In some cases, this document provides methods for making an aged rum replica. The method can include providing an aqueous solution and adding to the aqueous solution ingredients including ethanol (e.g., a grain neutral spirit and optionally a traditional rum, where the traditional rum (if present) is added in an amount such that it makes up about 10 wt % or less (e.g., about 5 wt % or less, or about 1 wt % or less) of the rum replica product), glycerin, an oak extract, optionally one or more salts, optionally one or more sugars or other sweeteners, one or more tannins, optionally, one or more plant oils, fruit oils, plant flavors, or fruit flavors, optionally one or more nonvolatile compounds (e.g., coloring agents), and VOCs that include one or more acids, alcohols, aldehydes, esters, ketones, terpenes, furans, and VOCs that do not fall into any of the foregoing categories (e.g., one or more of acetic acid, 1-propanol, 2-methyl-1-butanol, furfural, benzeneacetaldehyde, nonanal, valeraldehyde, benzaldehyde, 5-methyl-furfural, isoamyl acetate, tetrahydrofurfuryl acetate, p-anisyl acetate, ethyl propionate, ethyl acetate, diethyl butanedioate, 2,3-hexanedione, maltol, p-cymene, 2-acetylfuran, rum ether, and whiskey lactone.

In some cases, this document provides methods for making a white rum replica. The method can include providing an aqueous solution and adding to the aqueous solution ingredients including ethanol (e.g., a grain neutral spirit and optionally a traditional rum, where the traditional rum (if present) is added in an amount such that it makes up about 10 wt % or less (e.g., about 5 wt % or less, or about 1 wt % or less) of the rum replica product), glycerin, optionally one or more salts, optionally one or more sugars or other sweeteners, optionally one or more tannins, optionally, one or more plant oils, fruit oils, plant flavors, or fruit flavors, optionally one or more nonvolatile compounds, and VOCs that include one or more acids, alcohols, aldehydes, esters, terpenes, furans, and VOCs that do not fall into any of the foregoing categories (e.g., one or more of acetic acid, 1-propanol, 2-methyl-1-butanol, furfural, valeraldehyde, benzaldehyde, 5-methyl-furfural, ethyl hexanoate, ethyl octanoate, isobutyl acetate, ethyl propionate, ethyl acetate, p-cymene, 2-acetylfuran, rum ether, and whiskey lactone.

In some cases, this document provides methods for making a spiced rum replica. The method can include providing an aqueous solution and adding to the aqueous solution ingredients including ethanol (e.g., a grain neutral spirit and optionally a traditional rum, where the traditional rum (if present) is added in an amount such that it makes up about 10 wt % or less (e.g., about 5 wt % or less, or about 1 wt % or less) of the rum replica product), glycerin, optionally an oak extract, optionally one or more salts, optionally one or more sugars or other sweeteners, optionally one or more tannins, optionally, one or more plant oils, fruit oils, plant flavors, or fruit flavors, optionally one or more nonvolatile compounds (e.g., coloring agents), and VOCs that include one or more acids, alcohols, aldehydes, esters, ketones, terpenes, furans, and VOCs that do not fall into any of the foregoing categories (e.g., one or more of acetic acid, isobutanol, 1-propanol, 2-methyl-1-butanol, furfural, hexanal, citral, benzaldehyde, 5-methyl-furfural, isobutyl acetate, tetrahydrofurfuryl acetate, p-anisyl acetate, ethyl propionate, ethyl acetate, 2,3-hexanedione, 2,3-pentanedione, maltol, D-limonene, beta-pinene, myrcene, beta-caryophyllene, linalool, p-cymene, 2-acetylfuran, rum ether, and whiskey lactone.

In some cases, this document provides methods for making an artisanal rum replica. The method can include providing an aqueous solution and adding to the aqueous solution ingredients including ethanol (e.g., a grain neutral spirit and optionally a traditional rum, where the traditional rum (if present) is added in an amount such that it makes up about 10 wt % or less (e.g., about 5 wt % or less, or about 1 wt % or less) of the rum replica product), glycerin, optionally an oak extract, optionally one or more salts, optionally one or more sugars or other sweeteners, optionally one or more tannins, optionally, one or more plant oils, fruit oils, plant flavors, or fruit flavors, optionally one or more nonvolatile compounds (e.g., coloring agents), and VOCs that include one or more acids, alcohols, aldehydes, esters, terpenes, furans, and VOCs that do not fall into any of the foregoing categories (e.g., one or more of acetic acid, isobutanol, isoamyl alcohol, 1-propanol, 2-methyl-1-butanol, 1-octen-3-ol, furfural, valeraldehyde, benzaldehyde, 5-methyl-furfural, ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, ethyl acetate, D-limonene, p-cymene, 2-acetylfuran, dimethyl disulfide, rum ether, and whiskey lactone.

This document also provides methods for generating concentrated versions of any rum-like alcoholic beverage, where the concentrated versions include glycerin, optionally an oak extract, optionally one or more salts, optionally one or more sugars or other sweeteners, optionally one or more tannins, optionally, one or more plant oils, fruit oils, plant flavors, or fruit flavors, and added VOCs and non-volatile components (if any) of the final product, and optionally a traditional rum, but without the full bulk of the ethanol and water (and in some cases, without the traditional rum). Such concentrates can be manufactured and then shipped to a second location, where water and ethanol (e.g., grain neutral spirits and, optionally, traditional rum) can be added at the appropriate ABV and volume to create a finished product.

Any suitable concentration of traditional rum (if included), glycerin, optional oak extract, optional salt(s), optional sugar(s) or other sweetener(s), optional tannin(s), and additional VOCs and (if included) non-volatile compounds can be used. For example, a concentrated rum-like alcoholic beverage can include optionally a traditional rum, glycerin, optionally an oak extract, optionally one or more salts, optionally one or more sugars or other sweeteners, optionally one or more tannins, optionally, one or more plant oils, fruit oils, plant flavors, or fruit flavors, additional VOCs, and non-volatile components (if any) at concentrations that are at least 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold) greater than their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 5-fold, 8-fold, 10-fold, 15-fold, or 20-fold), respectively, with water and ethanol to yield the final product. The concentrates provided herein can contain all of the formulaic components that are present in the final product. In general, such concentrates can be prepared in much the same way as a non-concentrated rum-like alcoholic beverage, by combining the desired amounts of ingredients but omitting the water and the bulk of the ethanol. It is noted that in some cases, some amount of ethanol can be included in the concentrate in order to facilitate dissolution of the added VOCs and, if any, non-volatile compounds.

### Exemplary Embodiments

Embodiment 1 is a rum replica comprising water; a grain neutral spirit; optionally, a traditional rum, wherein said rum replica comprises no more than about 10 wt % of said traditional rum; glycerin; optionally, an oak extract; optionally, a salt; optionally, a sugar or other sweetener; optionally, a tannin; optionally, one or more plant oils, fruit oils, plant flavors, or fruit flavors; and at least ten added volatile organic compounds, wherein said added VOCs comprise at least one acid, at least one additional alcohol, at least one aldehyde, at least one ester, at least one terpene, at least one furan, and optionally at least one ketone, wherein said added VOCs comprise about 0.0001 wt % to about 1 wt % of said rum replica.

Embodiment 2 is the rum replica of embodiment 1, wherein said at least one acid comprises acetic acid.

Embodiment 3 is the rum replica of embodiment 1 or embodiment 2, wherein said at least one additional alcohol comprises one or more of 1-octen-3-ol, 1-propanol, 2-methyl-1-butanol, isoamyl alcohol, and isobutanol.

Embodiment 4 is the rum replica of embodiment 3, wherein said at least one additional alcohol comprises 1-propanol and 2-methyl-1-butanol.

Embodiment 5 is the rum replica of embodiment 3, wherein said at least one additional alcohol comprises isobutanol, isoamyl alcohol, 1-propanol, 2-methyl-1-butanol, and 1-octen-3-ol.

Embodiment 6 is the rum replica of embodiment 3, wherein said at least one additional alcohol comprises isobutanol, 1-propanol, and 2-methyl-1-butanol.

Embodiment 7 is the rum replica of any one of embodiments 1 to 6, wherein said at least one aldehyde comprises one or more of 5-methyl-furfural, benzaldehyde, benzeneacetaldehyde, citral, furfural, hexanal, nonanal, and valeraldehyde.

Embodiment 8 is the rum replica of embodiment 7, wherein said at least one aldehyde comprises furfural, benzeneacetaldehyde, nonanal, valeraldehyde, benzaldehyde, and 5-methyl-furfural.

Embodiment 9 is the rum replica of embodiment 7, wherein said at least one aldehyde comprises furfural, valeraldehyde, benzaldehyde, and 5-methyl-furfural.

Embodiment 10 is the rum replica of embodiment 7, wherein said at least one aldehyde comprises furfural, hexanal, citral, benzaldehyde, and 5-methyl-furfural.

Embodiment 11 is the rum replica of any one of embodiments 1 to 10, wherein said at least one ester comprises one or more of allyl hexanoate, benzyl butyrate, butyl acetate, diethyl butanedioate, ethyl acetate, ethyl octanoate, ethyl butyrate, ethyl heptanoate, ethyl hexanoate, ethyl pentanoate, ethyl propionate, heptanyl acetate, isoamyl acetate, isobutyl acetate, n-propyl acetate, p-anisyl acetate, and tetrahydrofurfuryl acetate.

Embodiment 12 is the rum replica of embodiment 11, wherein said at least one ester comprises isoamyl acetate, tetrahydrofurfuryl acetate, p-anisyl acetate, ethyl propionate, ethyl acetate, and diethyl butanedioate.

Embodiment 13 is the rum replica of embodiment 11, wherein said at least one ester comprises ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, and ethyl acetate.

Embodiment 14 is the rum replica of embodiment 11, wherein said at least one ester comprises isobutyl acetate, tetrahydrofurfuryl acetate, p-anisyl acetate, ethyl propionate, and ethyl acetate.

Embodiment 15 is the rum replica of embodiment 11, wherein said at least one ester comprises ethyl hexanoate, ethyl octanoate, isobutyl acetate, ethyl propionate, and ethyl acetate.

Embodiment 16 is the rum replica of any one of embodiments 1 to 15, wherein said at least one terpene comprises one or more of beta-caryophyllene, beta-pinene, d-limonene, linalool, myrcene, and p-cymene.

Embodiment 17 is the rum replica of embodiment 16, wherein said at least one terpene comprises p-cymene.

Embodiment 18 is the rum replica of embodiment 16, wherein said at least one terpene comprises d-limonene and p-cymene.

Embodiment 19 is the rum replica of embodiment 16, wherein said at least one terpene comprises d-limonene, beta-pinene, myrcene, beta-caryophyllene, linalool, and p-cymene.

Embodiment 20 is the rum replica of any one of embodiments 1 to 19, wherein said at least one furan comprises 2-acetylfuran.

Embodiment 21 is the rum replica of any one of embodiments 1 to 20, wherein said rum replica comprises at least one ketone, and wherein said at least one ketone comprises one or more of 2,3-hexanedione, 2,3-pentanedione, and maltol.

Embodiment 22 is the rum replica of embodiment 21, wherein said at least one ketone comprises 2,3-hexanedione and maltol.

Embodiment 23 is the rum replica of embodiment 21, wherein said at least one ketone comprises 2,3-hexanedione, 2,3-pentanedione, and maltol.

Embodiment 24 is the rum replica of any one of embodiments 1 to 23, wherein said added VOCs further comprise one or more of dimethyl disulfide, rum ether, and whiskey lactone.

Embodiment 25 is the rum replica of embodiment 24, wherein said added VOCs comprise rum ether and whiskey lactone.

Embodiment 26 is the rum replica of embodiment 24, wherein said added VOCs comprise dimethyl disulfide, rum ether, and whiskey lactone.

Embodiment 27 is the rum replica of any one of embodiments 1 to 26, wherein said rum replica comprises an oak extract.

Embodiment 28 is the rum replica of any one of embodiments 1 to 27, wherein said rum replica comprises a salt, and wherein the salt is sodium chloride.

Embodiment 29 is the rum replica of any one of embodiments 1 to 28, wherein said rum replica comprises a sugar or other sweetener selected from the group consisting of sucrose, fructose, glucose, sugar alcohols, and sugar substitutes.

Embodiment 30 is the rum replica of any one of embodiments 1 to 29, wherein said rum replica comprises a tannin.

Embodiment 31 is the rum replica of any one of embodiments 1 to 30, wherein said added VOCs comprise ten or more compounds selected from the group consisting of 1-decanol, 1-octen-3-ol, 1-propanol, 2,3-hexanedione, 2,3-pentanedione, 2-acetylfuran, 2-methyl-1-butanol, 2-pentylfuran, 5-methyl-furfural, acetic acid, allyl hexanoate, benzaldehyde, benzeneacetaldehyde, benzyl butyrate, beta-bisabolene, beta-caryophyllene, beta-pinene, butyl acetate, citral, decanal, diethyl butanedioate, dimethyl disulfide, D-limonene, dodecanoic acid, ethyl acetate, ethyl octanoate, ethyl benzoate, ethyl butyrate, ethyl dodecanoate, ethyl heptanoate, ethyl hexanoate, ethyl pentanoate, ethyl propionate, furfural, heptanyl acetate, isoamyl acetate, isoamyl acetate, isobutyl acetate, isopentyl hexanoate, isobutanol, linalool, maltol, menthol, myrcene, decanoic acid, hexanal, nonanal, n-propyl acetate, octanoic acid, octyl acetate, p-anisyl acetate, p-cymene, phenethyl acetate, phenylethyl alcohol, rum ether, tetrahydrofurfuryl acetate, valeraldehyde, and whiskey lactone.

Embodiment 32 is the rum replica of any one of embodiments 1 to 30, wherein said added VOCs comprise 10 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

Embodiment 33 is the rum replica of any one of embodiments 1 to 30, wherein said added VOCs comprise 20 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

Embodiment 34 is the rum replica of embodiment 1, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

Embodiment 35 is the rum replica of embodiment 1, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

Embodiment 36 is the rum replica of embodiment 1, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

Embodiment 37 is the rum replica of embodiment 1, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

Embodiment 38 is the rum replica of embodiment 1, comprising from about 5 wt % to about 70 wt % water; from about 25 wt % to about 95 wt % grain neutral spirits; from about 1 wt % to about 10 wt % rum; from about 0.1 wt % to about 10 wt % glycerin; optionally, up to about 0.1 wt % salt; optionally, up to about 5 wt % sugar or sweetener; optionally, up to about 0.1 wt % tannins; and from about 0.001 wt % to about 1 wt % added VOCs, wherein said added VOCs comprise ten or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

Embodiment 39 is the rum replica of embodiment 38, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

Embodiment 40 is the rum replica of embodiment 38, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

Embodiment 41 is the rum replica of embodiment 38, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

Embodiment 42 is the rum replica of embodiment 38, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

Embodiment 43 is the rum replica of embodiment 38, wherein said added VOCs comprise isobutanol, and wherein said isobutanol is present in said rum replica at a concentration greater than about 315 mg/L.

Embodiment 44 is the rum replica of embodiment 38, wherein said added VOCs comprise ethyl heptanoate, and wherein said ethyl heptanoate is present in said rum replica at a concentration greater than about 1.84 mg/L.

Embodiment 45 is the rum replica of embodiment 38, wherein said added VOCs comprise acetic acid, and wherein said acetic acid is present in said rum replica at a concentration less than about 7.5 mg/L.

Embodiment 46 is the rum replica of embodiment 38, wherein said added VOCs comprise n-propyl acetate, and wherein said n-propyl acetate is present in said rum replica at a concentration less than about 0.12 mg/L.

Embodiment 47 is the rum replica of embodiment 38, wherein said added VOCs comprise isoamyl acetate, and wherein said isoamyl acetate is present in said rum replica at a concentration greater than about 21.4 mg/L.

Embodiment 48 is the rum replica of embodiment 38, wherein said added VOCs comprise 2-methyl-1-butanol, and wherein said 2-methyl-1-butanol is present in said rum replica at a concentration less than about 3.1 mg/L.

Embodiment 49 is the rum replica of embodiment 38, wherein said added VOCs comprise benzeneacetaldehyde, and wherein said benzeneacetaldehyde is present in said rum replica at a concentration less than about 0.0012 mg/L.

Embodiment 50 is the rum replica of embodiment 38, wherein said added VOCs comprise nonanal, and wherein said nonanal is present in said rum replica at a concentration greater than about 0.1 mg/L.

Embodiment 51 is the rum replica of embodiment 38, wherein said added VOCs comprise valeraldehyde, and wherein said valeraldehyde is present in said rum replica at a concentration less than about 0.0024 mg/L.

Embodiment 52 is the rum replica of embodiment 38, wherein said added VOCs comprise allyl hexanoate, and wherein said allyl hexanoate is present in said rum replica at a concentration greater than about 0.034 mg/L.

Embodiment 53 is the rum replica of embodiment 38, wherein said added VOCs comprise benzyl butyrate, and wherein said benzyl butyrate is present in said rum replica at a concentration in an amount greater than about 0.37 mg/L.

Embodiment 54 is the rum replica of embodiment 38, wherein said added VOCs comprise ethyl acetate, and wherein said ethyl acetate is present in said rum replica at a concentration less than about 4.6 mg/L.

Embodiment 55 is the rum replica of embodiment 38, wherein said added VOCs comprise acetic acid, and wherein less than about 0.001 wt % of the added VOCs is acetic acid.

Embodiment 56 is the rum replica of embodiment 38, wherein said added VOCs comprise isoamyl acetate, and wherein at least about 0.013 wt % of said added VOCs is isoamyl acetate.

Embodiment 57 is the rum replica of embodiment 38, wherein said added VOCs comprise 2-methyl-1-butanol, and wherein less than about 0.0003 wt % of said added VOCs is 2-methyl-1-butanol.

Embodiment 58 is the rum replica of embodiment 38, wherein said added VOCs comprise nonanal, and wherein at least about 0.00007 wt % of said added VOCs is nonanal.

Embodiment 59 is the rum replica of embodiment 38, wherein said added VOCs comprise allyl hexanoate, and wherein at least about 0.00002 wt % of said added VOCs is allyl hexanoate.

Embodiment 60 is the rum replica of embodiment 38, wherein said added VOCs comprise benzyl butyrate, and wherein at least about 0.0002 wt % of said added VOCs is benzyl butyrate.

Embodiment 61 is the rum replica of embodiment 38, wherein said added VOCs comprise ethyl acetate, and wherein less than about 0.0005 wt % of said added VOCs is ethyl acetate.

Embodiment 62 is the rum replica of any one of embodiments 38 to 61, further comprising from about 10 wt % to about 30 wt % oak extract.

Embodiment 63 is the rum replica of any one of embodiments 1 to 62, further comprising from about 0.0005 to about 0.002 wt % orange oil.

Embodiment 64 is the rum replica of any one of embodiments 1 to 63, wherein the total concentration of said one or more esters in said rum replica is less than about 7.5 mg/L.

Embodiment 65 is the rum replica of any one of embodiments 1 to 64, wherein the total concentration of said one or more acids in the rum replica is less than about 10 mg/L.

Embodiment 66 is a method for making a rum replica, wherein said method comprises combining: water; a grain neutral spirit; optionally, a traditional rum, wherein said rum replica comprises no more than about 10 wt % of said rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein said added VOCs comprise at least one acid, at least one additional alcohol, at least one aldehyde, at least one ester, and at least one terpene, at least one furan, and optionally at least one ketone, wherein said added VOCs comprise about 0.0001 wt % to about 1 wt % of said rum replica.

Embodiment 67 is the method of embodiment 66, wherein said at least one acid comprises acetic acid.

Embodiment 68 is the method of embodiment 66 or embodiment 67, wherein said at least one additional alcohol comprises one or more of 1-octen-3-ol, 1-propanol, 2-methyl-1-butanol, isoamyl alcohol, and isobutanol.

Embodiment 69 is the method of embodiment 68, wherein said at least one additional alcohol comprises 1-propanol and 2-methyl-1-butanol.

Embodiment 70 is the method of embodiment 68, wherein said at least one additional alcohol comprises isobutanol, isoamyl alcohol, 1-propanol, 2-methyl-1-butanol, and 1-octen-3-ol.

Embodiment 71 is the method of embodiment 68, wherein said at least one additional alcohol comprises isobutanol, 1-propanol, and 2-methyl-1-butanol.

Embodiment 72 is the method of any one of embodiments 66 to 71, wherein said at least one aldehyde comprises one or more of 5-methyl-furfural, benzaldehyde, benzeneacetaldehyde, citral, furfural, hexanal, nonanal, and valeraldehyde.

Embodiment 73 is the method of embodiment 72, wherein said at least one aldehyde comprises furfural, benzeneacetaldehyde, nonanal, valeraldehyde, benzaldehyde, and 5-methyl-furfural.

Embodiment 74 is the method of embodiment 72, wherein said at least one aldehyde comprises furfural, valeraldehyde, benzaldehyde, and 5-methyl-furfural.

Embodiment 75 is the method of embodiment 72, wherein said at least one aldehyde comprises furfural, hexanal, citral, benzaldehyde, and 5-methyl-furfural.

Embodiment 76 is the method of any one of embodiments 66 to 75, wherein said at least one ester comprises one or more of allyl hexanoate, benzyl butyrate, butyl acetate, diethyl butanedioate, ethyl acetate, ethyl octanoate, ethyl butyrate, ethyl heptanoate, ethyl hexanoate, ethyl pentanoate, ethyl propionate, heptanyl acetate, isoamyl acetate, isobutyl acetate, n-propyl acetate, p-anisyl acetate, and tetrahydrofurfuryl acetate.

Embodiment 77 is the method of embodiment 76, wherein said at least one ester comprises isoamyl acetate, tetrahydrofurfuryl acetate, p-anisyl acetate, ethyl propionate, ethyl acetate, and diethyl butanedioate.

Embodiment 78 is the method of embodiment 76, wherein said at least one ester comprises ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, and ethyl acetate.

Embodiment 79 is the method of embodiment 76, wherein said at least one ester comprises isobutyl acetate, tetrahydrofurfuryl acetate, p-anisyl acetate, ethyl propionate, and ethyl acetate.

Embodiment 80 is the method of embodiment 76, wherein said at least one ester comprises ethyl hexanoate, ethyl octanoate, isobutyl acetate, ethyl propionate, and ethyl acetate.

Embodiment 81 is the method of any one of embodiments 66 to 80, wherein said at least one terpene comprises one or more of beta-caryophyllene, beta-pinene, d-limonene, linalool, myrcene, and p-cymene.

Embodiment 82 is the method of embodiment 81, wherein said at least one terpene comprises p-cymene.

Embodiment 83 is the method of embodiment 81, wherein said at least one terpene comprises d-limonene and p-cymene.

Embodiment 84 is the method of embodiment 81, wherein said at least one terpene comprises d-limonene, beta-pinene, myrcene, beta-caryophyllene, linalool, and p-cymene.

Embodiment 85 is the method of any one of embodiments 66 to 84, wherein said at least one furan comprises 2-acetylfuran.

Embodiment 86 is the method of any one of embodiments 66 to 85, wherein said rum replica comprises at least one ketone, and wherein said at least one ketone comprises one or more of 2,3-hexanedione, 2,3-pentanedione, and maltol.

Embodiment 87 is the method of embodiment 86, wherein said at least one ketone comprises 2,3-hexanedione and maltol.

Embodiment 88 is the method of embodiment 86, wherein said at least one ketone comprises 2,3-hexanedione, 2,3-pentanedione, and maltol.

Embodiment 89 is the method of any one of embodiments 66 to 88, wherein said added VOCs further comprise one or more of dimethyl disulfide, rum ether, and whiskey lactone.

Embodiment 90 is the method of embodiment 89, wherein said added VOCs comprise rum ether and whiskey lactone.

Embodiment 91 is the method of embodiment 89, wherein said added VOCs comprise dimethyl disulfide, rum ether, and whiskey lactone.

Embodiment 92 is the method of any one of embodiments 66 to 91, wherein said rum replica comprises an oak extract.

Embodiment 93 is the method of any one of embodiments 66 to 92, wherein said rum replica comprises a salt, and wherein the salt is sodium chloride.

Embodiment 94 is the method of any one of embodiments 66 to 93, wherein said rum replica comprises a sugar or other sweetener selected from the group consisting of sucrose, fructose, glucose, sugar alcohols, and sugar substitutes.

Embodiment 95 is the method of any one of embodiments 66 to 94, wherein said rum replica comprises a tannin.

Embodiment 96 is the method of any one of embodiments 66 to 95, wherein said added VOCs comprise ten or more compounds selected from the group consisting of 1-decanol, 1-octen-3-ol, 1-propanol, 2,3-hexanedione, 2,3-pentanedione, 2-acetylfuran, 2-methyl-1-butanol, 2-pentylfuran, 5-methyl-furfural, acetic acid, allyl hexanoate, benzaldehyde, benzeneacetaldehyde, benzyl butyrate, beta-bisabolene, beta-caryophyllene, beta-pinene, butyl acetate, citral, decanal, diethyl butanedioate, dimethyl disulfide, D-limonene, dodecanoic acid, ethyl acetate, ethyl octanoate, ethyl benzoate, ethyl butyrate, ethyl dodecanoate, ethyl heptanoate, ethyl hexanoate, ethyl pentanoate, ethyl propionate, furfural, heptanyl acetate, isoamyl acetate, isoamyl acetate, isobutyl acetate, isopentyl hexanoate, isobutanol, linalool, maltol, menthol, myrcene, decanoic acid, hexanal, nonanal, n-propyl acetate, octanoic acid, octyl acetate, p-anisyl acetate, p-cymene, phenethyl acetate, phenylethyl alcohol, rum ether, tetrahydrofurfuryl acetate, valeraldehyde, and whiskey lactone.

Embodiment 97 is the method of any one of embodiments 66 to 95, wherein said added VOCs comprise 10 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

Embodiment 98 is the method of any one of embodiments 66 to 95, wherein said added VOCs comprise 20 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

Embodiment 99 is the method of embodiment 66, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

Embodiment 100 is the method of embodiment 66, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

Embodiment 101 is the method of embodiment 66, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

Embodiment 102 is the method of embodiment 66, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

Embodiment 103 is the method of embodiment 66, comprising combining from about 5 wt % to about 70 wt % water; from about 25 wt % to about 95 wt % grain neutral spirits; from about 1 wt % to about 10 wt % traditional rum; from about 0.1 wt % to about 10 wt % glycerin; optionally, up to about 0.1 wt % salt; optionally, up to about 5 wt % sugar or sweetener; optionally, up to about 0.1 wt % tannins; and from about 0.001 wt % to about 1 wt % added VOCs, wherein said added VOCs comprise ten or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

Embodiment 104 is the method of embodiment 103, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

Embodiment 105 is the method of embodiment 103, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

Embodiment 106 is the method of embodiment 103, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

Embodiment 107 is the method of embodiment 103, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

Embodiment 108 is the method of embodiment 103, wherein said added VOCs comprise isobutanol, and wherein said isobutanol is present in said rum replica at a concentration greater than about 315 mg/L.

Embodiment 109 is the method of embodiment 103, wherein said added VOCs comprise ethyl heptanoate, and wherein said ethyl heptanoate is present in said rum replica at a concentration greater than about 1.84 mg/L.

Embodiment 110 is the method of embodiment 103, wherein said added VOCs comprise acetic acid, and wherein said acetic acid is present in said rum replica at a concentration less than about 7.5 mg/L.

Embodiment 111 is the method of embodiment 103, wherein said added VOCs comprise n-propyl acetate, and wherein said n-propyl acetate is present in said rum replica at a concentration less than about 0.12 mg/L.

Embodiment 112 is the method of embodiment 103, wherein said added VOCs comprise isoamyl acetate, and wherein said isoamyl acetate is present in said rum replica at a concentration greater than about 21.4 mg/L.

Embodiment 113 is the method of embodiment 103, wherein said added VOCs comprise 2-methyl-1-butanol, and wherein said 2-methyl-1-butanol is present in said rum replica at a concentration less than about 3.1 mg/L.

Embodiment 114 is the method of embodiment 103, wherein said added VOCs comprise benzeneacetaldehyde, and wherein said benzeneacetaldehyde is present in said rum replica at a concentration less than about 0.0012 mg/L.

Embodiment 115 is the method of embodiment 103, wherein said added VOCs comprise nonanal, and wherein said nonanal is present in said rum replica at a concentration greater than about 0.1 mg/L.

Embodiment 116 is the method of embodiment 103, wherein said added VOCs comprise valeraldehyde, and wherein said valeraldehyde is present in said rum replica at a concentration less than about 0.0024 mg/L.

Embodiment 117 is the method of embodiment 103, wherein said added VOCs comprise allyl hexanoate, and wherein said allyl hexanoate is present in said rum replica at a concentration greater than about 0.034 mg/L.

Embodiment 118 is the method of embodiment 103, wherein said added VOCs comprise benzyl butyrate, and wherein said benzyl butyrate is present in said rum replica at a concentration in an amount greater than about 0.37 mg/L.

Embodiment 119 is the method of embodiment 103, wherein said added VOCs comprise ethyl acetate, and wherein said ethyl acetate is present in said rum replica at a concentration less than about 4.6 mg/L.

Embodiment 120 is the method of embodiment 103, wherein said added VOCs comprise acetic acid, and wherein less than about 0.001 wt % of the added VOCs is acetic acid.

Embodiment 121 is the method of embodiment 103, wherein said added VOCs comprise isoamyl acetate, and wherein at least about 0.013 wt % of said added VOCs is isoamyl acetate.

Embodiment 122 is the method of embodiment 103, wherein said added VOCs comprise 2-methyl-1-butanol, and wherein less than about 0.0003 wt % of said added VOCs is 2-methyl-1-butanol.

Embodiment 123 is the method of embodiment 103, wherein said added VOCs comprise nonanal, and wherein at least about 0.00007 wt % of said added VOCs is nonanal.

Embodiment 124 is the method of embodiment 103, wherein said added VOCs comprise allyl hexanoate, and wherein at least about 0.00002 wt % of said added VOCs is allyl hexanoate.

Embodiment 125 is the method of embodiment 103, wherein said added VOCs comprise benzyl butyrate, and wherein at least about 0.0002 wt % of said added VOCs is benzyl butyrate.

Embodiment 126 is the method of embodiment 103, wherein said added VOCs comprise ethyl acetate, and wherein less than about 0.0005 wt % of said added VOCs is ethyl acetate.

Embodiment 127 is the method of any one of embodiments 104 to 127, further comprising adding from about 10 wt % to about 30 wt % oak extract to said rum replica.

Embodiment 128 is the method of any one of embodiments 67 to 128, further comprising adding from about 0.0005 to about 0.002 wt % orange oil to said rum replica.

Embodiment 129 is the method of any one of embodiments 67 to 129, wherein the total concentration of said one or more esters in said rum replica is less than about 7.5 mg/L.

Embodiment 130 is the method of any one of embodiments 67 to 130, wherein the total concentration of said one or more acids in the rum replica is less than about 10 mg/L.

Embodiment 131 is a rum replica produced by the method of any one of embodiments 66 to 130.

Embodiment 132 is a rum-like alcoholic beverage concentrate comprising: optionally, a traditional rum, wherein said alcoholic beverage, after dilution to produce a final product, comprises no more than about 10 wt % of said rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein said added VOCs comprise at least one acid, at least one additional alcohol, at least one aldehyde, at least one ester, at least one terpene, at least one furan, and optionally at least one ketone, wherein at least one of said added VOCs is present in a concentration of at least about 2-fold the concentration of the same VOC in a corresponding traditional rum or a corresponding non-concentrate rum-like alcoholic beverage.

Embodiment 133 is the rum-like alcoholic beverage concentrate of embodiment 132, wherein at least one of said added VOCs is present in the concentrate in a concentration of at least about 5-fold the concentration of the same VOCs in a corresponding traditional rum or a corresponding non-concentrate rum-like alcoholic beverage.

Embodiment 134 is the rum-like alcoholic beverage concentrate of embodiment 132, wherein at least one of said added VOCs is present in the concentrate in a concentration of at least about 10-fold the concentration of the same VOCs in a corresponding traditional rum or a corresponding non-concentrate rum-like alcoholic beverage.

Embodiment 135 is the rum-like alcoholic beverage concentrate of embodiment 132, wherein at least one of said added VOCs is present in the concentrate in a concentration of at least about 15-fold the concentration of the same VOCs in a corresponding traditional rum or a corresponding non-concentrate rum-like alcoholic beverage.

Embodiment 136 is the rum-like alcoholic beverage concentrate of any one of embodiments 132 to 135, wherein upon dilution of said rum-like beverage concentrate to a rum-like alcoholic beverage, the rum-like alcoholic beverage is the rum replica of any one of embodiments 1 to 65.

Embodiment 137 is a method of making a rum-like alcoholic beverage concentrate, the method comprising combining: optionally, a rum, wherein said alcoholic beverage, after dilution to produce a final product, comprises no more than about 10 wt % of said rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein said added VOCs comprise at least one acid, at least one additional alcohol, at least one aldehyde, at least one ester, at least one terpene, at least one furan, and optionally at least one ketone, wherein at least one of said added VOCs is present in a concentration of at least about 2-fold the concentration of the same VOC in a corresponding traditional rum or a corresponding non-concentrate rum-like alcoholic beverage.

Embodiment 138 is the method of embodiment 137, wherein at least one of said added VOCs is present in the concentrate in a concentration of at least about 5-fold the concentration of the same VOCs in a corresponding traditional rum or a corresponding non-concentrate rum-like alcoholic beverage.

Embodiment 139 is the method of embodiment 137, wherein at least one of said added VOCs is present in the concentrate in a concentration of at least about 10-fold the concentration of the same VOCs in a corresponding traditional rum or a corresponding non-concentrate rum-like alcoholic beverage.

Embodiment 140 is the method of embodiment 137, wherein at least one of said added VOCs is present in the concentrate in a concentration of at least about 15-fold the concentration of the same VOCs in a corresponding traditional rum or a corresponding non-concentrate rum-like alcoholic beverage.

Embodiment 141 is the method of any one of embodiments 137 to 140, wherein upon dilution of the rum-like beverage concentrate to a rum-like alcoholic beverage, the rum-like alcoholic beverage is the rum replica of any one of embodiments 1 to 65.

Embodiment 142 is an alcoholic beverage comprising (or consisting essentially of or consisting of) water; a grain neutral spirit; a rum, wherein the alcoholic beverage comprises no more than about 10 wt % of the rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein the added VOCs comprise at least one additional alcohol, at least one aldehyde, at least one ester, at least one ketone, optionally at least one acid, and optionally at least one terpene, and wherein the added VOCs comprise about 0.0001 wt % to about 1 wt % of the alcoholic beverage.

Embodiment 143 is the alcoholic beverage of embodiment 142, wherein the alcoholic beverage comprises the at least one acid, and wherein the at least one acid comprises one or more of 2-methylbutyric acid, acetic acid, butyric acid, decanoic acid, and isovaleric acid.

Embodiment 144 is the alcoholic beverage of embodiment 142 or embodiment 143, wherein the at least one additional alcohol comprises one or more of (+/−) 2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, and phenethyl alcohol.

Embodiment 145 is the alcoholic beverage of any one of embodiments 142 to 144, wherein the at least one aldehyde comprises one or more of 2-methylbutyraldehyde, 3-methylbutyraldehyde, acetal, cinnamaldehyde, citral, furfural, hexanal, piperonal, p-methoxybenzaldehyde, valeraldehyde, vanillin, and vanillin erythro and threo-butan-2,3-diol acetal.

Embodiment 146 is the alcoholic beverage of any one of embodiments 142 to 145, wherein the at least one ester comprises one or more of allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, and tetrahydrofurfuryl acetate.

Embodiment 147 is the alcoholic beverage of any one of embodiments 142 to 146 wherein the at least one ketone comprises one or more of 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, and piperine.

Embodiment 148 is the alcoholic beverage of any one of embodiments 142 to 147, wherein the beverage comprises at least one terpene, and wherein the at least one terpene comprises one or more of beta-caryophyllene, beta-pinene, d-limonene, linalool, and myrcene.

Embodiment 149 is the alcoholic beverage of any one of embodiments 142 to 148, wherein the added VOCs further comprise one or more of diacetyl, dimethyl disulfide, methyl sulfide, whiskey lactone, and rum ether.

Embodiment 150 is the alcoholic beverage of any one of embodiments 142 to 149, wherein the alcoholic beverage comprises an oak extract.

Embodiment 151 is the alcoholic beverage of any one of embodiments 142 to 150, wherein the alcoholic beverage comprises a salt, and wherein the salt is sodium chloride.

Embodiment 152 is the alcoholic beverage of any one of embodiments 142 to 151, wherein the alcoholic beverage comprises a sugar or other sweetener selected from the group consisting of sucrose, fructose, glucose, sugar alcohols, and sugar substitutes.

Embodiment 153 is the alcoholic beverage of any one of embodiments 142 to 152, wherein the alcoholic beverage comprises a tannin.

Embodiment 154 is the alcoholic beverage of any one of embodiments 142 to 153, wherein the added VOCs comprise ten or more compounds selected from the group consisting of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, piperine, diacetyl, dimethyl disulfide, methyl sulfide, rum ether, beta-caryophyllene, beta-pinene, d-limonene, linalool, and myrcene.

Embodiment 155 is the alcoholic beverage of any one of embodiments 142 to 153, wherein the added VOCs comprise 20 or more compounds selected from the group consisting of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, piperine, diacetyl, dimethyl disulfide, methyl sulfide, rum ether, beta-caryophyllene, beta-pinene, d-limonene, linalool, and myrcene.

Embodiment 156 is the alcoholic beverage of embodiment 142, comprising (or consisting essentially of or consisting of) from about 5 wt % to about 70 wt % water; from about 25 wt % to about 95 wt % grain neutral spirits; from about 1 wt % to about 10 wt % rum; from about 0.1 wt % to about 10 wt % glycerin; from about 10 wt % to about 30 wt % oak extract; optionally, up to about 0.1 wt % salt; optionally, up to about 5 wt % sugar or sweetener; optionally, up to about 0.1 wt % tannins; and from about 0.001 wt % to about 1 wt % added VOCs, wherein the added VOCs comprise ten or more compounds selected from the group consisting of hexanol, vanillin erythro and threo-butan-2,3-diol acetal, diethyl succinate, tetrahydrofurfuryl acetate, isoamyl acetate, p-anisyl acetate, ethyl acetate, 3,4-dimethyl-1,2-cyclopentadione, 6-methyl-5-hepten-2-one, 2,3-hexanedione, 2,3-pentanedione, 2-acetoxy-3-butanone, methylcyclopentenolone, 3-ethyl-2-hydroxy-2-cyclopenten-1-one, and rum ether.

Embodiment 157 is the alcoholic beverage of embodiment 156, wherein the added VOCs consist of hexanol, vanillin erythro and threo-butan-2,3-diol acetal, diethyl succinate, tetrahydrofurfuryl acetate, isoamyl acetate, p-anisyl acetate, ethyl acetate, 3,4-dimethyl-1,2-cyclopentadione, 6-methyl-5-hepten-2-one, 2,3-hexanedione, 2,3-pentanedione, 2-acetoxy-3-butanone, methylcyclopentenolone, 3-ethyl-2-hydroxy-2-cyclopenten-1-one, and rum ether.

Embodiment 158 is the alcoholic beverage of embodiment 142, comprising (or consisting essentially of or consisting of) from about 5 wt % to about 70 wt % water; from about 25 wt % to about 95 wt % grain neutral spirits; from about 1 wt % to about 10 wt % rum; from about 0.1 wt % to about 10 wt % glycerin; optionally, up to about 0.1 wt % salt; optionally, up to about 5 wt % sugar or sweetener; optionally, up to about 0.1 wt % tannins; and from about 0.001 wt % to about 1 wt % added VOCs, wherein the added VOCs comprise 20 or more compounds selected from the group consisting of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, guaiacol, isoamyl alcohol, isobutyl alcohol, p-ethylphenol, phenethyl alcohol, 2-methylbutyraldehyde, 3-methylbutyraldehyde, acetal, furfural, hexanal, piperonal, valeraldehyde, vanillin, allyl hexanoate, benzyl butyrate, ethyl 2-methylbutyrate, ethyl acrylate, ethyl heptanoate, ethyl hexanoate, ethyl isovalerate, ethyl octanoate, ethyl valerate, isoamyl acetate, phenethyl isovalerate, 4,5-dimethyl-3-hydroxy-2,5-dihydrofuran-2-one, 5-butyl-4-methyldihydro-2(3h)-furanone, beta damascenone, gamma-decalactone, diacetyl, dimethyl disulfide, methyl sulfide, and rum ether.

Embodiment 159 is the alcoholic beverage of embodiment 158, wherein the added VOCs consist of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, guaiacol, isoamyl alcohol, isobutyl alcohol, p-ethylphenol, phenethyl alcohol, 2-methylbutyraldehyde, 3-methylbutyraldehyde, acetal, furfural, hexanal, piperonal, valeraldehyde, vanillin, allyl hexanoate, benzyl butyrate, ethyl 2-methylbutyrate, ethyl acrylate, ethyl heptanoate, ethyl hexanoate, ethyl isovalerate, ethyl octanoate, ethyl valerate, isoamyl acetate, phenethyl isovalerate, 4,5-dimethyl-3-hydroxy-2,5-dihydrofuran-2-one, 5-butyl-4-methyldihydro-2(3h)-furanone, beta damascenone, gamma-decalactone, diacetyl, dimethyl disulfide, methyl sulfide, and rum ether.

Embodiment 160 is the alcoholic beverage of embodiment 142, comprising (or consisting essentially of or consisting of) from about 5 wt % to about 70 wt % water; from about 25 wt % to about 95 wt % grain neutral spirits; from about 1 wt % to about 10 wt % rum; from about 0.1 wt % to about 10 wt % glycerin; optionally, up to about 30 wt % oak extract; optionally, up to about 0.1 wt % salt; optionally, up to about 5 wt % sugar or sweetener; optionally, up to about 0.1 wt % tannins; from about 0.0005 to about 0.002 wt % orange oil; and from about 0.001 wt % to about 1 wt % added VOCs, wherein the added VOCs comprise ten or more compounds selected from the group consisting of eucalyptol, eugenol, geraniol, guaiacol, isoeugenol, cinnamaldehyde, citral, piperonal, p-methoxybenzaldehyde, vanillin, vanillin erythro and threo-butan-2,3-diol acetal, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, acetoin, maltol, methylcyclopentenolone, piperine, beta-caryophyllene, beta-pinene, d-limonene, linalool, and myrcene.

Embodiment 161 is the alcoholic beverage of embodiment 160, wherein the added VOCs consist of eucalyptol, eugenol, geraniol, guaiacol, isoeugenol, cinnamaldehyde, citral, piperonal, p-methoxybenzaldehyde, vanillin, vanillin erythro and threo-butan-2,3-diol acetal, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, acetoin, maltol, methylcyclopentenolone, piperine, beta-caryophyllene, beta-pinene, d-limonene, linalool, and myrcene.

Embodiment 162 is a method for making an alcoholic beverage, wherein the method comprises (or consists essentially of or consists of) combining water; a grain neutral spirit; a rum, wherein the alcoholic beverage comprises no more than about 10 wt % of the rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein the added VOCs comprise at least one additional alcohol, at least one aldehyde, at least one ester, at least one ketone, optionally at least one acid, and optionally at least one terpene, and wherein the added VOCs comprise about 0.0001 wt % to about 1 wt % of the alcoholic beverage.

Embodiment 163 is the method of embodiment 162, comprising adding the at least one acid to the alcoholic beverage, wherein the at least one acid comprises one or more of 2-methylbutyric acid, acetic acid, butyric acid, decanoic acid, and isovaleric acid.

Embodiment 164 is the method of embodiment 162 or embodiment 163, wherein the at least one additional alcohol comprises one or more of (+/−) 2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, and phenethyl alcohol.

Embodiment 165 is the method of any one of embodiments 162 to 164, wherein the at least one aldehyde comprises one or more of 2-methylbutyraldehyde, 3-methylbutyraldehyde, acetal, cinnamaldehyde, citral, furfural, hexanal, piperonal, p-methoxybenzaldehyde, valeraldehyde, vanillin, and vanillin erythro and threo-butan-2,3-diol acetal.

Embodiment 166 is the method of any one of embodiments 162 to 165, wherein the at least one ester comprises one or more of allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, and tetrahydrofurfuryl acetate.

Embodiment 167 is the method of any one of embodiments 162 to 166, wherein the at least one ketone comprises one or more of 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, and piperine.

Embodiment 168 is the method of any one of embodiments 162 to 167, comprising adding the at least one terpene, wherein the at least one terpene comprises one or more of beta-caryophyllene, beta-pinene, d-limonene, linalool, and myrcene.

Embodiment 169 is the method of any one of embodiments 162 to 168, wherein the added VOCs further comprise one or more of diacetyl, dimethyl disulfide, methyl sulfide, whiskey lactone, and rum ether.

Embodiment 170 is the method of any one of embodiments 162 to 169, comprising adding the oak extract to the alcoholic beverage.

Embodiment 171 is the method of any one of embodiments 162 to 170, comprising adding the salt to the alcoholic beverage, wherein the salt is sodium chloride.

Embodiment 172 is the method of any one of embodiments 162 to 171, comprising adding the sugar or other sweetener to the alcoholic beverage, wherein the sugar or other sweetener is selected from the group consisting of sucrose, fructose, glucose, sugar alcohols, and sugar substitutes.

Embodiment 173 is the method of any one of embodiments 162 to 172, comprising adding the tannin to the alcoholic beverage.

Embodiment 174 is the method of any one of embodiments 162 to 173, wherein the added VOCs comprise ten or more compounds selected from the group consisting of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, piperine, diacetyl, dimethyl disulfide, methyl sulfide, rum ether, beta-caryophyllene, beta-pinene, d-limonene, linalool, and myrcene.

Embodiment 175 is the method of any one of embodiments 162 to 174, wherein the added VOCs comprise 20 or more compounds selected from the group consisting of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, eucalyptol, eugenol, geraniol, guaiacol, hexanol, isoamyl alcohol, isobutyl alcohol, isoeugenol, p-ethylphenol, phenethyl alcohol, 2-methylbutyraldehyde, 3-methylbutyraldehyde, acetal, cinnamaldehyde, citral, furfural, hexanal, piperonal, p-methoxybenzaldehyde, valeraldehyde, vanillin, vanillin erythro and threo-butan-2,3-diol acetal, allyl hexanoate, benzyl butyrate, diethyl succinate, ethyl 2-methylbutyrate, ethyl acetate, ethyl acrylate, ethyl heptanoate, ethyl hexanoate, ethyl isovalerate, ethyl octanoate, ethyl valerate, isoamyl acetate, p-anisyl acetate, phenethyl isovalerate, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, 4,5-dimethyl-3-hydroxy-2,5-dihydrofuran-2-one, 5-butyl-4-methyldihydro-2(3h)-furanone, 6-methyl-5-hepten-2-one, acetoin, beta damascenone, gamma-decalactone, maltol, methylcyclopentenolone, piperine, diacetyl, dimethyl disulfide, methyl sulfide, rum ether, beta-caryophyllene, beta-pinene, d-limonene, linalool, and myrcene.

Embodiment 176 is the method of embodiment 162, comprising (or consisting essentially of or consisting of) combining from about 5 wt % to about 70 wt % water; from about 25 wt % to about 95 wt % grain neutral spirits; from about 1 wt % to about 10 wt % rum; from about 0.1 wt % to about 10 wt % glycerin; from about 10 wt % to about 30 wt % oak extract; optionally, up to about 0.1 wt % salt; optionally, up to about 5 wt % sugar or sweetener; optionally, up to about 0.1 wt % tannins, and from about 0.001 wt % to about 1 wt % added VOCs, wherein the added VOCs comprise ten or more compounds selected from the group consisting of hexanol, vanillin erythro and threo-butan-2,3-diol acetal, diethyl succinate, tetrahydrofurfuryl acetate, isoamyl acetate, p-anisyl acetate, ethyl acetate, 3,4-dimethyl-1,2-cyclopentadione, 6-methyl-5-hepten-2-one, 2,3-hexanedione, 2,3-pentanedione, 2-acetoxy-3-butanone, methylcyclopentenolone, 3-ethyl-2-hydroxy-2-cyclopenten-1-one, and rum ether.

Embodiment 177 is the method of embodiment 176, wherein the added VOCs consist of hexanol, vanillin erythro and threo-butan-2,3-diol acetal, diethyl succinate, tetrahydrofurfuryl acetate, isoamyl acetate, p-anisyl acetate, ethyl acetate, 3,4-dimethyl-1,2-cyclopentadione, 6-methyl-5-hepten-2-one, 2,3-hexanedione, 2,3-pentanedione, 2-acetoxy-3-butanone, methylcyclopentenolone, 3-ethyl-2-hydroxy-2-cyclopenten-1-one, and rum ether.

Embodiment 178 is the method of embodiment 162, comprising (or consisting of or consisting essentially of) combining from about 5 wt % to about 70 wt % water; from about 25 wt % to about 95 wt % grain neutral spirits; from about 1 wt % to about 10 wt % rum; from about 0.1 wt % to about 10 wt % glycerin; optionally, up to about 0.1 wt % salt; optionally, up to about 5 wt % sugar or sweetener; optionally, up to about 0.1 wt % tannins; and from about 0.001 wt % to about 1 wt % added VOCs, wherein the added VOCs comprise 20 or more compounds selected from the group consisting of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, guaiacol, isoamyl alcohol, isobutyl alcohol, p-ethylphenol, phenethyl alcohol, 2-methylbutyraldehyde, 3-methylbutyraldehyde, acetal, furfural, hexanal, piperonal, valeraldehyde, vanillin, allyl hexanoate, benzyl butyrate, ethyl 2-methylbutyrate, ethyl acrylate, ethyl heptanoate, ethyl hexanoate, ethyl isovalerate, ethyl octanoate, ethyl valerate, isoamyl acetate, phenethyl isovalerate, 4,5-dimethyl-3-hydroxy-2,5-dihydrofuran-2-one, 5-butyl-4-methyldihydro-2(3h)-furanone, beta damascenone, gamma-decalactone, diacetyl, dimethyl disulfide, methyl sulfide, and rum ether.

Embodiment 179 is the method of embodiment 178, wherein the added VOCs consist of 2-methylbutyric acid, whiskey lactone, acetic acid, butyric acid, decanoic acid, isovaleric acid, (+/−) 2-methyl-1-butanol, 1-octen-3-ol, 2-methoxy-4-propylphenol, 4-allyl-2,6-dimethoxyphenol, 4-ethylguaiacol, guaiacol, isoamyl alcohol, isobutyl alcohol, p-ethylphenol, phenethyl alcohol, 2-methylbutyraldehyde, 3-methylbutyraldehyde, acetal, furfural, hexanal, piperonal, valeraldehyde, vanillin, allyl hexanoate, benzyl butyrate, ethyl 2-methylbutyrate, ethyl acrylate, ethyl heptanoate, ethyl hexanoate, ethyl isovalerate, ethyl octanoate, ethyl valerate, isoamyl acetate, phenethyl isovalerate, 4,5-dimethyl-3-hydroxy-2,5-dihydrofuran-2-one, 5-butyl-4-methyldihydro-2(3h)-furanone, beta damascenone, gamma-decalactone, diacetyl, dimethyl disulfide, methyl sulfide, and rum ether.

Embodiment 180 is the method of embodiment 162, comprising (or consisting essentially of or consisting of) combining from about 5 wt % to about 70 wt % water; from about 25 wt % to about 95 wt % grain neutral spirits; from about 1 wt % to about 10 wt % rum; from about 0.1 wt % to about 10 wt % glycerin; optionally, up to about 30 wt % oak extract; optionally, up to about 0.1 wt % salt; optionally, up to about 5 wt % sugar or sweetener; optionally, up to about 0.1 wt % tannins; from about 0.0005 to about 0.002 wt % orange oil; and from about 0.001 wt % to about 1 wt % added VOCs, wherein the added VOCs comprise ten or more compounds selected from the group consisting of eucalyptol, eugenol, geraniol, guaiacol, isoeugenol, cinnamaldehyde, citral, piperonal, p-methoxybenzaldehyde, vanillin, vanillin erythro and threo-butan-2,3-diol acetal, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, acetoin, maltol, methylcyclopentenolone, piperine, beta-caryophyllene, beta-pinene, d-limonene, linalool, and myrcene.

Embodiment 181 is the method of embodiment 180, wherein the added VOCs consist of eucalyptol, eugenol, geraniol, guaiacol, isoeugenol, cinnamaldehyde, citral, piperonal, p-methoxybenzaldehyde, vanillin, vanillin erythro and threo-butan-2,3-diol acetal, tetrahydrofurfuryl acetate, 2,3-hexanedione, 2,3-pentanedione, 2-acetoxy-3-butanone, 3,4-dimethyl-1,2-cyclopentadione, 3-ethyl-2-hydroxy-2-cyclopenten-1-one, acetoin, maltol, methylcyclopentenolone, piperine, beta-caryophyllene, beta-pinene, d-limonene, linalool, and myrcene.

Embodiment 182 is an alcoholic beverage produced by the method of any one of embodiments 162 to 181.

Embodiment 183 is a rum-like alcoholic beverage concentrate comprising (or consisting essentially of or consisting of) a rum, wherein the alcoholic beverage, after dilution to produce a final product, comprises no more than about 10 wt % of the rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein the added VOCs comprise at least one additional alcohol, at least one aldehyde, at least one ester, at least one ketone, optionally at least one acid, and optionally at least one terpene, and wherein at least one of the added VOCs is present in a concentration of at least about 2-fold the concentration of the same VOC in a corresponding traditional rum or a corresponding non-concentrate rum-like alcoholic beverage.

Embodiment 184 is the rum-like alcoholic beverage concentrate of embodiment 183, wherein at least one of the added VOCs is present in the concentrate in a concentration of at least about 5-fold the concentration of the same VOCs in a corresponding traditional rum or a corresponding non-concentrate rum-like alcoholic beverage.

Embodiment 185 is the rum-like alcoholic beverage concentrate of embodiment 183, wherein at least one of the added VOCs is present in the concentrate in a concentration of at least about 10-fold the concentration of the same VOCs in a corresponding traditional rum or a corresponding non-concentrate rum-like alcoholic beverage.

Embodiment 186 is the rum-like alcoholic beverage concentrate of embodiment 183, wherein at least one of the added VOCs is present in the concentrate in a concentration of at least about 15-fold the concentration of the same VOCs in a corresponding traditional rum or a corresponding non-concentrate rum-like alcoholic beverage.

Embodiment 187 is the rum-like alcoholic beverage concentrate of any one of embodiments 183 to 186, wherein upon dilution of the rum-like beverage concentrate to a rum-like alcoholic beverage, the rum-like alcoholic beverage is the alcoholic beverage of any one of embodiments 1 to 20.

Embodiment 188 is a method of making a rum-like alcoholic beverage concentrate, the method comprising (or consisting essentially of or consisting of) combining a rum, wherein the alcoholic beverage, after dilution to produce a final product, comprises no more than about 10 wt % of the rum; glycerin; optionally, an oak extract; optionally, a salt; optionally, a sugar or other sweetener; optionally, a tannin; optionally, one or more plant oils, fruit oils, plant flavors, or fruit flavors; and at least ten added VOCs, wherein the added VOCs comprise at least one additional alcohol, at least one aldehyde, at least one ester, at least one ketone, optionally at least one acid, and optionally at least one terpene, and wherein at least one of the added VOCs is present in a concentration of at least about 2-fold the concentration of the same VOC in a corresponding traditional rum or a corresponding non-concentrate rum-like alcoholic beverage.

Embodiment 189 is the method of embodiment 188, wherein at least one of the added VOCs is present in the concentrate in a concentration of at least about 5-fold the concentration of the same VOCs in a corresponding traditional rum or a corresponding non-concentrate rum-like alcoholic beverage.

Embodiment 190 is the method of embodiment 188, wherein at least one of the added VOCs is present in the concentrate in a concentration of at least about 10-fold the concentration of the same VOCs in a corresponding traditional rum or a corresponding non-concentrate rum-like alcoholic beverage.

Embodiment 191 is the method of embodiment 188, wherein at least one of the added VOCs is present in the concentrate in a concentration of at least about 15-fold the concentration of the same VOCs in a corresponding traditional rum or a corresponding non-concentrate rum-like alcoholic beverage.

Embodiment 192 is the method of any one of embodiments 188 to 191, wherein upon dilution of the rum-like beverage concentrate to a rum-like alcoholic beverage, the rum-like alcoholic beverage is the alcoholic beverage of any one of embodiments 1 to 20.

The invention will be further described in the following examples, which do not limit the scope of the invention described in the claims.

### EXAMPLES

### Example 1—Exemplary Flavored Rum-Like Alcoholic Beverages

Rum replicas were prepared using the components listed in TABLE 1A. In some cases, the ingredients included the exemplary VOCs listed in TABLES 1B-1H. The ingredients were added to a mixing tank in no particular order, and were mixed for 15-20 minutes and then held until being placed into the desired containers (e.g., bottles or cans).

The rum replicas had a final ABV of 40%, and were comparable to rums crafted by traditional methods in terms of its flavor, aroma, mouthfeel, and overall sensory experience.

It also is to be noted that while rum replicas can include added VOCs and, in some cases, non-volatile compounds, the added compounds may react with one another to generate additional compounds, or to change the effective amount of one or more of the added compounds within the rum replica formulation.

TABLE 1A
Exemplary rum replica formulations

| Ingredient | Exemplary wt % |
|---|---|
| Water | 5-70 |
| Alcohol (grain neutral spirits and traditional rum) | 25-95 |
| Glycerin | 0.1-10 |
| Oak Extract | 0-30 |
| Salt | 0-0.1 |
| Sugar/sweeteners | 0-5 |
| Tannins | 0-0.1 |
| Plant oil, fruit oils, plant flavors, or fruit flavors | 0-0.01 |
| Total VOCs: | 0.0001-1 |
| Acid(s) | 0-0.1 |
| Alcohol(s) | 0-0.1 |
| Aldehyde(s) | 0-0.1 |
| Ester(s) | 0-0.1 |
| Ketone(s) | 0-0.1 |
| Terpene(s) | 0-0.1 |
| Other VOCs | 0-0.1 |

TABLE 1B
Exemplary VOCs in aged rum replicas

| VOC | Exemplary wt % (in replica) |
|---|---|
| hexanol | 0.000002%-0.000008% |
| vanillin erythro and threo-butan-2,3-diol | 0.000804%-0.002145% |
| acetal | |
| diethyl succinate | 0.000005%-0.000022% |
| tetrahydrofurfuryl acetate | 0.00005%-0.000134% |
| isoamyl acetate | 0.00008%-0.00012% |
| p-anisyl acetate | 0.00015%-0.0003% |
| ethyl acetate | 0.0002%-0.0008% |
| 3,4-dimethyl-1,2-cyclopentadione | 0.000001%-0.000003% |
| 6-methyl-5-hepten-2-one | 0.0000025%-0.00001% |
| 2,3-hexanedione | 0.00001%-0.000027% |
| 2,3-pentanedione | 0.000042%-0.000112% |
| 2-acetoxy-3-butanone | 0.000101%-0.000268% |
| methylcyclopentenolone | 0.000328%-0.000875% |
| 3-ethyl-2-hydroxy-2-cyclopenten-1-one | 0.000603%-0.001609% |
| rum ether | 0.04%-0.16% |

TABLE 1C
Exemplary VOCs in white rum replicas

| VOC | Exemplary wt % (in replica) |
|---|---|
| 2-methylbutyric acid | 0.00004%-0.00018% |
| 4-hydroxy-3-methyloctanoic acid | 0.000013%-0.0002% |
| lactone | |
| acetic acid | 0.012%-0.052% |
| butyric acid | 0.00003%-0.00012% |
| decanoic acid | 0.00025%-0.0011% |
| isovaleric acid | 0.000045%-0.00018% |
| (+/−) 2-methyl-1-butanol | 0.00005%-0.0245% |
| 1-octen-3-ol | 0.000012%-0.00005% |
| 2-methoxy-4-propylphenol | 0.000001%-0.000004% |
| 4-ally1-2,6-dimethoxyphenol | 0.000005%-0.00002% |
| 4-ethylguaiacol | 0.000013%-0.000054% |
| guaiacol | 0.0000025%-0.00001% |
| isoamyl alcohol | 0.04%-0.017% |
| isobutyl alcohol | 0.02%-0.09% |
| p-ethylphenol | 0.000006%-0.000024% |
| phenethyl alcohol | 0.00085%-0.0034% |
| 2-methylbutyraldehyde | 0.0000015%-0.000006% |
| 3-methylbutyraldehyde | 0.00001%-0.000046% |
| acetal | 0.0012%-0.005% |
| furfural | 0.000015%-0.0001% |
| hexanal | 0.000006%-0.000026% |
| piperonal | 0.00005%-0.0008% |
| valeraldehyde | 0.000025%-0.0001% |
| vanillin | 0.00005%-0.000235% |
| allyl hexanoate | 0.0001%-0.0002% |
| benzyl butyrate | 0.000075%-0.00015% |
| ethyl 2-methylbutyrate | 0.00001%-0.000046% |
| ethyl acrylate | 0.000025%-0.0001% |
| ethyl heptanoate | 0.00015%-0.0002% |
| ethyl hexanoate | 0.000084%-0.00025% |
| ethyl isovalerate | 0.00001%-0.00004% |
| ethyl octanoate | 0.000025%-0.00005% |
| ethyl valerate | 0.0000025%-0.0001% |
| isoamyl acetate | 0.000106%-0.002% |
| phenethyl isovalerate | 0.000025%-0.0001% |
| 4,5-dimethyl-3-hydroxy-2,5- | 0.000001%-0.000004% |
| dihydrofuran-2-one | |
| 5-butyl-4-methyldihydro-2(3h)- | 0.000006%-0.000024% |
| furanone | |
| beta damascenone | 0.000004%-0.0001% |
| gamma-decalactone | 0.000025%-0.0002% |
| diacetyl | 0.000002%-0.000008% |
| dimethyl disulfide | 0.00005%-0.0001% |
| methyl sulfide | 0.00005%-0.00018% |
| rum ether | 0.04%-0.16% |

TABLE 1D
Exemplary VOCs in spiced rum replicas

| VOC | Exemplary wt % (in replica) |
|---|---|
| eucalyptol | 0.000005%-0.00002% |
| eugenol | 0.000015%-0.00005% |
| geraniol | 0.0001%-0.0004% |
| guaiacol | 0.00001%-0.00004% |
| isoeugenol | 0.000003%-0.00012% |
| cinnamaldehyde | 0.000003%-0.0004% |
| citral | 0.00002%-0.000075% |
| piperonal | 0.000058%-0.0005% |
| p-methoxybenzaldehyde | 0.00001%-0.0001% |
| vanillin | 0.0006%-0.0008% |
| vanillin erythro and threo-butan-2,3- | 0.00195%-0.003% |
| diol acetal | |
| tetrahydrofurfuryl acetate | 0.000122%-0.000188% |
| 2,3-hexanedione | 0.000024%-0.000038% |
| 2,3-pentanedione | 0.000183%-0.000281% |
| 2-acetoxy-3-butanone | 0.000244%-0.000375% |
| 3,4-dimethyl-1,2-cyclopentadione | 0.000063%-0.000098% |
| 3-ethyl-2-hydroxy-2-cyclopenten-1-one | 0.001463%-0.00225% |
| acetoin | 0.000195%-0.0003% |
| maltol | 0.0001%-0.00025% |
| methylcyclopentenolone | 0.001463%-0.00225% |
| piperine | 0.00003%-0.0001% |
| beta-caryophyllene | 0.00001%-0.00002% |
| beta-pinene | 0.000005%-0.00002% |
| d-limonene | 0.00005%-0.00015% |
| linalool | 0.000005%-0.00004% |
| myrcene | 0.000005%-0.00001% |

TABLE 1E
Exemplary VOCs in aged rum replicas

| VOC | Exemplary wt % (in replica) |
|---|---|
| 1-propanol | 0.0355-0.142 |
| 2,3-hexanedione | 0.00000137-0.00000549 |
| 2-acetylfuran | 0.000000932-0.00000373 |
| 2-methyl-1-butanol | 0.00000165-0.00000662 |
| 5-methyl-furfural | 0.0000126-0.0000504 |
| acetic acid | 0.000148-0.000593 |
| benzaldehyde | 0.00000886-0.0000354 |
| benzeneacetaldehyde | 0.0000000343-0.00000014 |
| diethyl butanedioate | 0.0000126-0.0000505 |
| ethyl acetate | 0.000129-0.000517 |
| ethyl propionate | 0.0000146-0.0000588 |
| furfural | 0.0000752-0.000301 |
| isoamyl acetate | 0.000027-0.000108 |
| maltol | 0.0000114-0.0000457 |
| nonanal | 0.0000155-0.0000621 |
| p-anisyl acetate | 0.000144-0.000574 |
| p-cymene | 0.000000269-0.00000107 |
| rum ether | 0.0336-0.135 |
| tetrahydrofurfuryl acetate | 0.000038-0.000152 |
| valeraldehyde | 0.000000096-0.00000038 |
| whiskey lactone | 0.00000814-0.0000326 |

TABLE 1F
Exemplary VOCs in white rum replicas

| VOC | Exemplary wt % (in replica) |
|---|---|
| 1-propanol | 0.0389-0.156 |
| 2-acetylfuran | 0.000000571-0.00000228 |
| 2-methyl-1-butanol | 0.0000248-0.0000992 |
| 5-methyl-furfural | 0.0000107-0.0000427 |
| acetic acid | 0.0000713-0.000285 |
| benzaldehyde | 0.00000886-0.0000354 |
| ethyl acetate | 0.000153-0.000613 |
| ethyl octanoate | 0.0000139-0.0000558 |
| ethyl hexanoate | 0.00000226-0.00000906 |
| ethyl propionate | 0.0000223-0.0000892 |
| furfural | 0.0000176-0.0000706 |
| isobutyl acetate | 0.0000596-0.000238 |
| p-cymene | 0.000000174-0.00000070 |
| rum ether | 0.0551-0.221 |
| valeraldehyde | 0.0000000732-0.00000029 |
| whiskey lactone | 0.0000292-0.000117 |

TABLE 1G
Exemplary VOCs in spiced rum replicas

| VOC | Exemplary wt % (in replica) |
|---|---|
| 1-propanol | 0.036-0.144 |
| 2,3-hexanedione | 0.00000263-0.0000105 |
| 2,3-pentanedione | 0.0000161-0.0000644 |
| 2-acetylfuran | 0.000000204-0.00000082 |
| 2-methyl-1-butanol | 0.000000713-0.00000285 |
| 5-methyl-furfural | 0.0000112-0.0000449 |
| acetic acid | 0.000179-0.000715 |
| benzaldehyde | 0.00000884-0.0000354 |
| beta-caryophyllene | 0.00000213-0.00000853 |
| beta-pinene | 0.00000141-0.00000564 |
| citral | 0.0000152-0.0000607 |
| D-limonene | 0.0000149-0.0000594 |
| ethyl acetate | 0.0000146-0.0000583 |
| ethyl propionate | 0.00000378-0.0000151 |
| furfural | 0.0000479-0.000191 |
| isobutyl acetate | 0.00000896-0.0000359 |
| isobutanol | 0.0000424-0.000170 |
| linalool | 0.000003-0.0000120 |
| maltol | 0.00000588-0.0000235 |
| myrcene | 0.00000103-0.00000411 |
| hexanal | 0.000000211-0.00000084 |
| p-anisyl acetate | 0.000000273-0.00000109 |
| p-cymene | 0.00000034-0.00000136 |
| rum ether | 0.0481-0.192 |
| tetrahydrofurfuryl acetate | 0.0000787-0.000315 |
| whiskey lactone | 0.0000122-0.0000486 |

TABLE 1H
Exemplary VOCs in artisanal rum replicas

| VOC | Exemplary wt % (in replica) |
|---|---|
| 1-octen-3-ol | 0.000026-0.000104 |
| 1-propanol | 0.0278-0.111 |
| 2-acetylfuran | 0.00000155-0.00000619 |
| 2-methyl-1-butanol | 0.0153-0.0613 |
| 5-methyl-furfural | 0.000011-0.0000438 |
| acetic acid | 0.0126-0.0504 |
| allyl hexanoate | 0.0000895-0.000358 |
| benzaldehyde | 0.00000892-0.0000357 |
| benzyl butyrate | 0.0000602-0.000241 |
| butyl acetate | 0.0000054-0.0000216 |
| dimethyl disulfide | 0.0000863-0.000345 |
| D-limonene | 0.00000189-0.00000755 |
| ethyl acetate | 0.00174-0.00698 |
| ethyl octanoate | 0.0000437-0.000175 |
| ethyl butyrate | 0.00000197-0.00000789 |
| ethyl heptanoate | 0.0000923-0.000369 |
| ethyl hexanoate | 0.000123-0.000493 |
| ethyl pentanoate | 0.0000144-0.0000575 |
| ethyl propionate | 0.000052-0.000208 |
| furfural | 0.000136-0.000545 |
| heptanyl acetate | 0.000017-0.0000679 |
| isoamyl acetate | 0.00511-0.0204 |
| isoamyl alcohol | 0.0232-0.0926 |
| isobutyl acetate | 0.0000176-0.0000704 |
| isobutanol | 0.0169-0.0674 |
| n-propyl acetate | 0.000000484-0.00000194 |
| p-cymene | 0.000000348-0.00000139 |
| rum ether | 0.074-0.296 |
| valeraldehyde | 0.0000171-0.0000682 |
| whiskey lactone | 0.000000606-0.00000242 |

### Example 2—Scaled Up Production and Generation of Concentrated Rum Replicas

It is to be noted that the above process, and similar processes using variations of the ingredient list, are scaled up for commercial production of a rum-like alcoholic beverage. Such scaled up processes (e.g., to generate 1000 L or more) can utilize tanks or vat, for example.

Rum replica concentrates are made in ˜100 L test batches and held for a minimum of 8 weeks, with periodic sampling at 1, 2, 4, 6, and 8 weeks. Density measurements are taken each week, and three replicate bottles of rum replicas are produced by adding 43% ABV neutral grain spirits prior to filtering through a 0.45 PVDF vacuum filter. Samples are then submitted for analytical testing versus a corresponding non-concentrated rum replica, and versus each other, to assess volatile and non-volatile components. Organoleptic comparisons also are conducted. The concentrates are held in HDPE vessels, or in stainless steel at the highest concentration, to ensure that there are no changes in composition due to the storage material.

To find the appropriate volume of concentrate (5×, 10×, or 20×) to add to create a finished product, the following formulas are used:

$$( {C}_{concentrate} ) ( {V}_{concentrate} ) = ( {C}_{final product} ) ( {V}_{final product} )$$

$${V}_{concentrate} = \frac{( 1 ) ( {V}_{final product} )}{( {C}_{concentrate} )}$$

### Where:

C_{final product}=concentration of final product=1 (i.e., 1×)
V_{final product}=desired volume of finished product
C_{concentrate}=concentration of the concentrate (5×, 10×, or 20×)
V_{concentrate}=volume of concentrate to add to create finished product

### Example 3—VOCs and Non-VOCs in Reference Rum Samples

GC-MS/MS and GC-LECO-TOF-MS were used to assess the amounts of various VOCs in traditional rums.

GC-MS/MS Conditions: All analyses were performed using an Agilent 7890B GC interfaced with a 7000D Triple Quadrupole mass spectrometer, and equipped with a PAL RSI 85 autosampler with syringe attachment. The injection volume was 1.0 μL. Liquid injections had a split ratio of 1:20, with a desorption temperature of 250° C. The column was a 30 m×0.25 mm×0.25 Agilent DB-WAX (ultra inert). Helium was used as the carrier gas at a constant flow rate of 1.3 mL/min. The MS ion source temperature and interface temperature were 250° C. The temperature program was as follows: initial temperature 40° C., held for 2 minutes, then increased to 210° C. at a rate of 10° C./min, and held for 5 minutes, for a total run time of 24 minutes.

GC-LECO-TOF-MS Conditions: All analyses were performed using an Agilent 7890B GC interfaced with a 7820 LECO-TOF mass spectrometer and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, PA). HS-SPME autosampler conditions were as follows: pre-incubation time of 5 minutes, incubation temperature of 60° C., extraction time of 15 minutes, and desorption time 5 minutes. Post-desorption fiber conditioning time was 30 minutes. SPME injections had a split ratio of 1:20, with a desorption temperature of 250° C. The columns were a 29.69 m×0.25 mm×0.25 Agilent Rxi-5MS column attached to a 1.09 m×0.25 mm×0.25 Agilent Rxi-17 Sil MS column. Helium was used as the carrier gas at a constant flow rate of 1 mL/min. The MS ion source temperature and interface temperature were 250° C. The temperature program was as follows: initial temperature 40° C., held for 2 minutes, then increased to 90° C. at a rate of 10° C./min and held for 2 min, then increased to 132° C. at a rate of 10° C./min and held for 2 min, then increased to 145° C. at a rate of 10° C./min and held for 2 min, and finally increased to 240° C. at a rate of 10° C./min held for 5 minutes, for a total run time of 33 minutes.

Selection of target compounds and MRM method development: An outline of the general workflow for GC-MS analyses is as follows. Real samples were first analyzed in full scan mode (m/z 15-550) on the GC/MS-LECO to identify potential target compounds. Collected data were analyzed manually using LECO ChromaTOF Software. Multiple Reaction Monitoring (MRM) optimization was performed for commercially available standards. First, full scan experiments were repeated with liquid injection (10 mg/L in either pure MeOH or DCM) to verify retention time and potential precursor ions. Product ion scans were performed using liquid injection and collision energy of 30 V. Optimized MRM transitions and collision energies were selected and are displayed in TABLE 2. A dynamic MRM (dMRM) method was developed for the generation of calibration curves, as described below. Compounds were divided into nine methods (TABLE 2) to minimize simultaneous transitions (no greater than 6).

Preparation of calibration curves for GC-MS/MS: All calibration solutions were prepared as 1 mL in either pure MeOH or DCM in 2-mL amber vials. The concentration range was originally 1-1000 μg/L and then varied based on LOD and expected concentration per compound.

Quantification in real samples for GC-MS/MS: All samples (15 mL initial volume) were extracted with 3×5 mL DCM and the combined extract was dried with anhydrous magnesium sulfate. Then 1 mL of dried extract was transferred to a 2 mL amber auto vial and were analyzed using Agilent Quantitative Analysis (for QQQ). Values reported as not detected (ND) may are considered to be below the limits of detection (LODs) listed in TABLE 2. LODs were approximated based on S/N ratios as generated by the MassHunter software.

Various reference rum samples were assayed by GC-MS; the levels of VOCs therein are shown in TABLES 3A and 3B. In these tables, each column is designated by a numeral that refers to a particular rum.

TABLE 2A
GC/MS/MS Method Transitions and Figures of Merit

| Compound Method | | | | Calibration | |
|---|---|---|---|---|---|
| | RT | | Collision | Range | LOD |
| Name | (min) | Transition | Energy | (mg/L) | (mg/L) |
| n-propyl acetate | 3.644 | 61.0 → 43.0 | 30 | 0.001-1.0 | 0.001 |
| isobutyl acetate | 4.164 | 56.0 → 43.0 | 30 | 0.05-1.0 | 0.05 |
| butyl acetate | 5.046 | 73.0 → 43.0 | 30 | 0.02-1.0 | 0.02 |
| isoamyl acetate | 5.816 | 70.0 → 39.0 | 30 | 0.01-1.0 | 0.01 |
| heptanyl acetate | 9.54 | 70.0 → 39.0 | 30 | 0.02-1.0 | 0.02 |
| octyl acetate | 10.91 | 70.0 → 40.0 | 30 | 0.1-1.0 | 0.1 |
| phenethyl acetate | 15.013 | 104.0 → 103.0 | 30 | 0.005-1.0 | 0.005 |
| tetrahydrofurfuryl acetate | 12.228 | 70.0 → 41.0 | 30 | 0.1-1.0 | 0.1 |
| p-anisyl acetate | 18.414 | 121.0 → 78.0 | 30 | 0.005-1.0 | 0.005 |
| octanoic acid | 17.574 | 60.0 → 45.0 | 30 | 1.0-100.0 | 1.0 |
| decanoic acid | 19.634 | 73.0 → 46.0 | 30 | 20.0-100.0 | 20.0 |
| dodecanoic acid | 22.374 | 73.0 → 55.0 | 30 | 1.0-100.0 | 1.0 |
| 1-propanol | 3.351 | 45.0 → 29.0 | 30 | 0.2-1.0 | 0.2 |
| isobutanol | 5.295 | 43.0 → 39.0 | 30 | 0.05-1.0 | 0.05 |
| 2-methyl-1-butanol | 7.048 | 70.0 → 39.0 | 30 | 0.02-1.0 | 0.02 |
| isoamyl alcohol | 7.04 | 70.2 → 39.1 | 30 | 0.01-1.0 | 0.01 |
| 1-octen-3-ol | 10.522 | 57.0 → 31.0 | 30 | 0.005-1.0 | 0.005 |
| phenylethyl alcohol | 15.975 | 91.0 → 65.0 | 30 | 0.01-1.0 | 0.01 |
| 1-decanol | 14.312 | 70.0 → 39.0 | 30 | 0.1-1.0 | 0.1 |
| maltol | 16.54 | 138.0 → 67.0 | 30 | 0.05-1.0 | 0.05 |
| hexanal | 5.15 | 72.2 → 31.1 | 30 | 0.02-1.0 | 0.02 |
| nonanal | 9.792 | 98.0 → 41.1 | 30 | 0.02-1.0 | 0.02 |
| decanal | 11.195 | 112.0 → 55.1 | 30 | 0.05-1.0 | 0.05 |
| citral | 14.02 | 134.0 → 91.1 | 30 | 0.05-1.0 | 0.05 |
| valeraldehyde | 3.664 | 58.2 → 31.2 | 30 | 0.02-1.0 | 0.02 |
| benzaldehyde | 11.543 | 106.0 → 77.0 | 30 | 0.001-1.0 | 0.001 |
| 5-methyl-furfural | 12.165 | 110.0 → 53.1 | 30 | 0.005-1.0 | 0.005 |
| p-cymene | 7.996 | 119.0 → 91.0 | 30 | 0.001-1.0 | 0.001 |
| D-limonene | 6.879 | 93.0 → 91.0 | 30 | 0.01-1.0 | 0.01 |
| (±)-menthol | 12.92 | 95.0 → 67.0 | 30 | 0.05-1.0 | 0.05 |
| beta-pinene | 5.431 | 93.0 → 51.0 | 30 | 0.001-1.0 | 0.001 |
| ethyl acetate | 2.81 | 61.2 → 43.2 | 30 | 0.01-1.0 | 0.01 |
| ethyl propionate | 3.434 | 57.0 → 27.0 | 30 | 0.005-1.0 | 0.005 |
| ethyl butyrate | 4.501 | 71.0 → 41.0 | 30 | 0.01-1.0 | 0.01 |
| ethyl hexanoate | 7.514 | 88.0 → 42.0 | 30 | 0.02-1.0 | 0.02 |
| ethyl heptanoate | 13.589 | 88.0 → 43.0 | 30 | 0.01-1.0 | 0.01 |
| ethyl benzoate | 8.971 | 105.0 → 51.0 | 30 | 0.01-1.0 | 0.01 |
| ethyl octanoate | 10.37 | 88.0 → 43.0 | 30 | 0.01-1.0 | 0.01 |
| ethyl dodecanoate | 15.276 | 88.0 → 61.0 | 30 | 0.1-1.0 | 0.1 |
| isopentyl hexanoate | 10.688 | 70.0 → 39.0 | 30 | 0.01-1.0 | 0.01 |
| allyl hexanoate | 9.517 | 99.0 → 41.0 | 30 | 0.01-1.0 | 0.01 |
| benzyl butyrate | 15.593 | 108.0 → 79.0 | 30 | 0.005-1.0 | 0.005 |
| ethyl pentanoate | 6.005 | 85.0 → 41.2 | 30 | 0.01-1.0 | 0.01 |
| furfural | 10.782 | 96.0 → 95.0 | 30 | 0.005-1.0 | 0.005 |
| 2-acetylfuran | 11.313 | 95.0 → 39.0 | 30 | 0.005-1.0 | 0.005 |
| 2-pentylfuran | 7.459 | 81.0 → 53.0 | 30 | 0.01-1.0 | 0.01 |
| whiskey lactone | 15.767 | 99.0 → 41.0 | 30 | 0.05-1.0 | 0.05 |
| 2,3-hexanedione | 5.97 | 71.0 → 41.0 | 30 | 0.05-1.0 | 0.05 |
| dimethyl disulfide | 4.95 | 94.0 → 64.0 | 30 | 0.005-1.0 | 0.005 |
| diethyl butanedioate | 13.437 | 101.0 → 45.0 | 30 | 0.005-1.0 | 0.005 |
| 2,3-pentanedione | 4.90 | 100.0 → 29.0 | 30 | 0.05-1.0 | 0.05 |
| rum ether | NA | NA | 30 | NA | NA |
| beta-bisabolene | 13.966 | 93.0 → 77.0 | 30 | 0.05-1.0 | 0.05 |
| myrcene | 6.381 | 93.0 → 65.0 | 30 | 0.01-1.0 | 0.01 |
| linalool | 11.781 | 93.0 → 51.0 | 30 | 0.005-1.0 | 0.005 |
| beta-caryophyllene | 12.451 | 133.0 → 91.0 | 30 | 0.02-1.0 | 0.02 |

TABLE 3A
VOCs in reference rums

| | Round 1 assays (values in mg/L) | | | | | | | |
|---|---|---|---|---|---|---|---|---|
| | 1 | 2 | 3 | 4 | 5 | 6 | 7 | 8 |
| (±)-menthol | ND | ND | ND | ND | 0.234 | 0.252 | ND | ND |
| 1-octen-3-ol | 0.072 | 0.113 | 0.098 | 0.126 | 0.070 | 0.030 | 0.022 | 0.062 |
| 1-propanol | 720.84 | 946.12 | 544.61 | 850.63 | 858.70 | 887.04 | 759.93 | 752.76 |
| 2,3-hexanedione | ND | ND | ND | ND | ND | ND | ND | ND |
| 2,3-pentanedione | 0.106 | ND | ND | ND | ND | 0.074 | 0.062 | ND |
| 2-acetylfuran | 0.415 | 1.094 | 0.106 | 1.079 | 0.310 | 0.004 | 0.017 | 0.642 |
| 2-methyl-1-butanol | 141.71 | 223.55 | 37.687 | 144.16 | 204.90 | 135.50 | 236.37 | 65.07 |
| 5-methyl-furfural | 0.339 | 0.358 | 0.218 | 0.361 | 0.259 | 0.212 | 0.213 | 0.408 |
| acetic acid | 248.98 | 274.72 | 34.347 | 365.90 | 461.56 | 265.45 | 14.818 | 169.86 |
| allyl hexanoate | ND | ND | ND | 0.002 | ND | ND | ND | 0.017 |
| benzaldehyde | 0.221 | 0.223 | 0.181 | 0.202 | 0.185 | 0.181 | 0.192 | 0.217 |
| benzeneacetaldehyde | ND | ND | ND | 0.027 | ND | 0.003 | ND | 0.002 |
| benzyl butyrate | 0.007 | 0.027 | 0.031 | 0.189 | 0.031 | 0.023 | 0.121 | 0.008 |
| beta-bisabolene | ND | ND | ND | ND | ND | ND | ND | 0.079 |
| beta-caryophyllene | ND | ND | ND | ND | ND | ND | ND | ND |
| beta-pinene | ND | ND | ND | ND | ND | ND | ND | ND |
| butyl acetate | ND | 0.103 | ND | 0.013 | ND | ND | ND | 0.017 |
| citral | ND | ND | ND | ND | ND | ND | ND | ND |
| diethyl butanedioate | 0.289 | 0.517 | 0.253 | 0.300 | 0.303 | 0.244 | 0.475 | 0.248 |
| dimethyl disulfide | 0.035 | ND | ND | 0.050 | ND | 0.065 | ND | 0.009 |
| D-limonene | ND | ND | ND | 0.071 | ND | ND | ND | 0.475 |
| dodecanoic acid | 1.247 | 2.287 | ND | ND | ND | 1.955 | 1.685 | ND |
| ethyl acetate | 142.65 | 212.72 | 65.080 | 162.46 | 152.68 | 9.267 | 36.547 | 227.48 |
| ethyl benzoate | 0.012 | 0.087 | 0.029 | 0.027 | 0.014 | 0.023 | 0.025 | 0.023 |
| ethyl butyrate | 0.994 | 1.755 | 0.229 | 2.905 | 0.850 | 1.388 | 0.343 | 20.149 |
| ethyl dodecanoate | 0.444 | 1.157 | 0.210 | 0.662 | 0.540 | 0.953 | 0.352 | 0.582 |
| ethyl heptanoate | 0.023 | 0.023 | ND | 0.040 | 0.029 | ND | ND | 0.209 |
| ethyl hexanoate | 0.639 | 0.289 | 0.071 | 0.447 | 0.609 | 0.434 | 0.061 | 2.299 |
| ethyl octanoate | 1.413 | 1.156 | 0.250 | 2.083 | 1.531 | 1.840 | 0.313 | 1.190 |
| ethyl pentanoate | 0.199 | ND | ND | 0.219 | ND | ND | ND | 0.511 |
| ethyl propionate | 0.715 | 1.822 | 0.076 | 4.688 | 0.602 | 0.131 | 0.202 | 7.153 |
| furfural | 11.363 | 6.792 | 0.222 | 6.430 | 3.522 | 2.993 | 1.200 | 8.970 |
| heptanyl acetate | ND | ND | ND | ND | ND | ND | ND | ND |
| isoamyl acetate | 1.652 | 1.442 | 0.073 | 4.362 | 0.748 | 0.213 | 0.089 | 1.178 |
| isoamyl alcohol | 121.76 | 248.35 | 43.159 | 148.32 | 232.02 | 279.97 | 308.41 | 74.559 |
| isobutanol | 57.114 | 144.50 | 25.646 | 45.501 | 151.12 | 138.96 | 147.93 | 36.127 |
| isobutyl acetate | 0.167 | 0.519 | ND | 0.685 | 0.545 | 0.525 | 0.153 | ND |
| isopentyl hexanoate | ND | ND | ND | ND | ND | ND | ND | ND |
| linalool | 0.026 | 0.038 | ND | 0.087 | 0.015 | 0.024 | 0.031 | ND |
| maltol | 0.094 | 0.554 | ND | 0.865 | 0.470 | ND | ND | 0.056 |
| myrcene | ND | ND | ND | ND | ND | ND | ND | ND |
| hexanal | 0.027 | 0.261 | ND | 0.023 | 0.039 | 0.004 | 0.042 | ND |
| nonanal | ND | ND | ND | ND | ND | ND | 0.053 | ND |
| n-propyl acetate | 0.180 | 0.285 | 0.023 | 1.365 | 0.073 | 0.041 | 0.033 | 1.857 |
| octanoic acid | 2.073 | 4.294 | ND | 3.331 | 2.094 | 2.676 | 4.209 | 2.177 |
| p-anisyl acetate | ND | ND | ND | ND | NI | ND | ND | ND |
| p-cymene | 0.005 | 0.008 | 0.006 | 0.011 | 0.004 | 0.005 | ND | 0.023 |
| phenethyl acetate | 0.142 | 0.048 | 0.013 | 0.107 | 0.065 | 0.023 | 0.037 | 0.093 |
| phenylethyl alcohol | 0.822 | 3.652 | 0.229 | 1.893 | 2.438 | 1.583 | 7.046 | 0.269 |
| rum ether | 1383.6 | 1481.3 | 1110.2 | 1503.2 | 1131.2 | 1168.0 | 1719.9 | 1028.4 |
| tetrahydrofurfuryl | ND | ND | ND | ND | ND | ND | ND | ND |
| acetate | | | | | | | | |
| valeraldehyde | 0.037 | 0.230 | ND | 0.145 | 0.058 | 0.038 | 0.207 | 0.133 |
| whiskey lactone | 0.401 | 0.611 | 0.020 | 0.316 | 0.889 | ND | ND | 0.060 |

TABLE 3B
VOCs in reference Rums

| | Round 1 assays (values in mg/L) | | | | | | |
|---|---|---|---|---|---|---|---|
| | 9 | 10 | 11 | 12 | 13 | 14 | 15 |
| (±)-menthol | ND | 0.274 | ND | ND | ND | ND | 0.714 |
| 1-octen-3-ol | ND | 0.165 | 0.019 | 0.171 | ND | 0.040 | 0.389 |
| 1-propanol | 977.67 | 948.53 | 797.85 | 906.22 | 957.4 | 771.72 | 997.72 |
| 2,3-hexanedione | ND | ND | ND | ND | ND | ND | ND |
| 2,3-pentanedione | ND | 0.104 | ND | ND | ND | ND | 3.195 |
| 2-acetylfuran | 0.059 | 2.404 | 0.082 | 0.319 | 0.036 | 0.131 | 4.199 |
| 2-methyl-1-butanol | 9.626 | 264.21 | 45.399 | 134.29 | 6.155 | 232.46 | 220.18 |
| 5-methyl-furfural | 0.237 | 0.696 | 0.235 | 0.265 | 0.232 | 0.258 | 1.243 |
| acetic acid | 241.95 | 1129.4 | 682.45 | 1906.8 | 89.30 | 99.297 | 1162.4 |
| allyl hexanoate | ND | ND | ND | ND | ND | ND | ND |
| benzaldehyde | 0.181 | 0.303 | 0.185 | 0.227 | 0.606 | 0.197 | 0.510 |
| benzeneacetaldehyde | ND | 0.085 | ND | 0.148 | 0.004 | 0.151 | 0.159 |
| benzyl butyrate | 0.010 | 0.069 | 0.008 | 0.159 | 0.045 | 0.056 | 0.038 |
| beta-bisabolene | ND | ND | ND | ND | ND | ND | ND |
| beta-caryophyllene | ND | ND | ND | ND | ND | ND | ND |
| beta-pinene | ND | ND | ND | ND | ND | ND | ND |
| butyl acetate | ND | ND | ND | ND | ND | ND | 0.096 |
| citral | ND | ND | ND | ND | ND | ND | ND |
| diethyl butanedioate | 0.288 | 0.337 | 0.327 | 0.420 | 0.369 | 0.363 | 0.278 |
| dimethyl disulfide | ND | 0.077 | ND | ND | ND | ND | 1.155 |
| D-limonene | ND | ND | ND | ND | ND | ND | 0.138 |
| dodecanoic acid | ND | 3.704 | ND | 2.034 | 1.425 | ND | 8.530 |
| ethyl acetate | 147.88 | 267.28 | 186.71 | 243.58 | 141.5 | 157.75 | 280.44 |
| ethyl benzoate | ND | 0.130 | ND | 0.029 | 0.093 | 0.017 | 0.214 |
| ethyl butyrate | 0.247 | 7.815 | 0.870 | 0.792 | 0.018 | 1.260 | 31.281 |
| ethyl dodecanoate | 0.155 | 2.878 | 0.281 | 0.811 | 0.516 | 0.627 | 13.898 |
| ethyl heptanoate | ND | 0.852 | 0.009 | 0.044 | 0.012 | 0.006 | 0.919 |
| ethyl hexanoate | 0.106 | 7.096 | 0.181 | 0.468 | 0.184 | 0.177 | 8.888 |
| ethyl octanoate | 0.123 | 3.139 | 0.238 | 1.375 | 0.749 | 0.565 | 6.416 |
| ethyl pentanoate | ND | 0.352 | ND | ND | 0.176 | ND | 1.045 |
| ethyl propionate | 0.301 | 6.275 | 0.439 | 0.736 | 0.223 | 0.572 | 12.030 |
| furfural | 3.489 | 47.810 | 3.252 | 5.851 | 3.856 | 1.858 | 76.757 |
| heptanyl acetate | ND | ND | ND | ND | ND | ND | ND |
| isoamyl acetate | 0.071 | 1.724 | 0.356 | 0.855 | 0.020 | 1.083 | 10.725 |
| isoamyl alcohol | 7.328 | 335.73 | 46.585 | 176.82 | 11.13 | 261.38 | 394.68 |
| isobutanol | 7.752 | 157.08 | 37.046 | 88.953 | 1.114 | 144.54 | 136.87 |
| isobutyl acetate | 0.166 | 0.339 | ND | 0.254 | 0.820 | 0.318 | 0.304 |
| isopentyl hexanoate | ND | ND | ND | ND | 0.026 | ND | ND |
| linalool | ND | 0.068 | ND | ND | ND | 0.034 | 0.191 |
| maltol | 0.155 | 0.527 | 0.233 | 0.749 | ND | 0.314 | 0.189 |
| myrcene | ND | ND | ND | ND | ND | ND | ND |
| hexanal | 0.052 | 0.086 | 0.058 | 0.135 | 0.069 | 0.074 | 0.141 |
| nonanal | ND | ND | ND | ND | ND | ND | ND |
| n-propyl acetate | 0.027 | 3.454 | 0.100 | 0.125 | ND | 0.084 | ND |
| octanoic acid | ND | 3.808 | ND | 4.327 | 2.506 | 2.221 | 6.373 |
| p-anisyl acetate | ND | ND | ND | ND | ND | ND | ND |
| p-cymene | 0.006 | 0.014 | 0.005 | 0.010 | 0.006 | 0.003 | 0.054 |
| phenethyl acetate | 0.020 | 0.205 | 0.038 | 0.265 | ND | 0.086 | 0.758 |
| phenylethyl alcohol | 0.651 | 4.341 | 2.113 | 8.101 | 1.580 | 2.918 | 1.237 |
| rum ether | 1652.9 | 2777.6 | 1139.8 | 2183.5 | 967.4 | 1626.1 | 5267.3 |
| tetrahydrofurfuryl | ND | ND | ND | ND | ND | ND | ND |
| acetate | | | | | | | |
| valeraldehyde | 0.022 | 0.439 | 0.005 | 0.048 | 0.027 | 0.029 | 0.564 |
| whiskey lactone | 0.478 | 1.616 | 0.946 | 1.814 | 0.159 | 0.414 | 0.330 |

ND = not detected or below limit of detection

LC-MS was used to ascertain the existence of various non-volatile compounds in several reference rum samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:

Polarity: positive or negative mode, as indicated for each method

Resolution: 70,000

Scan range: 60-900 m/z for all methods

Isolation window: 1.5 m/z

MS/MS collision energy: 30

Qualitative analysis was done in Compound Discoverer to gather which LC/MS compounds were present in all reference rums.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A rum replica comprising:
water,
a grain neutral spirit,
optionally, a rum, wherein said rum replica comprises no more than about 10 wt % of said rum,
glycerin,
optionally, an oak extract,
optionally, a salt,
optionally, a sugar or other sweetener,
optionally, a tannin,
optionally, one or more plant oils, fruit oils, plant flavors, or fruit flavors, and
at least ten added volatile organic compounds (VOCs), wherein said added VOCs comprise at least one acid, at least one additional alcohol, at least one aldehyde, at least one ester, at least one terpene, at least one furan, and optionally at least one ketone, wherein said added VOCs comprise about 0.0001 wt % to about 1 wt % of said rum replica.

2. The rum replica of claim 1, wherein said at least one acid comprises acetic acid.

3. The rum replica of claim 1 or claim 2, wherein said at least one additional alcohol comprises one or more of 1-octen-3-ol, 1-propanol, 2-methyl-1-butanol, isoamyl alcohol, and isobutanol.

4. The rum replica of claim 3, wherein said at least one additional alcohol comprises 1-propanol and 2-methyl-1-butanol.

5. The rum replica of claim 3, wherein said at least one additional alcohol comprises isobutanol, isoamyl alcohol, 1-propanol, 2-methyl-1-butanol, and 1-octen-3-ol.

6. The rum replica of claim 3, wherein said at least one additional alcohol comprises isobutanol, 1-propanol, and 2-methyl-1-butanol.

7. The rum replica of any one of claims 1 to 6, wherein said at least one aldehyde comprises one or more of 5-methyl-furfural, benzaldehyde, benzeneacetaldehyde, citral, furfural, hexanal, nonanal, and valeraldehyde.

8. The rum replica of claim 7, wherein said at least one aldehyde comprises furfural, benzeneacetaldehyde, nonanal, valeraldehyde, benzaldehyde, and 5-methyl-furfural.

9. The rum replica of claim 7, wherein said at least one aldehyde comprises furfural, valeraldehyde, benzaldehyde, and 5-methyl-furfural.

10. The rum replica of claim 7, wherein said at least one aldehyde comprises furfural, hexanal, citral, benzaldehyde, and 5-methyl-furfural.

11. The rum replica of any one of claims 1 to 10, wherein said at least one ester comprises one or more of allyl hexanoate, benzyl butyrate, butyl acetate, diethyl butanedioate, ethyl acetate, ethyl octanoate, ethyl butyrate, ethyl heptanoate, ethyl hexanoate, ethyl pentanoate, ethyl propionate, heptanyl acetate, isoamyl acetate, isobutyl acetate, n-propyl acetate, p-anisyl acetate, and tetrahydrofurfuryl acetate.

12. The rum replica of claim 11, wherein said at least one ester comprises isoamyl acetate, tetrahydrofurfuryl acetate, p-anisyl acetate, ethyl propionate, ethyl acetate, and diethyl butanedioate.

13. The rum replica of claim 11, wherein said at least one ester comprises ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, and ethyl acetate.

14. The rum replica of claim 11, wherein said at least one ester comprises isobutyl acetate, tetrahydrofurfuryl acetate, p-anisyl acetate, ethyl propionate, and ethyl acetate.

15. The rum replica of claim 11, wherein said at least one ester comprises ethyl hexanoate, ethyl octanoate, isobutyl acetate, ethyl propionate, and ethyl acetate.

16. The rum replica of any one of claims 1 to 15, wherein said at least one terpene comprises one or more of beta-caryophyllene, beta-pinene, d-limonene, linalool, myrcene, and p-cymene.

17. The rum replica of claim 16, wherein said at least one terpene comprises p-cymene.

18. The rum replica of claim 16, wherein said at least one terpene comprises d-limonene and p-cymene.

19. The rum replica of claim 16, wherein said at least one terpene comprises d-limonene, beta-pinene, myrcene, beta-caryophyllene, linalool, and p-cymene.

20. The rum replica of any one of claims 1 to 19, wherein said at least one furan comprises 2-acetylfuran.

21. The rum replica of any one of claims 1 to 20, wherein said rum replica comprises at least one ketone, and wherein said at least one ketone comprises one or more of 2,3-hexanedione, 2,3-pentanedione, and maltol.

22. The rum replica of claim 21, wherein said at least one ketone comprises 2,3-hexanedione and maltol.

23. The rum replica of claim 21, wherein said at least one ketone comprises 2,3-hexanedione, 2,3-pentanedione, and maltol.

24. The rum replica of any one of claims 1 to 23, wherein said added VOCs further comprise one or more of dimethyl disulfide, rum ether, and whiskey lactone.

25. The rum replica of claim 24, wherein said added VOCs comprise rum ether and whiskey lactone.

26. The rum replica of claim 24, wherein said added VOCs comprise dimethyl disulfide, rum ether, and whiskey lactone.

27. The rum replica of any one of claims 1 to 26, wherein said rum replica comprises an oak extract.

28. The rum replica of any one of claims 1 to 27, wherein said rum replica comprises a salt, and wherein the salt is sodium chloride.

29. The rum replica of any one of claims 1 to 28, wherein said rum replica comprises a sugar or other sweetener selected from the group consisting of sucrose, fructose, glucose, sugar alcohols, and sugar substitutes.

30. The rum replica of any one of claims 1 to 29, wherein said rum replica comprises a tannin.

31. The rum replica of any one of claims 1 to 30, wherein said added VOCs comprise ten or more compounds selected from the group consisting of 1-decanol, 1-octen-3-ol, 1-propanol, 2,3-hexanedione, 2,3-pentanedione, 2-acetylfuran, 2-methyl-1-butanol, 2-pentylfuran, 5-methyl-furfural, acetic acid, allyl hexanoate, benzaldehyde, benzeneacetaldehyde, benzyl butyrate, beta-bisabolene, beta-caryophyllene, beta-pinene, butyl acetate, citral, decanal, diethyl butanedioate, dimethyl disulfide, D-limonene, dodecanoic acid, ethyl acetate, ethyl octanoate, ethyl benzoate, ethyl butyrate, ethyl dodecanoate, ethyl heptanoate, ethyl hexanoate, ethyl pentanoate, ethyl propionate, furfural, heptanyl acetate, isoamyl acetate, isoamyl acetate, isobutyl acetate, isopentyl hexanoate, isobutanol, linalool, maltol, menthol, myrcene, decanoic acid, hexanal, nonanal, n-propyl acetate, octanoic acid, octyl acetate, p-anisyl acetate, p-cymene, phenethyl acetate, phenylethyl alcohol, rum ether, tetrahydrofurfuryl acetate, valeraldehyde, and whiskey lactone.

32. The rum replica of any one of claims 1 to 30, wherein said added VOCs comprise 10 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

33. The rum replica of any one of claims 1 to 30, wherein said added VOCs comprise 20 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

34. The rum replica of claim 1, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

35. The rum replica of claim 1, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

36. The rum replica of claim 1, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

37. The rum replica of claim 1, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

38. The rum replica of claim 1, comprising:
from about 5 wt % to about 70 wt % water,
from about 25 wt % to about 95 wt % grain neutral spirits,
from about 1 wt % to about 10 wt % rum,
from about 0.1 wt % to about 10 wt % glycerin,
optionally, up to about 0.1 wt % salt,
optionally, up to about 5 wt % sugar or sweetener,
optionally, up to about 0.1 wt % tannins, and
from about 0.001 wt % to about 1 wt % added VOCs, wherein said added VOCs comprise ten or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

39. The rum replica of claim 38, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

40. The rum replica of claim 38, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

41. The rum replica of claim 38, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

42. The rum replica of claim 38, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

43. The rum replica of claim 38, wherein said added VOCs comprise isobutanol, and wherein said isobutanol is present in said rum replica at a concentration greater than about 315 mg/L.

44. The rum replica of claim 38, wherein said added VOCs comprise ethyl heptanoate, and wherein said ethyl heptanoate is present in said rum replica at a concentration greater than about 1.84 mg/L.

45. The rum replica of claim 38, wherein said added VOCs comprise acetic acid, and wherein said acetic acid is present in said rum replica at a concentration less than about 7.5 mg/L.

46. The rum replica of claim 38, wherein said added VOCs comprise n-propyl acetate, and wherein said n-propyl acetate is present in said rum replica at a concentration less than about 0.12 mg/L.

47. The rum replica of claim 38, wherein said added VOCs comprise isoamyl acetate, and wherein said isoamyl acetate is present in said rum replica at a concentration greater than about 21.4 mg/L.

48. The rum replica of claim 38, wherein said added VOCs comprise 2-methyl-1-butanol, and wherein said 2-methyl-1-butanol is present in said rum replica at a concentration less than about 3.1 mg/L.

49. The rum replica of claim 38, wherein said added VOCs comprise benzeneacetaldehyde, and wherein said benzeneacetaldehyde is present in said rum replica at a concentration less than about 0.0012 mg/L.

50. The rum replica of claim 38, wherein said added VOCs comprise nonanal, and wherein said nonanal is present in said rum replica at a concentration greater than about 0.1 mg/L.

51. The rum replica of claim 38, wherein said added VOCs comprise valeraldehyde, and wherein said valeraldehyde is present in said rum replica at a concentration less than about 0.0024 mg/L.

52. The rum replica of claim 38, wherein said added VOCs comprise allyl hexanoate, and wherein said allyl hexanoate is present in said rum replica at a concentration greater than about 0.034 mg/L.

53. The rum replica of claim 38, wherein said added VOCs comprise benzyl butyrate, and wherein said benzyl butyrate is present in said rum replica at a concentration in an amount greater than about 0.37 mg/L.

54. The rum replica of claim 38, wherein said added VOCs comprise ethyl acetate, and wherein said ethyl acetate is present in said rum replica at a concentration less than about 4.6 mg/L.

55. The rum replica of claim 38, wherein said added VOCs comprise acetic acid, and wherein less than about 0.001 wt % of the added VOCs is acetic acid.

56. The rum replica of claim 38, wherein said added VOCs comprise isoamyl acetate, and wherein at least about 0.013 wt % of said added VOCs is isoamyl acetate.

57. The rum replica of claim 38, wherein said added VOCs comprise 2-methyl-1-butanol, and wherein less than about 0.0003 wt % of said added VOCs is 2-methyl-1-butanol.

58. The rum replica of claim 38, wherein said added VOCs comprise nonanal, and wherein at least about 0.00007 wt % of said added VOCs is nonanal.

59. The rum replica of claim 38, wherein said added VOCs comprise allyl hexanoate, and wherein at least about 0.00002 wt % of said added VOCs is allyl hexanoate.

60. The rum replica of claim 38, wherein said added VOCs comprise benzyl butyrate, and wherein at least about 0.0002 wt % of said added VOCs is benzyl butyrate.

61. The rum replica of claim 38, wherein said added VOCs comprise ethyl acetate, and wherein less than about 0.0005 wt % of said added VOCs is ethyl acetate.

62. The rum replica of any one of claims 38 to 61, further comprising from about 10 wt % to about 30 wt % oak extract.

63. The rum replica of any one of claims 1 to 62, further comprising from about 0.0005 to about 0.002 wt % orange oil.

64. The rum replica of any one of claims 1 to 63, wherein the total concentration of said one or more esters in said rum replica is less than about 7.5 mg/L.

65. The rum replica of any one of claims 1 to 64, wherein the total concentration of said one or more acids in the rum replica is less than about 10 mg/L.

66. A method for making a rum replica, wherein said method comprises combining:
water,
a grain neutral spirit,
optionally, a rum, wherein said rum replica comprises no more than about 10 wt % of said rum,
glycerin,
optionally, an oak extract,
optionally, a salt,
optionally, a sugar or other sweetener,
optionally, a tannin,
optionally, one or more plant oils, fruit oils, plant flavors, or fruit flavors, and at least ten added VOCs, wherein said added VOCs comprise at least one acid, at least one additional alcohol, at least one aldehyde, at least one ester, and at least one terpene, at least one furan, and optionally at least one ketone, wherein said added VOCs comprise about 0.0001 wt % to about 1 wt % of said rum replica.

67. The method of claim 66, wherein said at least one acid comprises acetic acid.

68. The method of claim 66 or claim 67, wherein said at least one additional alcohol comprises one or more of 1-octen-3-ol, 1-propanol, 2-methyl-1-butanol, isoamyl alcohol, and isobutanol.

69. The method of claim 68, wherein said at least one additional alcohol comprises 1-propanol and 2-methyl-1-butanol.

70. The method of claim 68, wherein said at least one additional alcohol comprises isobutanol, isoamyl alcohol, 1-propanol, 2-methyl-1-butanol, and 1-octen-3-ol.

71. The method of claim 68, wherein said at least one additional alcohol comprises isobutanol, 1-propanol, and 2-methyl-1-butanol.

72. The method of any one of claims 66 to 71, wherein said at least one aldehyde comprises one or more of 5-methyl-furfural, benzaldehyde, benzeneacetaldehyde, citral, furfural, hexanal, nonanal, and valeraldehyde.

73. The method of claim 72, wherein said at least one aldehyde comprises furfural, benzeneacetaldehyde, nonanal, valeraldehyde, benzaldehyde, and 5-methyl-furfural.

74. The method of claim 72, wherein said at least one aldehyde comprises furfural, valeraldehyde, benzaldehyde, and 5-methyl-furfural.

75. The method of claim 72, wherein said at least one aldehyde comprises furfural, hexanal, citral, benzaldehyde, and 5-methyl-furfural.

76. The method of any one of claims 66 to 75, wherein said at least one ester comprises one or more of allyl hexanoate, benzyl butyrate, butyl acetate, diethyl butanedioate, ethyl acetate, ethyl octanoate, ethyl butyrate, ethyl heptanoate, ethyl hexanoate, ethyl pentanoate, ethyl propionate, heptanyl acetate, isoamyl acetate, isobutyl acetate, n-propyl acetate, p-anisyl acetate, and tetrahydrofurfuryl acetate.

77. The method of claim 76, wherein said at least one ester comprises isoamyl acetate, tetrahydrofurfuryl acetate, p-anisyl acetate, ethyl propionate, ethyl acetate, and diethyl butanedioate.

78. The method of claim 76, wherein said at least one ester comprises ethyl hexanoate, ethyl heptanoate, ethyl octanoate, n-propyl acetate, isobutyl acetate, isoamyl acetate, butyl acetate, heptanyl acetate, ethyl propionate, ethyl butyrate, allyl hexanoate, benzyl butyrate, ethyl pentanoate, and ethyl acetate.

79. The method of claim 76, wherein said at least one ester comprises isobutyl acetate, tetrahydrofurfuryl acetate, p-anisyl acetate, ethyl propionate, and ethyl acetate.

80. The method of claim 76, wherein said at least one ester comprises ethyl hexanoate, ethyl octanoate, isobutyl acetate, ethyl propionate, and ethyl acetate.

81. The method of any one of claims 66 to 80, wherein said at least one terpene comprises one or more of beta-caryophyllene, beta-pinene, d-limonene, linalool, myrcene, and p-cymene.

82. The method of claim 81, wherein said at least one terpene comprises p-cymene.

83. The method of claim 81, wherein said at least one terpene comprises d-limonene and p-cymene.

84. The method of claim 81, wherein said at least one terpene comprises d-limonene, beta-pinene, myrcene, beta-caryophyllene, linalool, and p-cymene.

85. The method of any one of claims 66 to 84, wherein said at least one furan comprises 2-acetylfuran.

86. The method of any one of claims 66 to 85, wherein said rum replica comprises at least one ketone, and wherein said at least one ketone comprises one or more of 2,3-hexanedione, 2,3-pentanedione, and maltol.

87. The method of claim 86, wherein said at least one ketone comprises 2,3-hexanedione and maltol.

88. The method of claim 86, wherein said at least one ketone comprises 2,3-hexanedione, 2,3-pentanedione, and maltol.

89. The method of any one of claims 66 to 88, wherein said added VOCs further comprise one or more of dimethyl disulfide, rum ether, and whiskey lactone.

90. The method of claim 89, wherein said added VOCs comprise rum ether and whiskey lactone.

91. The method of claim 89, wherein said added VOCs comprise dimethyl disulfide, rum ether, and whiskey lactone.

92. The method of any one of claims 66 to 91, wherein said rum replica comprises an oak extract.

93. The method of any one of claims 66 to 92, wherein said rum replica comprises a salt, and wherein the salt is sodium chloride.

94. The method of any one of claims 66 to 93, wherein said rum replica comprises a sugar or other sweetener selected from the group consisting of sucrose, fructose, glucose, sugar alcohols, and sugar substitutes.

95. The method of any one of claims 66 to 94, wherein said rum replica comprises a tannin.

96. The method of any one of claims 66 to 95, wherein said added VOCs comprise ten or more compounds selected from the group consisting of 1-decanol, 1-octen-3-ol, 1-propanol, 2,3-hexanedione, 2,3-pentanedione, 2-acetylfuran, 2-methyl-1-butanol, 2-pentylfuran, 5-methyl-furfural, acetic acid, allyl hexanoate, benzaldehyde, benzeneacetaldehyde, benzyl butyrate, beta-bisabolene, beta-caryophyllene, beta-pinene, butyl acetate, citral, decanal, diethyl butanedioate, dimethyl disulfide, D-limonene, dodecanoic acid, ethyl acetate, ethyl octanoate, ethyl benzoate, ethyl butyrate, ethyl dodecanoate, ethyl heptanoate, ethyl hexanoate, ethyl pentanoate, ethyl propionate, furfural, heptanyl acetate, isoamyl acetate, isoamyl acetate, isobutyl acetate, isopentyl hexanoate, isobutanol, linalool, maltol, menthol, myrcene, decanoic acid, hexanal, nonanal, n-propyl acetate, octanoic acid, octyl acetate, p-anisyl acetate, p-cymene, phenethyl acetate, phenylethyl alcohol, rum ether, tetrahydrofurfuryl acetate, valeraldehyde, and whiskey lactone.

97. The method of any one of claims 66 to 95, wherein said added VOCs comprise 10 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

98. The method of any one of claims 66 to 95, wherein said added VOCs comprise 20 or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

99. The method of claim 66, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

100. The method of claim 66, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

101. The method of claim 66, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

102. The method of claim 66, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

103. The method of claim 66, comprising combining:
from about 5 wt % to about 70 wt % water,
from about 25 wt % to about 95 wt % grain neutral spirits,
from about 1 wt % to about 10 wt % rum,
from about 0.1 wt % to about 10 wt % glycerin,
optionally, up to about 0.1 wt % salt,
optionally, up to about 5 wt % sugar or sweetener,
optionally, up to about 0.1 wt % tannins, and
from about 0.001 wt % to about 1 wt % added VOCs, wherein said added VOCs comprise ten or more compounds selected from the group consisting of 1-octen-3-ol, 1-propanol, 2,3-hexanedione, 2,3-pentanedione, 2-acetylfuran, 2-methyl-1-butanol, 5-methyl-furfural, acetic acid, allyl hexanoate, benzaldehyde, benzeneacetaldehyde, benzyl butyrate, beta-caryophyllene, beta-pinene, butyl acetate, citral, diethyl butanedioate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, linalool, maltol, myrcene, hexanal, nonanal, n-propyl acetate, p-anisyl acetate, p-cymene, rum ether, tetrahydrofurfuryl acetate, valeraldehyde, and whiskey lactone.

104. The method of claim 103, wherein said added VOCs comprise 1-propanol, 2,3-hexanedione, 2-acetylfuran, 2-methyl-1-butanol, 5-methyl-furfural, acetic acid, benzaldehyde, benzeneacetaldehyde, diethyl butanedioate, ethyl acetate, ethyl propionate, furfural, isoamyl acetate, maltol, nonanal, p-anisyl acetate, p-cymene, rum ether, tetrahydrofurfuryl acetate, valeraldehyde, and whiskey lactone.

105. The method of claim 103, wherein said added VOCs comprise 1-octen-3-ol, 1-propanol, 2-acetylfuran, 2-methyl-1-butanol, 5-methyl-furfural, acetic acid, allyl hexanoate, benzaldehyde, benzyl butyrate, butyl acetate, dimethyl disulfide, D-limonene, ethyl acetate, ethyl octanoate, ethyl butyrate, ethyl heptanoate, ethyl hexanoate, ethyl pentanoate, ethyl propionate, furfural, heptanyl acetate, isoamyl acetate, isoamyl alcohol, isobutyl acetate, isobutanol, n-propyl acetate, p-cymene, rum ether, valeraldehyde, and whiskey lactone.

106. The method of claim 103, wherein said added VOCs comprise 1-propanol, 2,3-hexanedione, 2,3-pentanedione, 2-acetylfuran, 2-methyl-1-butanol, 5-methyl-furfural, acetic acid, benzaldehyde, beta-caryophyllene, beta-pinene, citral, D-limonene, ethyl acetate, ethyl propionate, furfural, isobutyl acetate, isobutanol, linalool, maltol, myrcene, hexanal, p-anisyl acetate, p-cymene, rum ether, tetrahydrofurfuryl acetate, and whiskey lactone.

107. The method of claim 103, wherein said added VOCs comprise 1-propanol, 2-acetylfuran, 2-methyl-1-butanol, 5-methyl-furfural, acetic acid, benzaldehyde, ethyl acetate, ethyl octanoate, ethyl hexanoate, ethyl propionate, furfural, isobutyl acetate, p-cymene, rum ether, valeraldehyde, and whiskey lactone.

108. The method of claim 103, wherein said added VOCs comprise isobutanol, and wherein said isobutanol is present in said rum replica at a concentration greater than about 315 mg/L.

109. The method of claim 103, wherein said added VOCs comprise ethyl heptanoate, and wherein said ethyl heptanoate is present in said rum replica at a concentration greater than about 1.84 mg/L.

110. The method of claim 103, wherein said added VOCs comprise acetic acid, and wherein said acetic acid is present in said rum replica at a concentration less than about 7.5 mg/L.

111. The method of claim 103, wherein said added VOCs comprise n-propyl acetate, and wherein said n-propyl acetate is present in said rum replica at a concentration less than about 0.12 mg/L.

112. The method of claim 103, wherein said added VOCs comprise isoamyl acetate, and wherein said isoamyl acetate is present in said rum replica at a concentration greater than about 21.4 mg/L.

113. The method of claim 103, wherein said added VOCs comprise 2-methyl-1-butanol, and wherein said 2-methyl-1-butanol is present in said rum replica at a concentration less than about 3.1 mg/L.

114. The method of claim 103, wherein said added VOCs comprise benzeneacetaldehyde, and wherein said benzeneacetaldehyde is present in said rum replica at a concentration less than about 0.0012 mg/L.

115. The method of claim 103, wherein said added VOCs comprise nonanal, and wherein said nonanal is present in said rum replica at a concentration greater than about 0.1 mg/L.

116. The method of claim 103, wherein said added VOCs comprise valeraldehyde, and wherein said valeraldehyde is present in said rum replica at a concentration less than about 0.0024 mg/L.

117. The method of claim 103, wherein said added VOCs comprise allyl hexanoate, and wherein said allyl hexanoate is present in said rum replica at a concentration greater than about 0.034 mg/L.

118. The method of claim 103, wherein said added VOCs comprise benzyl butyrate, and wherein said benzyl butyrate is present in said rum replica at a concentration in an amount greater than about 0.37 mg/L.

119. The method of claim 103, wherein said added VOCs comprise ethyl acetate, and wherein said ethyl acetate is present in said rum replica at a concentration less than about 4.6 mg/L.

120. The method of claim 103, wherein said added VOCs comprise acetic acid, and wherein less than about 0.001 wt % of the added VOCs is acetic acid.

121. The method of claim 103, wherein said added VOCs comprise isoamyl acetate, and wherein at least about 0.013 wt % of said added VOCs is isoamyl acetate.

122. The method of claim 103, wherein said added VOCs comprise 2-methyl-1-butanol, and wherein less than about 0.0003 wt % of said added VOCs is 2-methyl-1-butanol.

123. The method of claim 103, wherein said added VOCs comprise nonanal, and wherein at least about 0.00007 wt % of said added VOCs is nonanal.

124. The method of claim 103, wherein said added VOCs comprise allyl hexanoate, and wherein at least about 0.00002 wt % of said added VOCs is allyl hexanoate.

125. The method of claim 103, wherein said added VOCs comprise benzyl butyrate, and wherein at least about 0.0002 wt % of said added VOCs is benzyl butyrate.

126. The method of claim 103, wherein said added VOCs comprise ethyl acetate, and wherein less than about 0.0005 wt % of said added VOCs is ethyl acetate.

127. The method of any one of claims 104 to 127, further comprising adding from about 10 wt % to about 30 wt % oak extract to said rum replica.

128. The method of any one of claims 67 to 128, further comprising adding from about 0.0005 to about 0.002 wt % orange oil to said rum replica.

129. The method of any one of claims 67 to 129, wherein the total concentration of said one or more esters in said rum replica is less than about 7.5 mg/L.

130. The method of any one of claims 67 to 130, wherein the total concentration of said one or more acids in the rum replica is less than about 10 mg/L.

131. A rum replica produced by the method of any one of claims 66 to 130.

132. A rum-like alcoholic beverage concentrate comprising:
a rum, wherein said alcoholic beverage, after dilution to produce a final product, comprises no more than about 10 wt % of said rum,
glycerin,
optionally, an oak extract,
optionally, a salt,
optionally, a sugar or other sweetener,
optionally, a tannin,
optionally, one or more plant oils, fruit oils, plant flavors, or fruit flavors, and
at least ten added VOCs, wherein said added VOCs comprise at least one acid, at least one additional alcohol, at least one aldehyde, at least one ester, at least one terpene, at least one furan, and optionally at least one ketone, wherein at least one of said added VOCs is present in a concentration of at least about 2-fold the concentration of the same VOC in a corresponding traditional rum or a corresponding non-concentrate rum-like alcoholic beverage.

133. The rum-like alcoholic beverage concentrate of claim 132, wherein at least one of said added VOCs is present in the concentrate in a concentration of at least about 5-fold the concentration of the same VOCs in a corresponding traditional rum or a corresponding non-concentrate rum-like alcoholic beverage.

134. The rum-like alcoholic beverage concentrate of claim 132, wherein at least one of said added VOCs is present in the concentrate in a concentration of at least about 10-fold the concentration of the same VOCs in a corresponding traditional rum or a corresponding non-concentrate rum-like alcoholic beverage.

135. The rum-like alcoholic beverage concentrate of claim 132, wherein at least one of said added VOCs is present in the concentrate in a concentration of at least about 15-fold the concentration of the same VOCs in a corresponding traditional rum or a corresponding non-concentrate rum-like alcoholic beverage.

136. The rum-like alcoholic beverage concentrate of any one of claims 132 to 135, wherein upon dilution of said rum-like beverage concentrate to a rum-like alcoholic beverage, the rum-like alcoholic beverage is the rum replica of any one of claims 1 to 65.

137. A method of making a rum-like alcoholic beverage concentrate, the method comprising combining:
a rum, wherein said alcoholic beverage, after dilution to produce a final product, comprises no more than about 10 wt % of said rum,
glycerin,
optionally, an oak extract,
optionally, a salt,
optionally, a sugar or other sweetener,
optionally, a tannin,
optionally, one or more plant oils, fruit oils, plant flavors, or fruit flavors, and
at least ten added VOCs, wherein said added VOCs comprise at least one acid, at least one additional alcohol, at least one aldehyde, at least one ester, at least one terpene, at least one furan, and optionally at least one ketone, wherein at least one of said added VOCs is present in a concentration of at least about 2-fold the concentration of the same VOC in a corresponding traditional rum or a corresponding non-concentrate rum-like alcoholic beverage.

138. The method of claim 137, wherein at least one of said added VOCs is present in the concentrate in a concentration of at least about 5-fold the concentration of the same VOCs in a corresponding traditional rum or a corresponding non-concentrate rum-like alcoholic beverage.

139. The method of claim 137, wherein at least one of said added VOCs is present in the concentrate in a concentration of at least about 10-fold the concentration of the same VOCs in a corresponding traditional rum or a corresponding non-concentrate rum-like alcoholic beverage.

140. The method of claim 137, wherein at least one of said added VOCs is present in the concentrate in a concentration of at least about 15-fold the concentration of the same VOCs in a corresponding traditional rum or a corresponding non-concentrate rum-like alcoholic beverage.

141. The method of any one of claims 137 to 140, wherein upon dilution of the rum-like beverage concentrate to a rum-like alcoholic beverage, the rum-like alcoholic beverage is the rum replica of any one of claims 1 to 65.
